(19) United States
(12) Patent Application Publication
(10) Pub. No.: US 2026/0127021 A1
(43) Pub. Date: May 7, 2026

(54) ADAPTIVE AI COWORKER FOR ORGANIZATIONAL OPERATIONS

(71) Applicant: LuminaData, Inc., San Jose, CA (US)

(72) Inventors: Deepti Chafekar, San Jose, CA (US); Afrozy Ara, San Jose, CA (US)

(21) Appl. No.: 19/379,183

(22) Filed: Nov. 4, 2025

Related U.S. Application Data
(60) Provisional application No. 63/716,444, filed on Nov. 5, 2024.

(51) Int. Cl. G06F 9/48

(52) U.S. Cl. CPC G06F 9/4831

(57) ABSTRACT

Examples relate to an adaptive AI coworker system for enhancing organizational operations. The system generates personalized AI coworkers based on role requirements, employing adaptive learning to understand unique organizational practices. It utilizes multi-agent coordination for complex task execution, automatically generating, prioritizing, and allocating tasks based on organizational context. The system integrates data from various sources, implementing data governance measures. Customized large language model instances are created for specific roles and organizations, incorporating organization-specific data and operational practices. The system provides explainable AI features for operational decision-making, ensuring transparency in critical tasks. Security measures and access controls are implemented to maintain data integrity and compliance with relevant regulations and standards.

### CROSS-REFERENCE TO RELATED APPLICATION

This non-provisional application claims the benefit of U.S. Provisional Ser. No. 63/716,444 , filed on Nov. 5, 2024, which is hereby incorporated by reference in its entirety.

### TECHNICAL FIELD

The present disclosures relate to artificial intelligence systems and, in some examples, to algorithms and systems to generate and deploy customized AI agents for task automation and workflow management in organizational operations.

### BACKGROUND

Operational teams within organizations face numerous technical challenges in managing complex workflows and tasks. The increasing volume and variety of data generated by enterprise systems, including customer relationship management (CRM) platforms, enterprise resource planning (ERP) software, and various internal databases, create significant hurdles in data integration and analysis.

Processing and extracting meaningful insights from this diverse data landscape, which includes structured and unstructured information, requires sophisticated technological solutions. Natural language processing and machine learning techniques are often employed to interpret and categorize vast amounts of textual data from sources such as emails, documents, and internal communications.

Task management and workflow optimization present another set of technical challenges. As organizational processes become more complex, there is a growing need for systems that can automate routine tasks, prioritize activities based on multiple factors, and adapt to changing operational requirements. This complexity is further compounded by the need to coordinate activities across different roles and departments within an organization.

The integration of various enterprise systems and the need for seamless data flow between them pose significant technical hurdles. Ensuring data consistency, maintaining security protocols, and managing access controls across multiple platforms require robust architectural solutions.

Additionally, the dynamic nature of modern business environments necessitates systems that can learn and adapt to new scenarios, understand context-specific requirements, and provide decision support based on historical data and current trends.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a networked computing environment for implementing a digital co-worker system, according to some examples.

FIG. 2 is a block diagram illustrating a system architecture for a role-based AI coworker system, according to some examples.

FIG. 3 is a block diagram illustrating a software architecture for generating and managing AI coworkers, according to some examples.

FIG. 4 is a block diagram illustrating a database architecture for storing and processing data in the AI coworker system, according to some examples.

FIG. 5 is a block diagram illustrating a task agent architecture for breaking down and executing tasks, according to some examples

FIG. 6 is a block diagram illustrating a role agent architecture for understanding and managing role-specific tasks, according to some examples.

FIG. 7 is a block diagram illustrating components of a single AI agent, according to some examples.

FIG. 8 is a block diagram illustrating various components and processes of an AI coworker system, according to some examples.

FIG. 9 is a flowchart illustrating a method for generating and managing an AI coworker, according to some examples.

FIG. 10 is a flowchart illustrating a method for role-based AI coworker customization with adaptive learning, according to some examples.

FIG. 11 is a flowchart illustrating a method for multi-agent coordination and communication, according to some examples.

FIG. 12 is a flowchart illustrating a method for automated task generation, prioritization, and allocation, according to some examples.

FIG. 13 is a flowchart illustrating a method for generating customized large language model instances, according to some examples.

FIG. 14 is a block diagram illustrating an algorithm architecture for executing tasks within a digital co-worker system, according to some examples.

FIG. 15 is a user interface diagram illustrating a login screen for a finance productivity application, according to some examples.

FIG. 16 is a user interface diagram illustrating an account settings screen within a finance productivity application, according to some examples.

FIG. 17 is a user interface diagram illustrating a home screen with task board and key performance indicators within a finance productivity application, according to some examples.

FIG. 18 is a user interface diagram illustrating a task board interface within a finance productivity application, according to some examples.

FIG. 19 is a user interface diagram illustrating a new task creation interface within a finance productivity application, according to some examples.

FIG. 20 is a user interface diagram illustrating an AI chat interface overlaid on a task board within a finance productivity application, according to some examples.

FIG. 21 is a user interface diagram illustrating a key performance indicators dashboard within a finance productivity application, according to some examples.

FIG. 22 is a user interface diagram illustrating an AI chat interface for setting up a KPI dashboard within a finance productivity application, according to some examples.

FIG. 23 is a user interface diagram illustrating a data query interface within a finance productivity application, according to some examples.

FIG. 24 is a user interface diagram illustrating a data visualization interface within a finance productivity application, according to some examples.

FIG. 25 is a user interface diagram illustrating an analytics workbench interface within a finance productivity application, according to some examples.

FIG. 26 is a user interface diagram illustrating an AI chat interface for data reconciliation within an analytics workbench, according to some examples.

FIG. 27 is a user interface diagram illustrating an AI chat interface for financial analysis within an analytics workbench, according to some examples.

FIG. 28 is a user interface diagram illustrating a connections interface for integrating third-party systems within a finance productivity application, according to some examples.

FIG. 29 is a user interface diagram illustrating a data linking interface within an analytics workbench, according to some examples.

FIG. 30 is a user interface diagram illustrating a mailbox interface with suggested tasks within a finance productivity application, according to some examples.

FIG. 31 is a user interface diagram illustrating an AI chat interface displaying suggested tasks created from emails within a finance productivity application, according to some examples.

FIG. 32 is a block diagram showing a software architecture within which the present disclosure may be implemented, according to some examples.

FIG. 33 is a diagrammatic representation of a machine in the form of a computer system within which a set of instructions may be executed for causing the machine to perform any one or more of the methodologies discussed herein, in accordance with some examples.

### DETAILED DESCRIPTION

### Overview

The described examples relate to an adaptive AI coworker system designed to enhance organizational operations across various domains.

Examples addresses the challenges faced by operational teams in managing complex workflows and tasks, processing large volumes of diverse data, and adapting to dynamic business environments.

The present disclosure provides a computer-implemented system that autonomously integrates and processes data from multiple heterogeneous sources using advanced machine learning and natural language processing techniques. By employing specialized data access agents and adaptive learning modules, the system continuously aggregates, normalizes, and analyzes information from emails, calendar events, system alerts, and enterprise databases. These operations are executed by computer processors, memory modules, and AI engines, enabling real-time, context-aware task generation and execution. This technical solution improves computer functionality by reducing operational latency, enhancing data-driven decision support, and enabling dynamic resource allocation, thereby transforming enterprise automation into a self-optimizing process.

In some examples, a system architecture comprises multiple interconnected layers and components that work together to provide an AI-powered solution for automating and enhancing organizational operations. Systems may utilize a digital co-worker platform that creates personalized or customized AI co-workers tailored to specific team roles.

A user interface layer serves as the primary interaction point between users and the system.

It allows users to input job description data (role description data), provides user interaction data, and receives user feedback. This interface may be implemented as a web-based or application-based platform, enabling users to access the system through various devices.

A role creation layer analyzes the job description data to identify required skills and responsibilities.

It then maps this information to predefined role templates, such as various operational roles within the organization. The system customizes these templates based on the specific requirements outlined in the job description.

The task agents layer comprises specialized AI agents designed to perform a variety of tasks.

These may include data monitoring tasks, operational tasks, analytics tasks, and communication tasks. For example, agents may be designed to track key performance indicators, oversee operational flows, perform reconciliations, generate reports, conduct variance analysis, and forecast operational metrics.

The data processing agents layer includes components for optical character recognition (OCR), data cleaning, entity extraction, document classification, and data aggregation.

These agents process and prepare data from various sources for analysis and task execution.

The data sources layer integrates information from multiple systems, including Enterprise Resource Planning (ERP) systems, Customer Relationship Management (CRM) platforms, email systems, and document management systems.

This integration allows the AI coworker to access and analyze data from across the organization.

Large Language Models (LLMs) are integrated throughout the system to enhance natural language processing capabilities. This enables the AI co-workers to understand and generate human-like text for improved communication and task execution.

Some examples employ a multi-agent coordination approach, where multiple AI agents can interact with each other and with human team members.

These agents can break down complex tasks into subtasks and coordinate their execution. The main agent, referred to as Emma in some examples, acts as the central processing unit of the operation. It receives user inputs and coordinates the required actions across the system.

A task handler is responsible for analyzing and managing tasks. It comprises components for task understanding, which analyzes task descriptions and breaks them down into manageable subtasks, and a task aggregator, which organizes and prioritizes tasks.

Example systems may include a capability assessment module that evaluates the AI co-worker's proficiency in various skills and identifies areas for improvement.

This information can be used to continuously refine and enhance the AI co-worker's capabilities through ongoing training and learning processes.

Adaptive learning allows the AI coworker to learn and adapt to each organization's unique practices and data structures. This is achieved through a combination of fine-tuning, few-shot learning, and retrieval augmentation techniques.

Example systems can automatically generate, prioritize, and allocate tasks based on role requirements, organizational context, and time sensitivity. For example, they may utilize natural language processing and machine learning techniques to interpret role requirements and organizational context, generating tasks that align with the specific needs of the team.

A task prioritization module organizes tasks based on various factors, including manager input, time sensitivity, and task importance. It employs algorithms that consider multiple criteria to assign priority levels to each task, ensuring that the most critical tasks are addressed first.

Some examples create customized LLM instances for each role and organization. These fine-tuned LLMs incorporate organization-specific data, operational practices, and learning from interactions. This allows the AI coworker to provide more accurate and context-aware responses and decisions. In some examples, at least one instance of the customized LLM is a FinEdge LLM.

Intelligent data integration can integrate data from various sources, such as ERP systems and other organizational platforms. The system implements data governance measures to ensure that only appropriate data is accessed based on the user's role.

Some examples also incorporate explainable AI features for operational decision-making. This provides transparency in its decision-making process, particularly for critical operational tasks. In some examples, each task executed by an AI coworker is associated with at least one task execution decision that led to an action being performed by the AI coworker. The AI coworker can offer an explanation for its action for each task execution decision and allows for dialogue to refine its understanding. The dialogue may include feedback on the explanation and the AI coworker can be further trained based on the feedback.

Security and compliance implements access controls to ensure the AI coworker only accesses data and performs tasks appropriate for its particular role. The system also incorporates knowledge of relevant regulations, standards, and industry best practices relevant to each role.

The described examples can be implemented in various ways. They may be deployed as part of a cloud-based service, managing resource allocation for the selected AI agents across distributed computing resources to optimize performance and efficiency of task execution. Alternatively, they may be implemented as an on-premises solution for organizations with specific security requirements.

In summary, the described examples present a comprehensive AI-powered solution for enhancing operations and task management in organizations.

By combining role-based customization, adaptive learning, multi-agent coordination, and intelligent data integration, the system aims to address the challenges of complex workflows, data processing, and decision-making in modern business environments.

### Networked Computing Environment 100

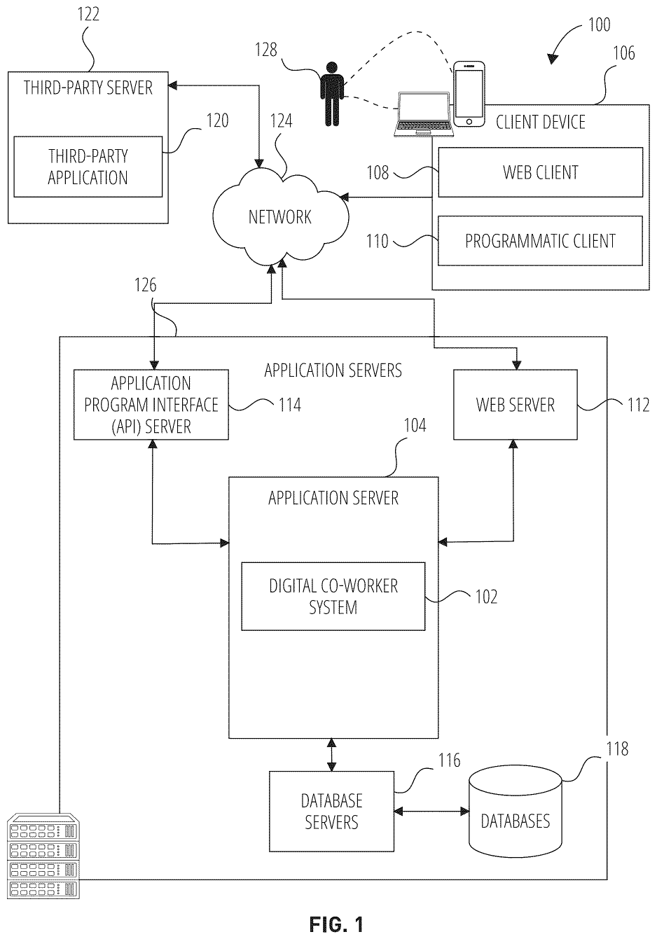

FIG. 1 illustrates a networked computing environment 100 that implements a digital co-worker system for organizational (e.g., corporate) teams. This environment comprises several interconnected components that work together to provide an AI-powered solution for automating and enhancing organization or enterprise operations.

The networked computing environment 100 includes a digital co-worker system 102, hosted on an application server 104. This AI-driven platform creates customized AI co-workers tailored to specific team roles, automates tasks, and continuously learns from feedback to improve performance. Features include role-based AI co-worker generation, task management and automation, adaptive learning capabilities, integration with various data sources and company systems, and communication interfaces for user interaction.

Users interact with the digital co-worker system 102 through client devices 106, accessing the digital co-worker system 102 via web clients 108 (e.g., browsers) or programmatic clients 110 (e.g., dedicated applications). These client-side interfaces communicate with the system through a web server 112 and an Application Program Interface (API) server 114, ensuring seamless interaction between users and the AI co-workers.

The networked computing environment 100 also includes database servers 116 a databases 118 that facilitate the management and processing of data. These databases store information that the digital co-worker system uses to perform its tasks and generate insights.

Third-party applications 120 can also integrate with this system, leveraging its capabilities to enhance their own functionalities. These applications run on third-party servers 122 and communicate with the digital co-worker system via the Application Program Interface (API) server 114. Examples of such applications might include Enterprise Resource Planning (ERP) systems, Customer Relationship Management (CRM) platforms, accounting software, or business intelligence tools. These integrations allow for a more comprehensive and interconnected organization or enterprise ecosystem.

The networked environment is connected via a network 124, which enables communication between all components. This creates a robust infrastructure for deploying AI-powered organization assistance, enabling finance teams to work more efficiently and make data-driven decisions.

### Digital Co-worker System 102

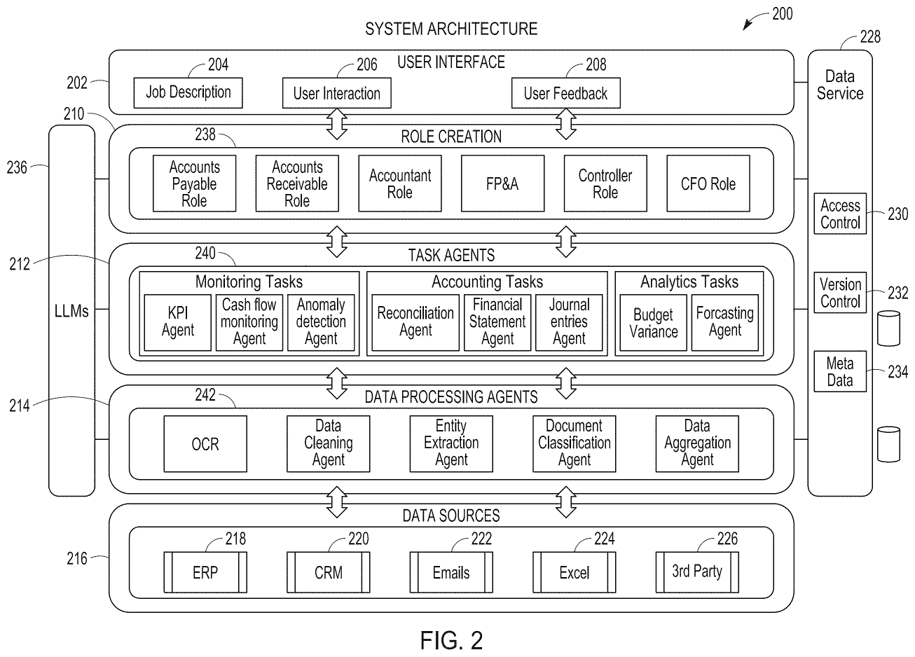

FIG. 2 is a system architecture diagram showing a detailed view of a digital co-worker system 102 for finance teams, according to some examples.

The system architecture 200 comprises multiple interconnected layers and components that work together to provide an AI-powered solution for automating and enhancing organization operations.

The user interface layer 202 serves as the primary interaction point between users and the system. It allows users to input job description data 204 (role description data), provides user interaction data 206, and receives user feedback 208. The interface may be implemented as a web-based or application-based platform, enabling users to access the system through various devices.

The user interface layer 202, according to some examples, may comprise several components that facilitate user interaction, data input, and system output:
Job Description Input: This component allows users to input detailed job descriptions/role descriptions and role requirements directly into the system. The information provided is used to configure and deploy AI co-workers tailored to specific operational needs within an operational team.
Chat Interface: This feature enables real-time interaction between users and AI co-workers. Users can query data, request reports, or specify tasks through a conversational interface, enhancing system usability and responsiveness to user needs.
Feedback Mechanism: Users can provide feedback on AI co-workers'performance and output via the chat interface. This feedback is used for the continuous learning and adaptation of the AI models, enabling them to refine their operations and improve accuracy over time.
Customizable Dashboards: The interface includes dashboards that display financial data, analytics, and Key Performance Indicators (KPIs) in a readily comprehensible format. These dashboards may be tailored to meet the specific needs of different users, from operational staff to senior management, providing relevant insights at a glance.
Notification and Alert System: This component keeps users informed of helpful updates, anomalies detected by the system, or urgent tasks that require attention. It ensures that important information is promptly communicated and acted upon.
Security Features: Robust security measures are integrated into the interface to protect sensitive financial data and user interactions. These include multi-factor authentication, data encryption, and secure access protocols, safeguarding the system's integrity and user data against unauthorized access.

The user interface layer is designed to be intuitive, secure, and flexible, providing a seamless interface between the complex functionalities of the AI-powered finance automation system and its users. It ensures that the benefits of the system are maximized, making advanced AI capabilities accessible and effective for enhancing organization operations The role creation layer 210 utilizes the user input to generate specialized AI co-workers for specific operational roles. Within the example context of an organization team, this layer may include modules for creating various finance roles such as Accounts Payable Role, Accounts Receivable Role, Accountant Role, FP&A Role, Controller Role, and CFO Role. The role creation process involves analyzing the job description/role description and required skills to tailor the AI co-worker's capabilities.

The role creation layer 210 employs advanced natural language processing and machine learning techniques to analyze the job descriptions and role requirements provided by users. This analysis involves parsing the text to extract key information such as required skills, responsibilities, and qualifications. The digital co-worker system 102 may utilize named entity recognition to identify specific financial terms, tools, and processes mentioned in the job description.

Once the job description is analyzed, the role creation layer 210 maps the extracted information to predefined role templates. These templates serve as a foundation for creating specialized AI co-workers. For example, an Accounts Payable Role template may include modules for invoice processing, vendor management, and payment scheduling. The system then customizes these templates based on the specific requirements outlined in the job description.

The role creation process also involves skill integration, where the AI co-worker is equipped with capabilities to perform role-specific tasks. For instance, an AI co-worker for an Accounts Receivable Role may be trained in invoice generation, payment tracking, and customer communication. This may involve fine-tuning large language models with domain-specific financial data and task-oriented training.

Additionally, the role creation layer 210 may incorporate, for example, a knowledge base of financial regulations, accounting standards, and industry best practices relevant to each role. This ensures that the AI co-worker can operate within the appropriate regulatory framework and adhere to professional standards.

The digital co-worker system 102 may also include a capability assessment module that evaluates the AI co-worker's proficiency in various skills and identifies areas for improvement. This information can be used to continuously refine and enhance the AI co-worker's capabilities through ongoing training and learning processes. Thus, the adaptive learning mechanisms enhance the digital co-coworker system 102's ability to process information over time.

The task agents layer 212 comprises specialized AI agents designed to perform a variety of tasks. For example, in the context of an organizational operations team the agents may be designed to perform tasks such as the following:
Data Monitoring Tasks:
   KPI Monitoring: Tracks key performance indicators to gauge business health.
   Cash Flow Monitoring: Oversees cash inflows and outflows to manage liquidity.
   Anomaly Detection: Identifies unusual patterns that may indicate errors or fraud.
Accounting Tasks:
   Reconciliation: Matches ledgers and records for consistency.
   Financial Statements Preparation: Compiles data into standard financial documents.
   Journal Entry Checks: Ensures accuracy in the recording of financial transactions.
Analytics Tasks:
   Budgeting: Helps in preparing detailed budgets.
   Forecasting: Predicts future financial conditions based on historical data.
   Variance Analysis: Compares planned financial outcomes with actual figures.
   Flux Analysis: Analyzes fluctuations in account balances over time.

The data processing agents layer 214 are responsible for preparing and transforming data for use by the task agents layer 212. This layer includes:
OCR (Optical Character Recognition): Converts text from scanned documents and images into machine-readable text.
Data Cleaning: Cleanses the data by fixing or removing incorrect, corrupted, incomplete, or duplicate data.
Entity Extraction: Identifies and classifies key pieces of information in text, such as names and places.
Document Classification: Categorizes documents into predefined classes.
Data Aggregation: Consolidates data from different sources for easier processing and analysis.

Thus, the data processing agents layer 214 includes agents that autonomously connect to internal and external data sources, retrieves relevant information, and processes it for downstream analysis. The agents utilizes secure APIs, OCR technology, and real-time event monitoring to ensure efficient and accurate data extraction.

The data sources layer 216 gathers and integrates data from various internal and external systems, including:
1. ERP (Enterprise Resource Planning) systems 218
2. CRM (Customer Relationship Management) systems 220
3. Email systems/mailboxes 222
4. Excel spreadsheets 224
5. Third-party systems 226

The digital co-worker system 102 may also incorporate a data service 228 that manages data governance, including access control 230, version control 232, and metadata 234. This ensures data security, maintains data integrity and facilitates efficient data retrieval and processing.

Large Language Models (LLMs) 236 are integrated throughout the digital co-worker system 102 to enhance natural language processing capabilities, enabling the AI co-workers to understand and generate human-like text for improved communication and task execution.

The system architecture 200 is designed to be modular and scalable, allowing for the addition of new components or the enhancement of existing ones as the needs of finance teams evolve. The interconnected nature of the components enables seamless data flow and task execution across different layers, providing a comprehensive solution for finance automation and decision support.

### Software Architecture 300

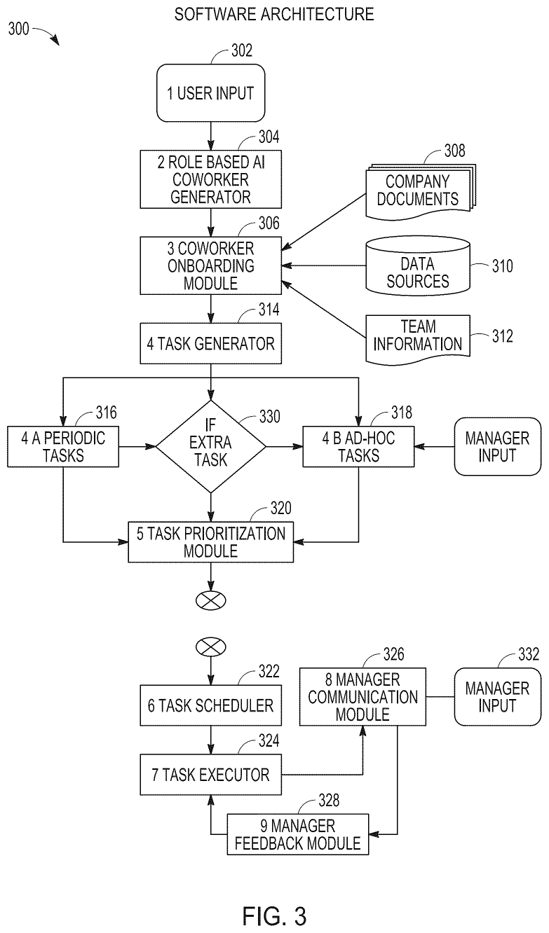

FIG. 3 is a software architecture diagram showing a detailed view of software architecture 300 of a digital co-worker system 102 for operational teams, according to some examples.

The software architecture 300 comprises multiple interconnected modules that work together to provide an AI-powered solution for automating and enhancing organizational operations.

User input 302 is received via the user interface layer 202 layers and includes detailed information about the role and responsibilities required for the finance team. This may include specific job descriptions, such as requirements for an Accounts Receivable manager with particular experience and expertise in financial tools.

A role-based AI co-worker generator 304 processes the user input 302 to create a specialized AI co-worker. For example, the role-based AI co-worker generator 304 analyzes the job description, interprets role requirements, and integrates multiple skills required for the specified role. For example, an AI co-worker for an Accounts Receivable role may be equipped with skills for invoice management, payment collection, and account reconciliation. The module may utilize fine-tuned large language models to execute role-specific tasks. For example, the role-based AI co-worker generator 304 may perform the following operations:
Input Analysis: The role-based AI co-worker generator 304 processes the job description/role description provided in the user input. It interprets the role requirements and responsibilities to understand the specific skills and capabilities needed for the AI co-worker.
Skill Integration: The AI coworker integrates multiple skills required for the specified role. For example, for the role of AR manager, the coworker may be loaded with specialized skills for managing accounts receivable, such as invoice management, payment collection, account reconciliation, conduction analysis, credit management and analysis, dispute management, etc. These skills enable the AI coworker to execute multiple tasks such as reconciliation, financial reporting, account management, etc. Here, the large language-based models are fine-tuned to execute these tasks based on the role.
Tool Proficiency: The AI co-worker may be trained to use the tools specified in the job description. It will also get loaded with skills to operate and understand tools such as NetSuite, Excel, SalesForce etc.

A co-worker onboarding module 306 facilitates the AI co-worker's integration into the company's systems and processes. It accesses company documents 308, data sources 310, and team information 312 to provide company-specific training. This module employs Retrieval Augmented Generation (RAG) techniques to assimilate company-specific information, enabling the AI co-worker to make informed decisions and execute tasks within the company's context.

For example, the co-worker onboarding module 306 may perform the following operations:
Company-Specific Training:
   Company Information: The AI co-worker reviews detailed information about the company, including its history, mission, organizational structure, and culture.
   Employee and Team Details: Understanding the team dynamics, key personnel, and how the finance department interacts with other parts of the organization.
   Financial Documents: Examining financial documents such as customer information, company reports, financial statements, and other relevant records to gain a comprehensive understanding of the company's financial operations.
Data Integration: The AI co-worker may be granted access to various data sources within the company. It begins to assimilate and connect data from different systems to create a unified view of the company's financial landscape.
Personalization: Through this onboarding process, the AI co-worker learns the specific financial practices and workflows of the company, allowing it to tailor its functions to align with the company's unique needs. Here, the Retrieval Augmented Generation (RAG) technique is used to assimilate company-specific information for the AI coworker to execute tasks and make decisions.
Continuous Learning: The AI co-worker may be designed to continually learn and adapt, integrating feedback and improving its performance over time to better serve the company's evolving requirements.

A task generator 314, in some examples, creates both periodic tasks 316 and ad-hoc tasks 318 based on the AI co-worker's role understanding. Periodic tasks may include regular responsibilities such as payment tracking or financial reporting, while ad-hoc tasks arise from immediate needs or manager instructions.

For example, the task generator 314 may perform the following operations:
Role Understanding: After the AI co-worker completes its onboarding, the task generator 314 thoroughly understands its role and responsibilities.
Task Creation:
   Periodic Tasks: Tasks that are regularly scheduled and integral to the particular role. For an AR Manager, these include:
      Payment Tracking: Monitoring and managing incoming payments.
      Aging Analysis: Assessing outstanding receivables and their age.
      Account Reconciliation: Ensuring all accounts are accurate and balanced.
   Financial Reporting: Preparing and presenting financial reports.
   Ad-Hoc Tasks: These tasks arise based on immediate needs or manager instructions. User inputs and system events are monitored and immediate needs within the organization are identified based on the user inputs and system events. The ad-hoc tasks are generated based on the identified needs of the organization. For instance:
      Collection Follow-Ups: Initiated based on aging analysis or direct manager input.
Task Generation: The AI co-worker dynamically generates these tasks, ensuring they align with the specific requirements of the role.

The AI coworker thus employs advanced machine learning models and natural language processing to analyze organizational context, historical data, and real-time events.

The system dynamically generates, prioritizes, and executes tasks tailored to specific roles and operational requirements, adapting to evolving business conditions without human intervention. These technical operations are performed by neural network engines, processors, and memory modules, enabling autonomous workflow management and real-time decision support. The adaptive task generation and execution system transforms enterprise automation into a self-optimizing process, providing a technical improvement to computer functionality.

A task prioritization module 320, according to some examples, organizes tasks based on various factors, including manager input, time sensitivity, and task importance. It efficiently manages the task queue to optimize workflow.

The task prioritization module 320, may for example, perform the following operations:
Input Analysis: Prioritizes tasks based on:
   Manager Input: Direct instructions and preferences from the manager.
   Time Sensitivity: Recognizing periods in the financial calendar (e.g., month-end, quarter-end).
   Task Importance: Weighing tasks by their impact and urgency.
Task Queue Management: Efficiently organizes tasks to optimize workflow and ensure high-priority tasks are addressed first.

A task scheduler 322, according to some examples, assigns specific times for task execution, considering task priority and manager preferences. It ensures even distribution of tasks to maintain productivity and prevent bottlenecks.

For example, the task scheduler 322 may perform the following operations:
Time Allocation: Assigns specific times for task execution based on:
   Task Priority: Scheduling high-priority tasks during optimal work periods.
   Manager Preferences: Aligning with a manager's scheduling inputs and preferences.
Automated Planning: Ensures that tasks are evenly distributed and executed within appropriate time frames to maintain productivity and prevent bottlenecks.

A task executor 324, according to some examples, carries out the scheduled tasks using predefined procedures and the skills integrated during the role-based AI co-worker generation. It adapts execution strategies based on real-time data and feedback.

For example, the task executor 324 may perform the following operations:
Task Retrieval: Picks up tasks from the task scheduler 322 as per the planned schedule.
Execution: Carries out tasks using predefined procedures and the skills loaded during the role-based AI co-worker generation.
Adaptability: Adjusts execution strategies based on real-time data and feedback to ensure tasks are completed efficiently and accurately.

A manager communication module 326 alerts the manager upon task completion and provides detailed reports on task outcomes. It allows for result review, ensuring transparency and accountability.

For example, the manager communication module 326 may perform the following operations:
Notification System: Alerts the manager upon task completion through preferred communication channels.
Result Reporting: Provides detailed reports on the outcomes of executed tasks.
Review Mechanism: Allows the manager to review results, ensuring transparency and accountability in task execution.

A manager feedback module 328 enables managers to provide feedback via a chat interface. This feedback is processed by the AI co-worker for task corrections and stored for future performance improvement. The manager feedback module 328 facilitates adaptive learning, enhancing the AI co-worker's efficiency and accuracy over time.

For example, the manager feedback module 328 may provide:
Feedback Interface: Enables the manager to provide feedback via a chat interface.
Feedback Processing: The AI co-worker processes this feedback to make immediate corrections to tasks.
Memory Integration: Stores feedback to improve future task performance, ensuring continuous learning and improvement.
Adaptive Learning: Uses stored feedback to adjust task execution strategies, enhancing the AI co-worker's efficiency and accuracy over time.

The software architecture 300 incorporates manager input at multiple stages, allowing for human oversight and guidance in the AI co-worker's operations. This design ensures a collaborative approach between human managers and AI assistants in organizational operations.

### Database Architecture 400

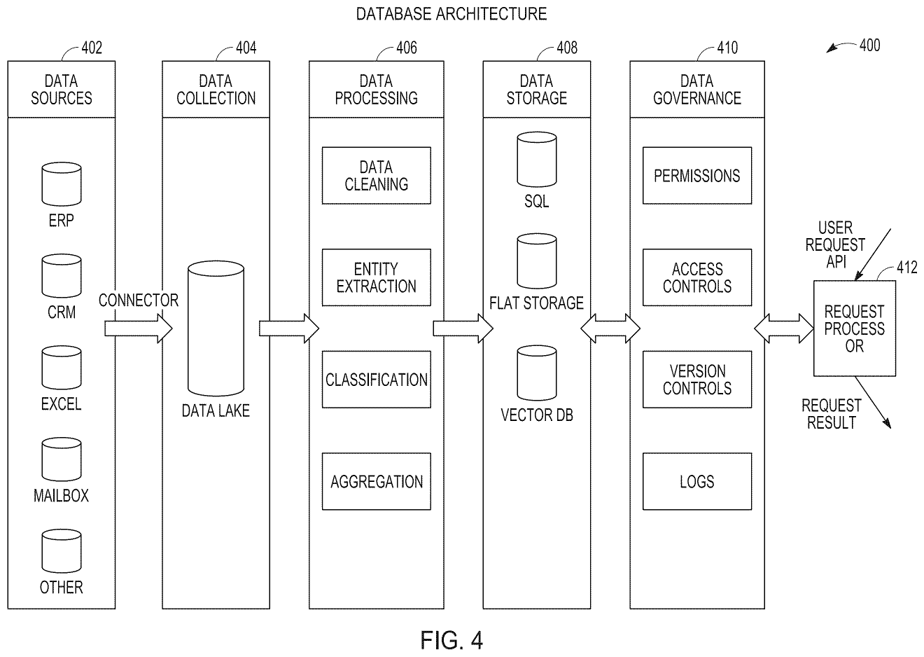

FIG. 4 is a database architecture diagram showing a detailed view of a database architecture 400 of data management system for a digital co-worker system 102, according to some examples.

The database architecture 400 comprises multiple interconnected layers that work together to collect, process, store, and manage data for organizational operations.

The data sources layer 402 gathers data from various business systems and external sources essential for organizational analysis and operations. This layer may include:
1. ERP (Enterprise Resource Planning) systems 218: Collect enterprise resource planning data including transactions, operations, and financials.
2. CRM (Customer Relationship Management) systems 220: Retrieve customer relationship data to integrate customer interactions and sales data.
3. Excel spreadsheets 224: Import data from spreadsheets used for financial tracking and reporting.
4. Email systems/mailboxes 222: Extract relevant financial information from email communications.
5. Other sources (e.g., third-party system 226): Incorporate additional data sources as needed to enrich the data landscape.

The data collection layer 404 consolidates data from the initial sources into a centralized data lake. This layer may utilize:
1. Data Lake Storage: Acts as a staging area and repository for raw data collected from various sources in its native format.
2. Connectors: Specialized tools and software facilitate the seamless extraction and transmission of data from source systems to the data lake.

The data processing layer 406 performs processing to ensure data accuracy, usability, and value. This layer includes:
1. Data Cleaning: Removes inconsistencies, duplicates, and errors to ensure data quality.
2. Entity Extraction: Identifies and extracts specific entities such as dates, monetary amounts, or company names from unstructured data.
3. Document Classification: Categorizes documents based on predefined criteria to streamline processing and retrieval.
4. Data Linking and Aggregation: Combines data from different sources to provide a unified view, summarizing information where necessary.
5. Ambiguity Resolution: Resolves conflicts and ambiguities in data to prevent errors in downstream processing.

The data storage layer 408 stores processed data across multiple storage solutions, optimized for different types of queries and access patterns:
1. SQL Database: Stores structured data in relational tables, ideal for complex queries involving joins and aggregations.
2. Key-Value Store: Facilitates quick retrieval of data based on a key; useful for session storage and caching.
3. Vector Database: Manages unstructured data with indexing that supports efficient searching and similarity assessments.
4. Flat Storage (S3): Utilizes object storage for vast amounts of unstructured data, providing scalability and data durability.

The data governance layer 410 ensures that data usage complies with policies and regulations and that data integrity and privacy are maintained. This layer may include:
1. Access Control: Manages who can access what data, ensuring that users only see data relevant to their role and permissions.
2. Version Control: Keeps track of different versions of data, allowing for audit trails and historical analysis.
3. Logging and Monitoring: Tracks data access and changes, providing insights into data usage patterns and potential security breaches.
4. Regulatory Compliance: Implements rules and mechanisms to ensure that data storage and processing comply with legal and corporate standards.

The request processor layer 412 handles incoming user requests, integrating tightly with the application's front end via APIs. This layer may include:
1. API Management: Routes requests to the appropriate data services, ensuring that interactions are smooth and secure.
2. Permission Handling: Checks user permissions to determine the data access level, ensuring compliance with governance rules.
3. Data Retrieval: Decides which data sources to query based on the user request and operational logic, pulling the appropriate data efficiently.

This multi-layered architecture ensures that the system efficiently processes and stores a wide array of financial data while adhering to strict governance standards. It enables secure, scalable, and rapid access to information, supporting the dynamic needs of modern organizational operations and ensuring data is always accurate, accessible, and actionable.

### AI Agent Architecture

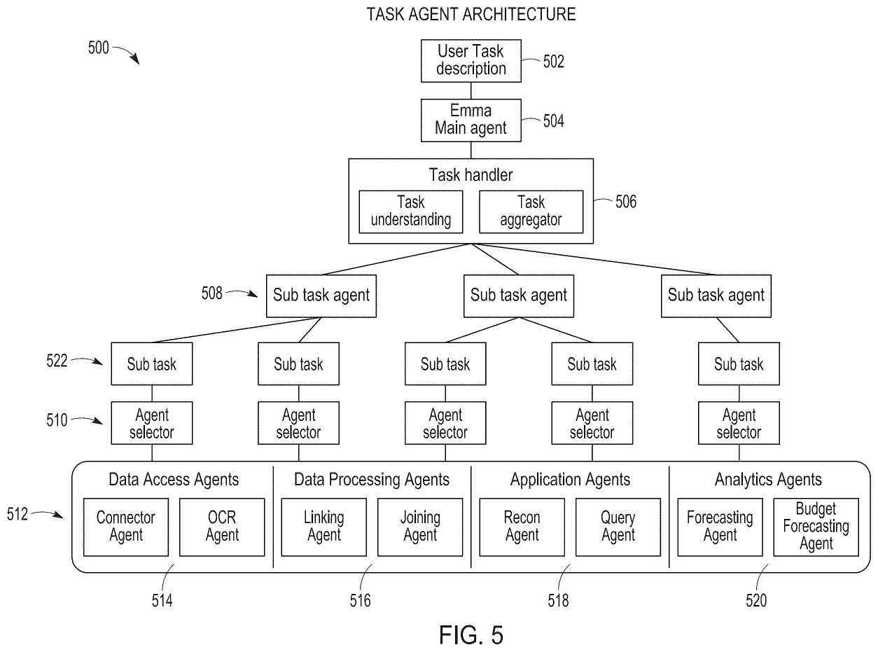

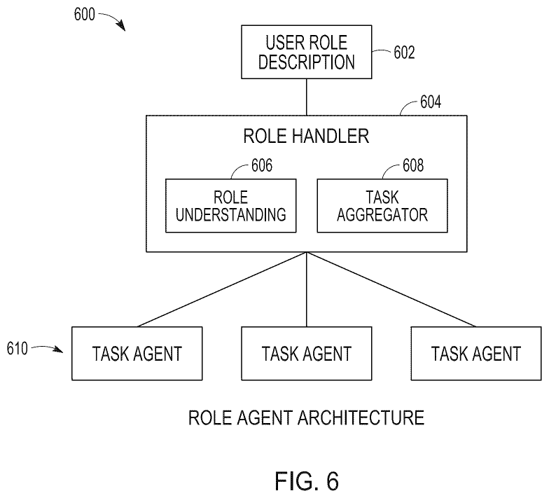

FIG. 5 and FIG. 6 illustrate the architecture of the AI Agent system designed for finance automation. This system comprises two primary types of agents: Task Agents and Role Agents, each tailored to handle specific aspects of organizational operations.

FIG. 5 depicts the task agent architecture 500, which is designed to efficiently manage and execute a variety of tasks based on user inputs and automated system needs. The architecture includes a user task description 502 as input, which is processed by the main agent 504 (e.g., Emma).

A task handler 506 analyzes and breaks down tasks into subtasks, while subtask agents 508 further decompose tasks as needed. Agent selectors 510 choose appropriate subtask agents for execution. The system incorporates specialized agents for data access, data processing, application-specific tasks, and analytics.

FIG. 6 shows the role agent architecture 600, which is structured to understand and execute tasks based on specific roles within the organizational team. It begins with a user role description 602, which is processed by the role handler 604. The role understanding component 606 analyzes the role requirements, and the task aggregator 608 organizes role-specific tasks. These tasks are then executed by task agents 610 tailored to the particular organizational role.

Both architectures work in tandem, enabling the system to handle a wide range of tasks with specialized, intelligent, and autonomous agents. Each agent employs a problem-solving approach, breaking down tasks into subtasks and making decisions based on subtask results. The system also facilitates communication between multiple agents for collaborative decision-making and task execution

Turning specifically to FIG. 5, a task agent architecture 500, as may be implemented within a digital co-worker system 102 for finance teams, is shown, according to some examples.

The task agent architecture 500 comprises multiple interconnected modules that work together to efficiently manage and execute a variety of tasks based on user inputs and automated system needs.

User task descriptions 502 serve as the input to the digital co-worker system 102, where users submit queries or descriptions of tasks to be performed.

A main agent 504, for example referred to as Emma, acts as the central processing unit of the operation. The main agent 504 receives the user inputs and coordinates the required actions across the system.

A task handler 506 is responsible for analyzing and managing the tasks. It comprises at least two example components:
1. Task understanding: This component analyzes the task description, breaking it down into manageable subtasks while identifying dependencies and necessary components of the task.
2. Task aggregator: After all subtasks have been processed, this module aggregates the results and synthesizes the outcomes, ensuring cohesive output.

The task agent architecture 500 includes multiple sub-task agents 508 that evaluate their specific tasks and, if needed, further decompose them into finer subtasks. This ensures detailed attention to each aspect of the task.

The task agent architecture 500 further incorporates agent selectors 510 that choose the appropriate subtask agents to execute parts of the task. These agent selectors 510 provide detailed instructions and ensure that the most suitable resources are used for each task component.

The task agent architecture 500 features a pool of specialized agent pool 512 designed to handle various aspects of organizational operations, for example:
1. Data access agents 514: Include specialized agents such as OCR agents, connectors for data sources like ERP systems and spreadsheets, CSV file readers, and email connectors.
2. Data processing agents 516: Handle data linking, cleaning, deduplication, formatting, and storage across various systems like vector databases, SQL databases, and flat storage solutions.
3. Application agents 518: Perform specialized tasks such as reconciliation, financial statement preparation, querying data, and contract review and analysis.
4. Analytics agents 520: Conduct financial analysis, including forecasting, fraud detection, anomaly detection, and budgeting.

This multi-layered task agent architecture 500 ensures efficient task management, processing, and execution within the digital co-worker system, enabling it to handle a wide range of organizational operations and queries.

FIG. 6 is a role agent architecture diagram showing a detailed view of a role agent architecture 600 within a digital co-worker system 102 for finance teams, according to some examples.

The role agent architecture 600 comprises multiple interconnected modules that work together to understand and execute tasks based on specific roles within the organizational team.

The user role description data 602 serves as the input to the role agent architecture 600, capturing the role description directly from user inputs. This input defines the tasks and responsibilities associated with a given organizational role.

A role handler 604 analyzes the role description, identifying and segmenting the role-specific tasks into actionable items for the system to address. This module comprises two main components:
Role understanding 606: This component analyzes the role requirements, extracting key information about the responsibilities and skills needed for the specific organizational role.
Task aggregator 608: This component organizes and consolidates the identified role-specific tasks, preparing them for execution.

The architecture includes multiple task agents 610 that are invoked by the role handler to carry out the necessary actions for each identified task. These task agents ensure that each aspect of the role's responsibilities is effectively managed and executed.

This role-based architecture enables the system to tailor its operations to specific organizational roles, allowing for more efficient and targeted task execution within the digital co-worker system.

### Single AI Agent

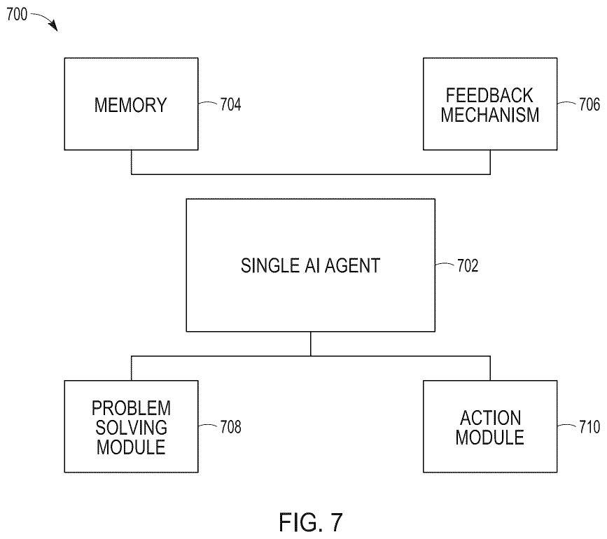

FIG. 7 is a block diagram showing a detailed view of a single AI agent 700 architecture within a digital co-worker system 102 for finance teams, according to some examples.

A single AI agent 702 comprises four interconnected modules that work together to enable intelligent and autonomous handling of organizational tasks:

A memory module 704 stores historical data and past decisions made by the agent. This module enables the agent to recall previous transactions, user interactions, and internal decisions, facilitating a context-aware approach to handling new tasks. The memory module 704 may utilize techniques such as vector databases or knowledge graphs to efficiently store and retrieve relevant information.

A feedback mechanism 706 receives and processes input from users or other system components. It processes both positive and negative feedback, which the digital co-worker system 102 uses to fine-tune the agent's performance. This feedback mechanism 706 may employ machine learning algorithms to analyze feedback patterns and adjust the agent's behavior accordingly. Thus, the LLM(s) integrated into the AI agent 702 are improved through the feedback and adjusted behavior.

A problem-solving module 708 provides operational intelligence to the AI agent 702. Equipped with advanced algorithms, it analyzes tasks, identifies potential solutions, and decides the best course of action. This problem-solving module 708 integrates various AI techniques, including machine learning and heuristic methods, to handle complex financial tasks such as data analysis, forecasting, and anomaly detection. The problem-solving module 708 may utilize techniques like decision trees, neural networks, or reinforcement learning algorithms to optimize its problem-solving capabilities.

An action module 710 executes tasks as determined by the problem-solving module 708. It acts on the decisions made and interacts with other system components to carry out the required actions. This action module 710 ensures that tasks are performed accurately and efficiently, coordinating with external systems and databases to execute operations such as data retrieval, updates, and reporting. It may implement APIs or use robotic process automation (RPA) techniques to interact with various organizational systems and tools.

The interconnected nature of these modules allows for continuous learning and adaptation. The feedback mechanism 706 informs the memory module, which in turn provides context for the problem-solving module 708 module. The action module 710 executes decisions and provides results back to the memory module 704, creating a closed-loop system for ongoing improvement in task performance and decision-making.

### AI Co-worker 800

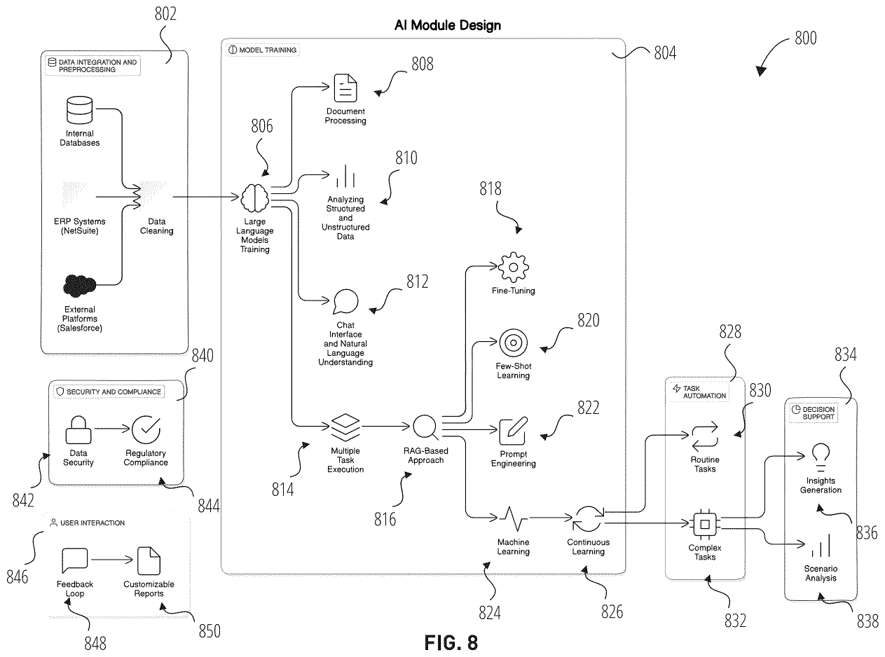

FIG. 8 is a block diagram showing a detailed view of an AI module design for an AI co-worker 800 for a digital co-worker system 102 for finance teams, according to some examples.

The AI module design comprises several interconnected components that work together to process financial data and perform various tasks.

A data integration and preprocessing component 802 integrates data from multiple sources, including internal databases, ERP (Enterprise Resource Planning) systems 218 (e.g., NetSuite), and external platforms (e.g., Salesforce). This component performs data cleaning to ensure accuracy and consistency, removing anomalies and standardizing formats.

A model training component 804 utilizes multiple AI techniques to enhance the AI co-worker's capabilities:
Large language models training 806 enables:
   Document processing 808: Extracts and interprets information from financial documents using natural language processing.
   Analyzing structured and unstructured data 810: Identifies patterns, trends, and anomalies in various data types.
   Chat interface and natural language understanding 812: Facilitates communication with finance team members through a conversational interface.
   Multiple task execution 814: Assigns different AI agents to specific tasks such as document processing, analytics, reconciliation, and forecasting.

RAG-based approach 816: Analyzes company-specific data using a Retriever-Answer Generator, retrieving information from a vast corpus and generating tailored answers.

Model tuning techniques:
Fine-tuning 818: Adapts AI models to the nuances of the financial sector and company-specific data.
Few-shot learning 820: Trains the AI with a small number of examples for quick adaptation to new tasks.
Prompt engineering 822: Guides language models in generating contextually relevant responses.

Machine learning 824: Develops models to predict, classify, and analyze financial outcomes based on historical data.

Continuous learning 826: Employs reinforcement learning or other adaptive techniques to refine models based on new data and feedback.

A task automation component 828 handles:
Routine tasks 830: Automates repetitive tasks such as data entry and basic reconciliations.
Complex tasks 832: Utilizes advanced algorithms for tasks like financial forecasting and risk assessment.

The decision support component 834 provides:
Insights generation 836: Analyzes financial data to suggest areas for cost reduction or investment opportunities.
Scenario analysis 838: Simulates various financial scenarios for future planning.

The security and compliance component 840 ensures:
Data security 842: Implements robust security measures to protect sensitive financial data.
Regulatory compliance 844: Ensures all data handling and financial practices meet legal requirements.

The user interaction component 846 facilitates:
Feedback loop 848: Allows finance team members to provide feedback on the AI co-worker's performance.
Customizable reports 850: Generates reports tailored to the specific needs of the finance team.

This AI module design enables the digital co-worker system to handle complex financial data through a combination of advanced data processing techniques, AI agents, machine learning algorithms, and domain-specific knowledge.

### Method 900

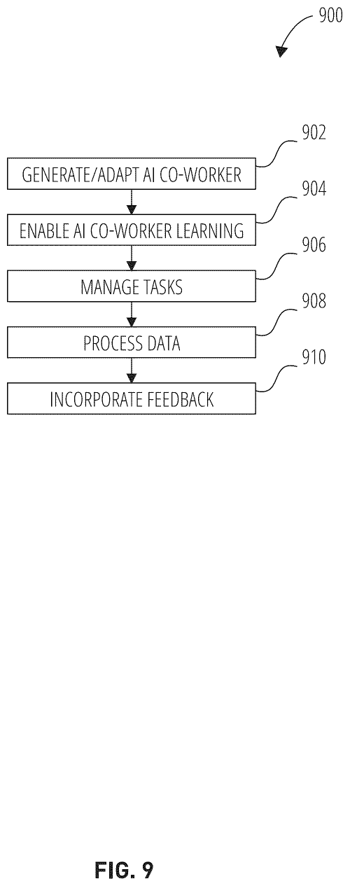

FIG. 9 is a flowchart illustrating a method 900, according to some examples, of providing a role-based, task-based AI co-worker for finance teams. Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 902, the method 900 generates or adapts a customized AI co-worker based on specific job requirements and roles. This operation may be performed by the role creation layer 210. The layer processes detailed job descriptions/role descriptions and integrates multiple specialized skills required for the specified role. In some examples, this may involve analyzing user input from the user interface layer 202 that defines job descriptions, roles, and responsibilities for the AI co-worker.

At block 904, the method 900 enables the AI co-worker to learn and adapt to a company's unique organizational practices and data structures. This operation may be performed by the co-worker onboarding module 306. The co-worker onboarding module 306 may employ a combination of fine-tuning, few-shot learning, and retrieval augmentation techniques to adapt to each company's specific needs and data structures. In some examples, this may involve an onboarding process where the AI co-worker learns company-specific information from documents 308, data sources 310, and team information 312.

At block 906, the method 900 manages tasks through at least one of generation, prioritization, scheduling, or execution assistance relevant to specific roles. This operation may be performed by the task agents layer 212 in conjunction with the task prioritization module 320 task scheduler 322, and task executor 324. The digital co-worker system 102 may categorize tasks into periodic tasks 316 and ad-hoc tasks 318 based on role requirements and immediate needs. In some examples, the system may autonomously execute tasks based on learned patterns and user preferences.

At block 908, the method 900 processes data from various sources to provide financial insights. This operation may be performed by the data processing agents layer 214. The agents may unify data from various sources 216 including ERP (Enterprise Resource Planning) system 218, CRM (Customer Relationship Management) system 220, email systems/mailboxes 222, and document systems 224. In some examples, this may involve applying machine learning algorithms to identify anomalies and patterns in organizational data.

At block 910, the method 900 incorporates feedback for improvement and adaptation to changing organizational practices. This operation may be performed by the manager feedback module 328. The manager feedback module 328 may refine the AI co-worker's performance over time based on user feedback 208. In some examples, this may involve storing and utilizing feedback for continuous improvement and accuracy.

The method 900 may also include additional operations not explicitly shown in the flowchart. For instance, the method may employ natural language processing capabilities to interact with users through natural language commands and queries via the user interface layer 202. It may integrate with third-party systems 226 for managing and analyzing blockchain-based financial transactions. The method may also include forecasting future financial trends and potential issues using analytics agents 520.

In some examples, the method 900 may handle organizational operations across different languages and regulatory environments. It may also generate customized organizational reports based on role-specific requirements and company practices using the application agents 518.

The method 900 may be implemented via a networked computing environment 100 accessible remotely by finance teams, allowing for scalability and easy updates. Alternatively, it may be implemented as an on-premises solution for organizations with specific security requirements.

### Method 1000

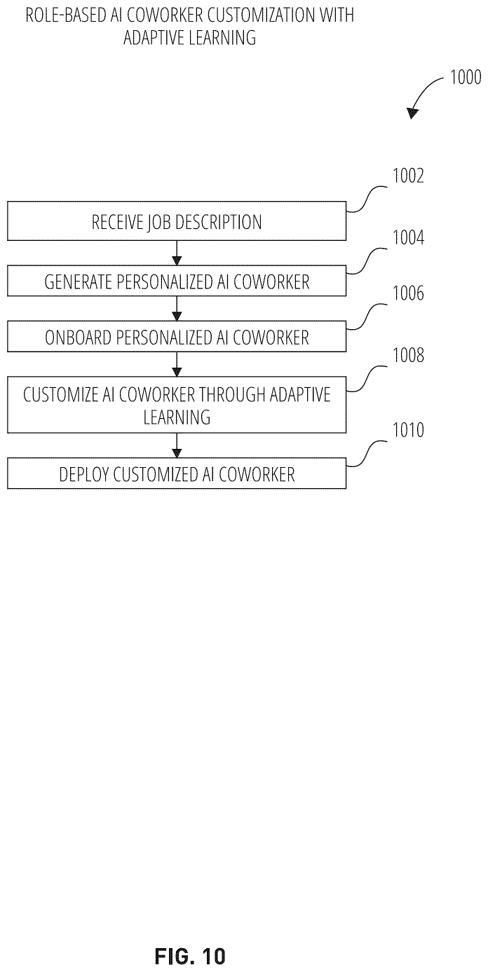

FIG. 10 is a flowchart illustrating a method 1000, according to some examples, of creating and customizing a role-based artificial intelligence (AI) coworker. Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1002, the method 1000 includes receiving a job description/role description. For example, the user interface layer 202 received and processes the job description data 204, which specifies requirements for a particular role within the finance team. The job description data 204 may include details such as required skills, tools, and responsibilities associated with the role.

At block 1004, the method 1000 includes generating a personalized AI coworker. In some examples, at a high level, this process involves analyzing input data, selecting appropriate components, and assembling a customized digital entity. The system utilizes various computational techniques to create a tailored solution based on specified requirements.

In more specific examples, the role-based AI co-worker generator 304 analyzes the job description data 204 to identify required skills and responsibilities. This analysis may involve natural language processing techniques to extract key information from the job description. The digital co-worker system 102 then selects and combines multiple AI agents 702 corresponding to the identified skills from a pool of pre-trained agents. These agents may represent different functional capabilities or domain expertise relevant to the specified role.

In even more specific examples, the generation process may include:
Detailed parsing of the job description data 204 using advanced natural language processing algorithms. This may involve tokenization, named entity recognition, and semantic analysis to identify specific skills, tools, and responsibilities required for the role.
A matching algorithm that compares the extracted requirements with the capabilities of available AI agents 702. This algorithm may use vector representations of skills and agent capabilities to compute similarity scores and determine the most suitable agents for the role.
An integration process that combines selected AI agents 702 into a cohesive system. This may involve:
   Establishing a hierarchical structure among agents, with a main agent 504 coordinating sub-task agents 508.
   Merging knowledge bases of selected agents, resolving conflicts and redundancies to create a unified knowledge repository.
   Synthesizing individual agent capabilities to create new, composite skills aligned with the role requirements.
   Generating a customized user interface tailored to the specific role and expected interactions within the finance team.
Equipping the personalized AI coworker with adaptive components such as:
   A memory module 704 for storing experiences and learned information.
   A feedback mechanism 706 for continuous improvement based on user interactions and task outcomes.
   A problem-solving module 708 capable of addressing situations by combining learned knowledge and reasoning capabilities.

This process creates a personalized AI coworker tailored to the specific role requirements, capable of performing specialized tasks and adapting to the unique context of the finance team.

At block 1006, the method 1000 includes onboarding the personalized AI coworker. The co-worker onboarding module 306 provides the AI coworker with access to company-specific data sources 310.

These may include documents 308, team information 312, and data from various systems such as ERP (Enterprise Resource Planning) system 218, CRM (Customer Relationship Management) system 220, email systems/mailboxes 222, and document systems 224. The AI coworker processes these documents and integrates them with existing company systems to gain a comprehensive understanding of the company's financial landscape.

At block 1008, the method 1000 includes customizing the AI coworker through adaptive learning. The system processes the company-specific data sources using data processing agents layer 214 to identify patterns and trends specific to the company's organizational practices.

Using techniques such as fine-tuning, few-shot learning, and retrieval-augmented generation (RAG), the AI coworker adapts its knowledge and decision-making processes to align with the company's unique needs. This customization may involve creating a unique instance of a machine-learning model such as a language model 236 and fine tuning the machine-learning model on the company-specific data sources. In some examples, the company-specific data sources include company-specific organization data and practices.

At block 1010, the method includes deploying the customized AI coworker. The system integrates the customized AI coworker with existing company workflows and enables communication between the AI coworker and human team members through interfaces such as the manager communication module 326.

The AI coworker is assigned tasks associated with its role, which may include both periodic tasks 316 and ad-hoc tasks 318 generated based on the role and company-specific requirements. The system implements access control 230 to ensure the AI coworker only accesses data and performs tasks appropriate for its particular role. As the AI coworker performs its tasks, the system monitors its performance, identifies areas for improvement, and continuously updates its knowledge and skills based on new data and experiences within the company, utilizing the manager feedback module 328.

### Method 1100

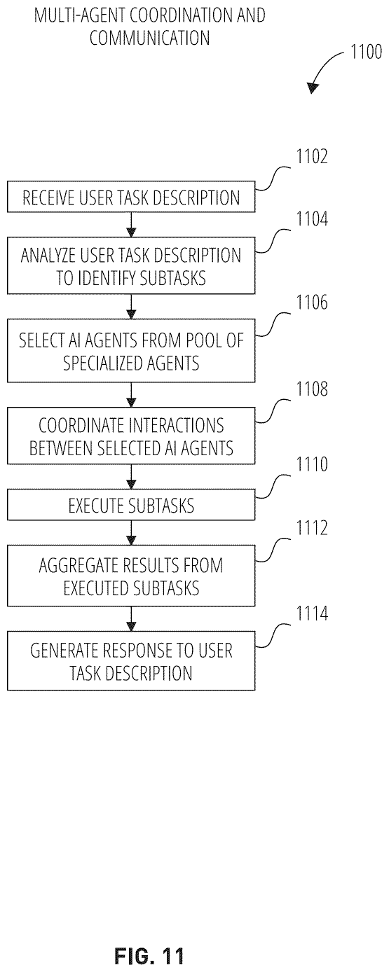

FIG. 11 is a flowchart illustrating a method 1100 for coordinating multiple AI agents in a digital co-worker system 102, according to some examples, of a role-based, task-based AI system for finance teams.

Although the example method 1100 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1102, at least one processor of the digital co-worker system 102 receives a user task description. This may involve receiving input through a user interface layer 202 that captures detailed information about the role and responsibilities required for the finance team.

A user task description 502 may be provided via a chat interface or other input mechanism of the digital co-worker system 102.

At block 1104, the at least one processor of the digital co-worker system 102 analyzes the user task description to identify subtasks. This analysis may involve multiple levels of processing to extract and interpret the task requirements.

In some examples, at a high level, the analysis may involve processing the textual input to determine the general nature and scope of the task. This may include identifying key terms and concepts related to organizational operations and team roles.

In more specific examples, the analysis may utilize natural language processing techniques to parse the user task description. This may involve tokenization, part-of-speech tagging, and named entity recognition to extract key information such as specific organizational tasks, required skills, and relevant tools or systems mentioned in the description.

In even more specific examples, the analysis may employ advanced machine learning models, such as large language models, to perform deep semantic analysis of the task description. These models may be fine-tuned on organizational domain knowledge and may utilize techniques such as few-shot learning or prompt engineering to accurately interpret complex organizational tasks.

The digital co-worker system 102 may map the extracted information to predefined task templates stored in its knowledge base, which may be continuously updated based on new organizational practices and regulations.

The task handler 506 component of the system may be responsible for this analysis, breaking down the task description into manageable subtasks while understanding dependencies and necessary components of the task.

The analysis may also involve the role understanding 606, which analyzes the role requirements to ensure the identified subtasks align with the specific organizational role described.

The outcome of this analysis is a structured representation of the task and associated subtasks, which may be used by subsequent components of the system to select appropriate AI agents, allocate resources, and execute the required organizational operations.

At block 1106, the at least one processor of the digital co-worker system 102 selects a plurality of AI agents 702 from an agent pool 512 of specialized agents to execute the identified subtasks. This selection process may involve multiple levels of analysis and matching to ensure the most appropriate agents are chosen for each subtask.

In some examples, at a high level, the selection process may involve evaluating the general requirements of each subtask and matching them to broad categories of agent capabilities within the agent pool 512.

In more specific examples, the selection process may utilize a task selector component to identify the required capabilities for each subtask and match them to detailed agent profiles stored in the system. This matching process may consider factors such as the agent's specialization, historical performance, and current availability.

In even more specific examples, the selection process may employ machine learning algorithms to optimize agent selection. These algorithms may analyze the subtask requirements, the agent profiles, and historical performance data to predict which agents are most likely to successfully complete each subtask efficiently.

The digital co-worker system 102 may also consider factors such as workload balancing and potential synergies between agents when making selections.

The agent pool 512 may comprise a diverse set of specialized agents, each designed to handle specific aspects of financial operations. These may include:
Data access agents 514: These agents may be responsible for retrieving data from various sources, including internal databases, ERP systems, and external platforms. They may utilize specialized connectors and APIs to efficiently extract relevant information.
Data processing agents 516: These agents may focus on cleaning and transforming raw data into a format suitable for analysis. They may employ techniques such as data normalization, deduplication, and format standardization.
Application agents 518: These agents may be designed to perform domain-specific tasks within financial operations. For example, they may handle tasks such as invoice processing, account reconciliation, or financial statement preparation.
Analytics agents 520: These agents may specialize in conducting data analysis and generating insights. They may utilize advanced statistical techniques, machine learning models, and visualization tools to provide valuable financial intelligence.

The selection process may also consider the hierarchical structure of the agent system, with a main agent 504 (such as Emma) overseeing and coordinating the activities of sub-task agents 508 assigned to specific subtasks.

This hierarchical approach may allow for more efficient task management and communication between agents.

At block 1108, the at least one processor of the digital co-worker system 102 coordinates interactions between the selected AI agents 702 to execute the subtasks. This coordination process may involve multiple levels of complexity and interaction between the agents.

In some examples, at a high level, the coordination may involve establishing general communication channels between agents assigned to related subtasks. This may include setting up a basic framework for information exchange and task sequencing.

In more specific examples, the coordination process may define a sequence of operations for subtask execution. This may involve creating a task dependency graph, where the output of one agent serves as the input for another. The digital co-worker system 102 may also implement data flow management protocols to ensure efficient and secure transfer of information between agents.

In even more specific examples, the coordination may utilize orchestration techniques. The task executor 324 component may employ algorithms to dynamically adjust the execution strategy based on real-time data and feedback. This may include load balancing across agents, parallel processing of independent subtasks, and adaptive rescheduling in response to changing priorities or resource availability.

The coordination process may also implement a hierarchical structure among the agents. In some examples, this hierarchy may be relatively simple, with a main agent 504 overseeing a small group of specialized sub-task agents 508. In more complex implementations, the hierarchy may involve multiple levels, with intermediate agents managing clusters of sub-task agents 508 and reporting to a top-level coordinating agent.

The main agent 504 may be responsible for high-level decision-making, task allocation, and conflict resolution between sub-agents. This agent may utilize the problem-solving module 708 to analyze complex scenarios and determine the optimal course of action.

The digital co-worker system 102 may also employ communication protocols to facilitate interaction between agents. This may include standardized message formats, encryption for sensitive data, and mechanisms for handling communication failures or delays. The action module 710 of each agent may be responsible for executing the coordinated actions and reporting results back to the main agent 504 or other relevant components of the digital co-worker system 102.

At block 1110, the selected AI agents 702 execute the subtasks. This execution process may involve multiple levels of interaction with various components of the digital co-worker system 102.

In some examples, at a high level, the execution may involve accessing data sources, processing information, and performing operations relevant to organizational tasks. This may include retrieving data from internal databases, ERP systems, and external platforms.

In more specific examples, the execution process may utilize specialized agents for different types of tasks. Data access agents 514 may retrieve information from various sources such as ERP systems (e.g., NetSuite), CRM systems, and Excel spreadsheets. Data processing agents 516 may clean and transform the retrieved data, while application agents 518 may perform domain-specific organizational operations.

In even more specific examples, the execution may involve complex interactions between multiple AI agents. The task executor 324 component may coordinate the activities of various agents, ensuring that subtasks are performed in the correct sequence and that data flows efficiently between agents. Analytics agents may conduct in-depth financial analysis, such as forecasting, anomaly detection, or budget variance analysis.

The execution process may also involve adaptive learning techniques. As agents perform their tasks, they may utilize feedback mechanisms and memory modules to improve their performance over time. This may include fine-tuning of models, few-shot learning for new scenarios, and continuous learning from task outcomes.

The system may also implement security and compliance measures during task execution. This may include enforcing data access controls, maintaining audit logs, and ensuring that all operations comply with relevant financial regulations and company policies.

The digital co-worker system 102 may employ multiple levels of monitoring and adjustment during subtask execution. In some examples, at a high level, the system may track overall progress of subtasks and identify any broad issues in agent interactions or task completion.

In more specific examples, the digital co-worker system 102 may utilize the task executor 324 component to actively monitor the execution of individual subtasks. This may involve tracking metrics such as completion time, resource usage, and output quality for each subtask. The system may also monitor communication channels between agents to detect potential conflicts or bottlenecks.

In even more specific examples, the digital co-worker system 102 may employ advanced machine learning algorithms to analyze the execution patterns in real-time. These algorithms may be designed to detect subtle anomalies or inefficiencies that may not be immediately apparent. The problem-solving module 708 of the AI agents may be utilized to interpret these patterns and propose adjustments.

When issues or conflicts are detected, the digital co-worker system 102 may dynamically adjust its coordination strategies. This may involve:
1. Reallocating resources between agents to balance workload
2. Modifying the sequence of operations to resolve dependencies
3. Adjusting communication protocols between agents to improve information flow
4. Temporarily suspending or reprioritizing certain subtasks to address issues

The main agent 504 may oversee this adjustment process, ensuring that changes are coordinated across the entire system. The digital co-worker system 102 may also leverage its continuous learning capabilities to refine its monitoring and adjustment strategies over time, improving its ability to preemptively identify and resolve potential issues in future task executions.

At block 1112, the at least one processor of the digital co-worker system 102 aggregates results from the executed subtasks. This aggregation process may involve multiple levels of integration of outputs from various AI agents 702.

In some examples, at a high level, the aggregation may involve collecting outputs from each AI agent 702 involved in subtask execution. This may include gathering data, analysis results, and task completion statuses output from the various specialized agents.

In more specific examples, the aggregation process may use algorithms to reconcile conflicting or inconsistent results produced by different agents. This reconciliation process may involve cross-referencing outputs, identifying discrepancies, and applying predefined rules or heuristics to resolve conflicts.

In even more specific examples, the aggregation may employ advanced machine learning techniques to synthesize a coherent response from the diverse outputs of the AI agents. This synthesis may involve natural language processing to generate human-readable summaries, data visualization techniques to present complex financial information, and contextual analysis to ensure the aggregated results align with the original user task description.

The task aggregator 608 component of the system may be responsible for this aggregation process, working in conjunction with the task handler 506 to ensure all subtask results are properly integrated.

The system may also leverage the memory module 704 of the AI agents to provide context and historical information that aids in the aggregation and synthesis of results.

The aggregation process may also involve quality checks and validation steps to ensure the accuracy and completeness of the synthesized response. This may include cross-referencing aggregated results with source data, applying organizational rules and regulations, and flagging any anomalies or areas requiring human review.

At block 1114, the at least one processor of the digital co-worker system 102 generates a response to the user task description based on the aggregated results. This response generation process may involve multiple levels of complexity and customization.

In some examples, at a high level, the response generation may involve compiling the aggregated results into a coherent format that addresses the original user task description. This may include summarizing key findings, highlighting important data points, and providing an overview of completed subtasks.

In more specific examples, the response generation process may utilize natural language processing techniques to create human-readable reports. The digital co-worker system 102 may employ templates tailored to different types of organizational tasks, populating them with relevant data and insights derived from the aggregated results. The response may be structured to align with standard organizational reporting formats or customized based on user preferences.

In even more specific examples, the response generation may leverage machine learning models to create highly personalized and context-aware responses. These models may consider factors such as the user's role, historical preferences, and the specific requirements outlined in the original task description. The system may utilize techniques like few-shot learning or prompt engineering to fine-tune the response generation process for each user and task type.

The generated response may be presented to the user through various components of the user interface layer 202. This may include:
Interactive dashboards: The digital co-worker system 102 may create customizable dashboards that display key performance indicators (KPIs), financial metrics, and visualizations of complex data relationships.
Detailed reports: For more comprehensive tasks, the digital co-worker system 102 may generate in-depth reports with executive summaries, detailed analyses, and supporting data.
Chat interface: The response may be delivered through a conversational interface, allowing users to ask follow-up questions or request clarifications on specific points.
Alerts and notifications: For time-sensitive or critical findings, the digital co-worker system 102 may generate alerts that are prominently displayed or pushed to relevant team members.

The response generation process may also incorporate explainable AI techniques to provide transparency in how conclusions were reached or recommendations formulated. This may include providing data lineage, confidence scores for predictions, and explanations of the reasoning behind specific insights or suggestions.

Additionally, the digital co-worker system 102 may store the generated response and associated metadata in the memory module 704 for future reference and continuous improvement of the response generation process.

The method 1100 may also include additional operations not explicitly shown in the flowchart, such as storing information about the task execution process in a memory module 704, analyzing the stored information to identify patterns or areas for improvement in agent coordination, and updating coordination strategies based on the analysis.

The digital co-worker system 102 may also receive feedback on the generated response, process the feedback to identify areas for improvement, and adjust agent selection or coordination strategies based on the processed feedback.

In some examples, the digital co-worker system 102 may be configured to handle organizational operations, and the user task description may relate to an organizational task such as data monitoring tasks (including KPI monitoring, cash flow monitoring, or anomaly detection), accounting tasks (including reconciliation, financial statement preparation, or journal entry checks), or analytics tasks (including budgeting, forecasting, or variance analysis).

The digital co-worker system 102 may also generate a visual representation of the agent coordination process, display it via a user interface, and enable user interaction with the visual representation to monitor or adjust the coordination process.

Additionally, the digital co-worker system 102 may be integrated with external tools and platforms, enabling the selected AI agents to access and utilize the functionalities of these external tools in executing their assigned subtasks.

To ensure secure operation, the digital co-worker system 102 may implement security protocols to ensure secure communication and data exchange between the selected AI agents, verifying the authenticity and authorization of each agent before allowing access to sensitive information or critical operations.

In some implementations, the digital co-worker system 102 may be deployed as part of a cloud-based service, managing resource allocation for the selected AI agents across distributed computing resources to optimize performance and efficiency of task execution.

### Method 1200

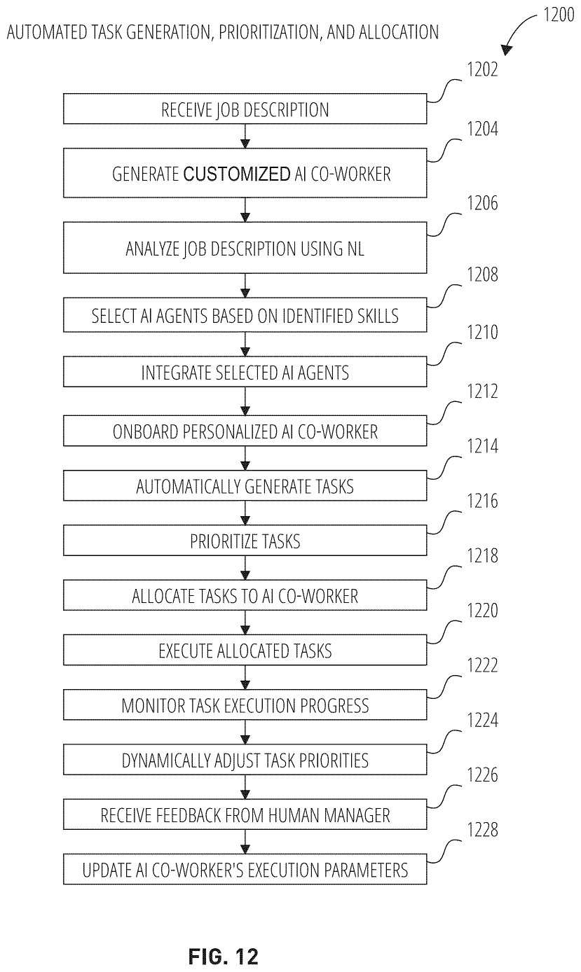

FIG. 12 is a flowchart illustrating a method 1200 for automated task management in a digital co-worker system, according to some examples, of generating and utilizing a customized AI co-worker for organizational operations.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1202, the method 1200 receives a job description/role description defining role requirements for an AI co-worker. This operation may be performed by at least one processor of the digital co-worker system.

In some examples, at a high level, the system may receive input data containing information about a desired role for an AI assistant. The input data may be processed to extract relevant details for configuring a virtual agent.

In more specific examples, the user interface layer 202 may capture detailed information, in the form of the job description data 204, about the role and responsibilities required for the finance team. This may involve presenting a structured form or interactive interface for users to input job requirements, skills, and other relevant details. The digital co-worker system 102 may utilize natural language processing techniques to analyze the provided job description.

In even more specific examples, the digital co-worker system 102 may employ the following techniques to process the job description/role description:
Named entity recognition to identify and extract specific organizational terms, tools, and processes mentioned
Semantic analysis to understand the context and importance of different role requirements
Classification algorithms to categorize the role (e.g., Accounts Payable, Accounts Receivable, Controller)
Skill mapping to match identified requirements with pre-defined AI agent capabilities

The digital co-worker system 102 may also allow users to specify additional parameters such as:
Desired personality traits for the AI co-worker (e.g., proactive, detail-oriented)
Preferred communication style (e.g., formal, concise)
Specific company policies or procedures to be followed
Required proficiencies in organizational software or systems (e.g., SAP, Oracle Financials)

Some examples may include options for users to upload supplementary documents like company handbooks, organizational process guides, or past job performance reports to provide additional context for the role. The system may use optical character recognition (OCR) and document parsing techniques to extract relevant information from these uploaded materials.

At block 1204, the method generates a customized AI co-worker based on the job description/role description. This operation may be performed by at least one processor of the digital co-worker system.

In some examples, at a high level, the system may analyze input data to create a specialized virtual agent. The process may involve interpreting job requirements and assembling AI components to match the specified role.

In more specific examples, the role-based AI co-worker generator 304 may analyze the job description using natural language processing techniques to identify required skills and responsibilities. It may then select a combination of AI agents corresponding to the identified skills and responsibilities from a pool of specialized agents, and integrate the selected AI agents to create the customized AI co-worker.

In even more specific examples, the system may employ the following techniques:
Named entity recognition to extract specific organizational terms, tools, and processes mentioned in the job description
Mapping of extracted information to predefined role templates, such as Accounts Payable Role or Controller Role
Customization of templates based on specific requirements outlined in the job description
Integration of role-specific capabilities, such as invoice processing for an Accounts Payable Role or financial analysis for an FP&A Role
Fine-tuning of large language models with domain-specific organizational data and task-oriented training
Incorporation of a knowledge base containing financial regulations, accounting standards, and industry best practices relevant to the role

The system may also include a capability assessment module that evaluates the AI co-worker's proficiency in various skills and identifies areas for improvement. This information can be used to continuously refine and enhance the AI co-worker's capabilities through ongoing training and learning processes.

At block 1206, the digital co-worker system 102 analyzes the job description data 204 using natural language processing techniques. This operation may be performed by at least one processor of the digital co-worker system 102.

In some examples, at a high level, the digital co-worker system 102 may process textual input to extract relevant information. This may involve applying computational algorithms to understand and interpret human language data.

In more specific examples, the digital co-worker system 102 may utilize natural language processing (NLP) techniques to parse the text and extract key information such as required skills, responsibilities, and qualifications. This process may involve tokenization, part-of-speech tagging, and semantic analysis to understand the context and importance of different elements within the job description.

In even more specific examples, the digital co-worker system 102 may employ the following NLP techniques:
Named Entity Recognition (NER) to identify and classify entities such as job titles, skills, tools, and industry-specific terms
Dependency parsing to understand the relationships between different parts of the job description
Sentiment analysis to gauge the importance or priority of different requirements
Topic modeling to categorize different aspects of the job role
Word embedding techniques to capture semantic relationships between terms used in the job description

The digital co-worker system 102 may also utilize domain-specific ontologies or knowledge graphs to enhance its understanding of financial terminology and concepts mentioned in the job description.

At block 1208, the digital co-worker system 102 selects AI agents based on identified skills. This operation may be performed by at least one processor of the digital co-worker system.

In some examples, at a high level, the digital co-worker system 102 may match extracted job requirements with available AI components. This process may involve selecting appropriate modules to fulfill the specified role requirements.

In more specific examples, the role creation layer 210 may utilize the user input and job description data 204 to generate specialized AI co-workers for specific operational roles, such as Accounts Payable Role, Accounts Receivable Role, or Controller Role. The digital co-worker system 102 may map the identified skills and responsibilities to an agent pool 512 of pre-defined AI agents, each designed to perform specific organizational tasks or possess certain domain knowledge.

In even more specific examples, the digital co-worker system 102 may employ the following techniques:
Skill-to-agent mapping algorithms that match identified skills with corresponding AI agents
Rule-based systems to ensure compliance with role-specific requirements and industry standards
Machine learning models trained on historical data to predict the most effective combination of agents for a given role
Dynamic agent assembly techniques that allow for real-time composition of AI co-workers based on evolving job requirements
Hierarchical agent structures that organize selected agents into functional groups aligned with the role's responsibilities

The digital co-worker system 102 may also incorporate feedback loops and performance metrics to continuously evaluate and optimize the selection of AI agents for each role, ensuring that the generated AI co-worker remains aligned with the evolving needs of the organizational team.

At block 1210, the selected AI agents 702 are integrated to create the customized AI co-worker 800. This operation may be performed by at least one processor of the digital co-worker system.

In some examples, at a high level, the digital co-worker system 102 may combine multiple AI components to form a unified virtual assistant. This process may involve assembling various modules to create a cohesive AI entity tailored to the specified role.

In more specific examples, the role-based AI co-worker generator 304 may integrate the selected AI agents corresponding to the identified skills and responsibilities. This integration process may involve establishing communication protocols between agents, defining hierarchies, and ensuring seamless data flow between different components.

In even more specific examples, the digital co-worker system 102 may employ the following techniques:
Agent orchestration algorithms to manage the interactions and dependencies between different AI agents
Semantic integration to ensure consistent understanding and interpretation of data across agents
Knowledge graph construction to represent the relationships between different skills and tasks
Fine-tuning of large language models with domain-specific organizational data and task-oriented training
Implementation of a unified interface layer that allows seamless interaction between the integrated agents and external systems
Development of conflict resolution mechanisms to handle potential contradictions or overlaps in agent functionalities

The digital co-worker system 102 may also incorporate adaptive learning mechanisms that allow the integrated AI co-worker to continuously refine its performance based on interactions and feedback.

At block 1212, the digital co-worker system 102 performs an onboarding process for the customized AI co-worker 800. This operation may be performed by at least one processor of the digital co-worker system.

In some examples, at a high level, the digital co-worker system 102 may initialize the AI co-worker 800 with company-specific information and data. This process may involve providing access to relevant resources to enhance the AI co-worker's understanding of the organizational context.

In more specific examples, the co-worker onboarding module 306 may facilitate the AI co-worker's integration into the company's systems and processes. It may access company documents 308, data sources 310, and team information 312 to provide company-specific training. This module may employ Retrieval Augmented Generation (RAG) techniques to assimilate company-specific information, enabling the AI co-worker 800 to make informed decisions and execute tasks within the company's context.

In even more specific examples, the onboarding process may involve:
Ingesting and processing company documents, including financial reports, policy manuals, and standard operating procedures
Establishing secure connections to relevant data sources, such as ERP (Enterprise Resource Planning) systems 218, CRM (Customer Relationship Management) system 220, and internal databases
Analyzing organizational structure and team dynamics to understand reporting lines and collaboration patterns
Creating a company-specific knowledge base that the AI co-worker can reference for context-aware decision making
Fine-tuning natural language understanding models to recognize company-specific terminology and jargon
Configuring role-based access controls to ensure the AI co-worker adheres to data privacy and security policies
Simulating common scenarios and workflows to validate the AI co-worker's understanding and performance The onboarding process may also include a feedback loop where human supervisors can review and correct the AI co-worker's initial outputs, allowing for iterative refinement of its knowledge and capabilities.

At block 1214, the digital co-worker system 102 automatically generates tasks based on the role requirements and company context. Generally, the company context describes the characteristics of a company or organization. In some examples, the company context refers to the specific organizational environment, practices, data, and operational parameters unique to a particular company. This includes, but is not limited to, the company's internal processes, rules, historical data, team structures, regulatory requirements, tools and systems, and any other information that characterizes how the company operates. The company context may be used to tailor its behavior, task generation, prioritization, and decision-making to align with the unique needs and practices of the organization. By integrating and learning from company-specific data sources and documents, the AI coworker adapts the tasks to fit the operational realities and requirements of the company, ensuring that its outputs and actions are relevant, accurate, and compliant with internal standards and external regulations.

This operation may be performed by at least one processor of the digital co-worker system.

In some examples, at a high level, the digital co-worker system 102 may create a list of activities to be performed based on predefined role specifications and organizational parameters. This process may involve analyzing job functions and company-specific needs to determine necessary tasks.

In more specific examples, the task generator 314 may create both periodic tasks 316 and ad-hoc tasks 318 based on the AI co-worker's role understanding. The digital co-worker system 102 may utilize natural language processing and machine learning techniques to interpret role requirements and company context, generating tasks that align with the specific needs of the finance team.

In even more specific examples, the task generation process may involve:
Analyzing historical task data to identify recurring tasks and their frequencies
Utilizing rule-based systems to generate tasks based on regulatory requirements and company policies
Implementing machine learning algorithms to predict upcoming tasks based on patterns in company operations
Integrating with company calendars and project management tools to identify time-sensitive tasks
Employing natural language processing to extract task requirements from team communications and documents

The digital co-worker system 102 may also adapt its task generation based on feedback and performance metrics, continuously refining its understanding of role requirements and company needs.

At block 1216, the digital co-worker system 102 prioritizes tasks. This operation may be performed by at least one processor of the digital co-worker system.

In some examples, at a high level, the digital co-worker system 102 may arrange tasks in order of importance or urgency. This process may involve evaluating various factors to determine the relative priority of each task.

In more specific examples, the task prioritization module 320 may organize tasks based on various factors, including manager input, time sensitivity, and task importance. The digital co-worker system 102 may employ algorithms that consider multiple criteria to assign priority levels to each task, ensuring that the most critical tasks are addressed first.

In even more specific examples, the task prioritization process may involve:
Implementing machine learning models trained on historical task completion data to predict task urgency
Utilizing natural language processing to interpret manager instructions and preferences for task prioritization
Applying time-based algorithms to factor in deadlines and time-sensitive operations
Incorporating dependency analysis to ensure prerequisite tasks are prioritized appropriately
Employing dynamic reprioritization based on real-time changes in company operations or financial markets

The digital co-worker system 102 may also use feedback loops to continuously refine its prioritization algorithms, learning from past prioritization decisions and their outcomes.

At block 1218, the digital co-worker system 102 allocates tasks to the AI co-worker. This operation may be performed by at least one processor of the digital co-worker system.

In some examples, at a high level, the digital co-worker system 102 may assign specific activities to the virtual assistant for execution. This process may involve matching tasks with the AI co-worker's capabilities and availability.

In more specific examples, the task scheduler 322 may assign specific times for task execution, considering task priority and manager preferences. The digital co-worker system 102 may utilize scheduling algorithms that optimize task allocation based on various constraints and efficiency metrics to increase efficiency of the co-worker system 102 thereby requiring less computational overhead.

In even more specific examples, the task allocation process may involve:
Implementing resource allocation algorithms to balance workload across multiple AI co-workers or team members
Utilizing machine learning models to predict task completion times and optimize scheduling
Applying constraint satisfaction algorithms to handle complex scheduling requirements and dependencies
Incorporating adaptive scheduling techniques that adjust task allocation based on real-time performance data thereby improving the efficiency of the co-worker system 102
Employing natural language processing to interpret and incorporate manager preferences into the scheduling process

The digital co-worker system 102 may also include mechanisms for handling conflicts in task allocation, such as overlapping priorities or resource constraints, and may provide options for manual override or adjustment by human managers.

At block 1220, the digital co-worker system 102 executes the allocated tasks using the AI co-worker 800. This operation may be performed by at least one processor of the digital co-worker system.

In some examples, at a high level, the digital co-worker system 102 may perform the assigned activities using the virtual assistant. This process may involve utilizing the AI co-worker's capabilities to complete the scheduled tasks.

In more specific examples, the task executor 324 may carry out the scheduled tasks using predefined procedures and the skills integrated during the role-based AI co-worker generation. The digital co-worker system 102 may employ various AI techniques, including natural language processing, machine learning, and data analytics, to perform diverse organizational tasks efficiently and accurately.

In even more specific examples, the task execution process may involve:
Implementing task-specific algorithms and workflows based on the AI co-worker's role and the nature of the task
Utilizing natural language processing to interpret and execute tasks that involve textual data or communication
Employing machine learning models to analyze financial data, detect patterns, and generate insights
Accessing and processing data from various sources, including databases, spreadsheets, and external systems
Generating reports, visualizations, or other outputs as required by the task specifications
Applying role-specific knowledge and company policies to ensure task execution aligns with organizational standards

The digital co-worker system 102 may also include error-handling mechanisms and logging capabilities to track task execution progress and outcomes.

At block 1222, the digital co-worker system 102 monitors task execution progress.

This operation may be performed by at least one processor of the digital co-worker system.

In some examples, at a high level, the digital co-worker system 102 may track the status of ongoing activities. This process may involve observing and recording the progress of tasks being executed by the AI co-worker.

In more specific examples, the digital co-worker system 102 may track the completion status of tasks and identify any issues or delays. This monitoring process may involve real-time data collection and analysis to ensure tasks are progressing as expected and to detect any potential problems early.

In even more specific examples, the task monitoring process may involve:
Implementing real-time tracking mechanisms that capture task status updates at predefined intervals
Utilizing machine learning algorithms to predict task completion times and identify potential bottlenecks
Employing anomaly detection techniques to flag unusual patterns or deviations from expected task execution
Generating progress reports and dashboards for human managers to review task execution status
Implementing alert systems to notify relevant stakeholders of critical issues or delays
Collecting and analyzing performance metrics to assess the efficiency and effectiveness of task execution

The digital co-worker system 102 may also include mechanisms for handling exceptions and escalating issues that require human intervention.

At block 1224, the digital co-worker system 102 dynamically adjusts task priorities based on the monitored progress. In some examples, task execution progress of the tasks is monitored and a workload balance between AI agents is also determined. The digital co-worker system 102 may dynamically adjust task priorities and allocation of the reprioritized tasks to the AI agents based on the monitored progress and workload balance.

By distributing tasks evenly among available AI agents, the co-worker system 102 avoids overloading any single agent, which reduces the risk of delays and ensures that high-priority tasks are addressed promptly. Efficient workload distribution enables the co-worker system 102 to process more tasks in parallel, increasing overall throughput and responsiveness. The ability to dynamically balance workloads allows the co-worker system 102 to scale effectively as the number of tasks or agents increases, maintaining performance even in large or complex organizational environments. By optimizing task allocation, the co-worker system 102 minimizes unnecessary resource consumption, leading to more efficient use of processors and memory modules. The co-worker system 102 can respond to changing operational conditions by reallocating tasks in real time, ensuring that resources are used optimally and that service levels are maintained. This operation may be performed by at least one processor of the digital co-worker system.

In some examples, at a high level, the digital co-worker system 102 may modify the order of activities based on their current status. This process may involve reassessing and updating task priorities to ensure optimal workflow management.

In more specific examples, the digital co-worker system 102 may employ an adaptive approach to ensure that the most critical tasks are addressed promptly. This dynamic prioritization may consider factors such as task progress, deadlines, dependencies, and changing business conditions.

In even more specific examples, the dynamic task prioritization process may involve:
Implementing machine learning algorithms that analyze task progress data and adjust priorities based on predefined criteria
Utilizing natural language processing to interpret and incorporate real-time feedback from human managers into the prioritization process
Employing predictive analytics to anticipate potential delays or issues and proactively adjust task priorities
Implementing a scoring system that considers multiple factors (e.g., deadline proximity, task importance, resource availability) to calculate and update task priorities. In some examples, the AI co-worker generates a priority score for each of the tasks based on criteria including at least one of deadline, impact on business operations, and manager input. The AI co-worker prioritizes the tasks based on the priority score for each of the tasks.
Applying reinforcement learning techniques to improve prioritization decisions over time based on outcomes and feedback
Implementing conflict resolution mechanisms to handle cases where multiple high-priority tasks compete for resources

The digital co-worker system 102 may also include mechanisms for manual override, allowing human managers to intervene and adjust priorities when necessary.

At block 1226, the digital co-worker system 102 receives feedback from a human manager. This operation may be performed by at least one processor of the digital co-worker system.

In some examples, at a high level, the digital co-worker system 102 may collect input from a supervisory user regarding task outcomes. This process may involve gathering qualitative and quantitative assessments of the AI co-worker's performance.

In more specific examples, the feedback mechanism 706 and manager communication module 326 may alert a manager upon task completion and provide detailed reports on task outcomes. The digital co-worker system 102 may utilize natural language processing techniques to interpret and categorize the feedback received from the manager.

In even more specific examples, the feedback collection process may involve:
Implementing a structured feedback form with predefined categories for task quality, timeliness, and accuracy
Utilizing sentiment analysis to gauge the overall satisfaction of the manager with the task execution
Employing natural language processing to extract specific improvement areas from free-form text feedback
Implementing a rating system that allows managers to quantitatively assess different aspects of task performance
Providing options for managers to annotate specific parts of the task output for more targeted feedback
Generating automated summaries of feedback trends over time to identify recurring issues or improvements

The system architecture 200 may also include mechanisms for real-time feedback during task execution, allowing managers to provide guidance or corrections as tasks are being performed.

At block 1228, the digital co-worker system 102 updates the AI co-worker's execution parameters based on the received feedback. This operation may be performed by at least one processor of the digital co-worker system.

In some examples, at a high level, the digital co-worker system 102 may modify its operational settings based on user input. This process may involve adjusting various aspects of the AI co-worker's functionality to improve future performance.

In more specific examples, the digital co-worker system 102 may update the AI co-worker's execution parameters based on the received feedback. This process enables continuous improvement and adaptation of the AI co-worker's performance. The digital co-worker system 102 may employ machine learning techniques to analyze feedback patterns and make appropriate adjustments to the AI co-worker's decision-making processes and task execution strategies.

In even more specific examples, the parameter update process may involve:
Implementing reinforcement learning algorithms that adjust task execution strategies based on positive and negative feedback
Utilizing transfer learning techniques to apply insights gained from feedback on one task to improve performance on similar tasks
Employing meta-learning approaches to optimize the AI co-worker's learning process itself, improving its ability to adapt to new feedback
Implementing a version control system for AI co-worker models, allowing for rollback if updates lead to decreased performance
Developing personalized learning rates for different aspects of the AI co-worker's functionality, allowing for faster adaptation in areas that receive more consistent feedback
Creating a feedback-driven knowledge base that the AI co-worker can reference when making decisions in future tasks

The system 102 may also include mechanisms for balancing recent feedback with long-term performance trends, ensuring that the AI co-worker's behavior remains stable while still being responsive to new input.

Throughout this process, the system may employ various AI techniques, including natural language processing, machine learning, and data analytics, to perform diverse organizational tasks efficiently and accurately.

### Method 1300

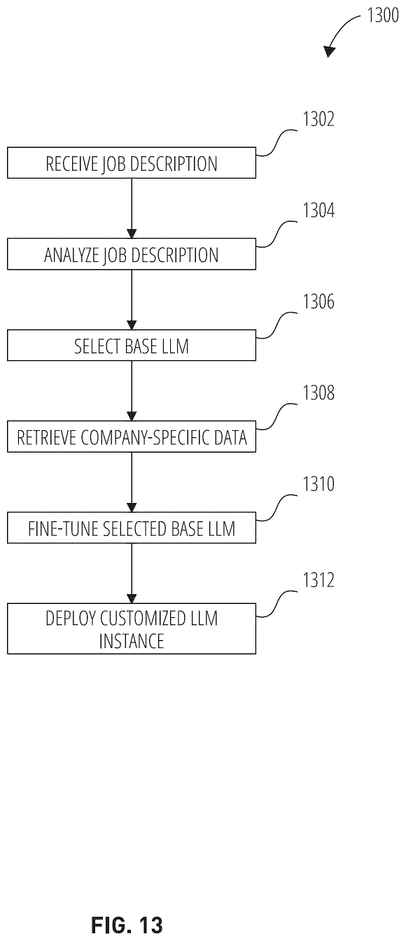

FIG. 13 is a flowchart illustrating a method 1300 for generating customized large language model (LLM) instances, according to some examples, of creating role-specific and company-tailored AI coworkers for organizational operations.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1302, the digital co-worker system 102 receives job description data 204 (role description data) specifying requirements for a role within a company. The job description may include details such as required skills, responsibilities, and qualifications for the role.

At block 1304, the digital co-worker system 102 analyzes the job description data 204 to identify required skills and responsibilities for the role. This analysis may involve natural language processing techniques to extract key information from the job description.

At block 1306, the digital co-worker system 102 selects a base LLM from a plurality of LLMs based on the identified required skills and responsibilities. The selection process may involve multiple levels of analysis and decision-making.

In some examples, at a high level, the digital co-worker system 102 may evaluate a set of language models to determine which one is most suitable for the specified role. This evaluation may involve comparing the general capabilities of each model against the broad requirements of the job description.

In more specific examples, the digital co-worker system 102 may implement a mapping algorithm that correlates the identified skills and responsibilities to predefined role templates. These templates may contain information about the typical tasks, knowledge areas, and competencies associated with various organizational roles. The processor may then calculate a similarity score between the job description and each template, selecting the LLM associated with the template that has the highest match.

In even more specific examples, the selection process may utilize a multi-stage filtering approach. Some examples may include:
Initial screening: The processor may first eliminate LLMs that do not meet minimum requirements for the role, such as those lacking specific organizational domain knowledge.
Capability assessment: The remaining LLMs may be evaluated based on their performance on benchmark tasks relevant to the identified skills. This may involve running test queries or simulations to assess each model's proficiency in areas like organizational analysis, report generation, or regulatory compliance.
Specialization matching: The processor may analyze the fine-grained specializations within the job description, such as expertise in specific accounting standards or financial instruments. It may then select an LLM that has been pre-trained or fine-tuned on datasets relevant to these specializations.
Adaptability scoring: The processor may assess each LLM's potential for further customization based on factors such as its architecture, training methodology, and historical performance in transfer learning scenarios.
Resource optimization: The selection algorithm may also consider computational requirements and efficiency, choosing an LLM that balances performance with the available system resources.

The final selection may be made using a weighted scoring system that combines these various factors, ensuring that the chosen base LLM provides the best starting point for creating a customized instance tailored to the specific role and company requirements.

At block 1308, the digital co-worker system 102 retrieves company-specific data including organizational practices and historical data of the company. This data retrieval process may involve multiple levels of data access and integration.

In some examples, at a high level, the digital co-worker system 102 may access various internal data repositories to gather relevant company information. This may include querying different data storage systems to collect organizational records, operational data, and historical transaction information.

In more specific examples, the processor may implement a multi-source data integration approach. This may involve:
Connecting to enterprise resource planning (ERP) systems like NetSuite to extract financial data, including general ledger entries, accounts payable and receivable information, and financial statements.
Accessing customer relationship management (CRM) systems to retrieve customer-related financial data and transaction histories.
Interfacing with document management systems to obtain relevant financial documents, policies, and procedural guidelines.
Retrieving data from email systems to gather financial communications and approvals.
Collecting data from Excel spreadsheets and other file-based sources that may contain financial analyses or reports.

In even more specific examples, the data retrieval process may utilize specialized data connectors and APIs to efficiently extract and consolidate information:
The digital co-worker system 102 may employ ETL (Extract, Transform, Load) processes to standardize data formats across different sources.
It may implement data lake technologies to store raw, unstructured data from various sources before processing.
The digital co-worker system 102 may use specialized financial data APIs to access real-time market data or industry benchmarks relevant to the company's operations.
For historical data, the digital co-worker system 102 may access data warehouses or archived databases to retrieve past financial records and performance metrics.
The digital co-worker system 102 may utilize OCR (Optical Character Recognition) technology to extract financial data from scanned documents or image files.

Throughout this process, the digital co-worker system 102 may apply data governance rules to ensure compliance with access controls, data privacy regulations, and company policies regarding sensitive financial information.

This may involve implementing encryption, masking sensitive data, and maintaining audit logs of data access and retrieval operations.

At block 1310, the digital co-worker system 102 fine-tunes the selected base LLM using the company-specific data to generate a customized LLM instance for the role and company. That is, the company-specific data and role requirements are input into the selected base LLM to tune the base LLM thereby generating the customized LLM instance that understands the role requirements for the company and the company-specific data of the company. Tuning the base LLM with company-specific data and role requirements provides significant technical benefits that directly improve the performance, relevance, and accuracy of the adaptive AI coworker system. From a technical perspective, a generic LLM is trained on broad datasets and possesses general language understanding and reasoning capabilities. However, such models may lack the contextual awareness, domain expertise, and operational nuance required for effective decision-making and task execution within a particular organization or role. By fine-tuning the base LLM with company-specific data—including internal documents, historical records, operational practices, and regulatory requirements—the system adapts the model's parameters to reflect the unique language, workflows, and priorities of the organization. This targeted adaptation yields several concrete technical advantages:
Enhanced Contextual Understanding: The tuned LLM can interpret company-specific terminology, acronyms, and jargon, reducing miscommunication and improving the accuracy of responses and task generation.
Role-Specific Expertise: By incorporating role requirements, the LLM develops specialized knowledge relevant to particular job functions (e.g., finance, HR, IT), enabling it to execute tasks and provide recommendations that align with the expectations and standards of each role.
Improved Decision Support: The model can leverage historical company data and operational patterns to deliver insights, forecasts, and anomaly detection that are tailored to the organization's actual business environment, rather than relying on generic assumptions.
Compliance and Governance: Fine-tuning with company policies and regulatory frameworks ensures that the LLM's outputs adhere to internal standards and external legal requirements, reducing risk and supporting auditability.
Adaptive Learning: The system can continuously refine the LLM as new data and feedback are received, allowing it to evolve with the organization and maintain high performance in dynamic business conditions.

Tuning the base LLM with company-specific data and role requirements transforms a general-purpose AI into a specialized, context-aware system that delivers more relevant, accurate, and actionable outputs. This technical improvement enhances the system's ability to autonomously manage complex workflows, support decision-making, and optimize enterprise operations in a way that cannot be achieved with untuned, generic models.

This fine-tuning process may involve multiple levels of adaptation and customization. In some examples, at a high level, the digital co-worker system 102 may apply transfer learning techniques to adapt the base LLM to the company-specific data. This process may involve adjusting the model's parameters to align with the company's unique organizational practices and terminology.

In more specific examples, the fine-tuning process may include:
Implementing a retrieval-augmented generation (RAG) approach to enhance the LLM's ability to access and utilize company-specific information.
Applying few-shot learning techniques to rapidly adapt the model to company-specific tasks using a limited number of examples.
Utilizing machine learning algorithms to develop models that can predict, classify, and analyze organizational outcomes based on historical company data.

In even more specific examples, the fine-tuning process may involve:

Adapting the LLM to recognize and interpret company-specific financial patterns and anomalies, enabling it to provide insights and recommendations based on historical financial data and current trends.
Customizing the model's natural language understanding capabilities to recognize company-specific terminology, acronyms, and jargon relevant to the role.
Implementing continuous learning mechanisms that allow the LLM to refine its processes based on new data and feedback, ensuring that its analyses remain accurate as business conditions change.
Fine-tuning the model on specific organizational datasets to adapt to the nuances of the organizational sector and the company's specific data.
Utilizing prompt engineering techniques to guide the language model in generating contextually relevant responses for company-specific queries and tasks.

Throughout this process, the digital co-worker system 102 may employ various AI techniques, including transfer learning, reinforcement learning, and adaptive algorithms, to optimize the LLM's performance for the specific role and company context.

At block 1312, the digital co-worker system 102 deploys the customized LLM instance to perform tasks associated with the role. This deployment process may involve multiple levels of configuration and integration.

In some examples, at a high level, the digital co-worker system 102 may initialize the customized LLM instance within the operational environment, establishing connections to necessary data sources and systems. This may include setting up communication channels with user interfaces and backend services.

In more specific examples, the deployment process may involve:
Configuring the LLM instance to interact with users through a natural language interface, such as a chat interface or conversational AI system.
Integrating the LLM instance with company-specific data sources, including ERP systems, CRM platforms, and internal databases to enable real-time data access and processing.
Setting up role-specific dashboards and reporting tools that allow the LLM instance to present information in a format tailored to the user's role and preferences.
Implementing security measures and access controls to ensure the LLM instance operates within the company's data governance framework.

In even more specific examples, the deployment may include:
Fine-tuning the natural language understanding capabilities to recognize company-specific terminology, acronyms, and jargon relevant to the role.
Configuring task execution pipelines that enable the LLM instance to perform role-specific tasks such as data analysis, report generation, and organizational calculations.
Setting up feedback loops and learning mechanisms that allow the LLM instance to continuously improve its performance based on user interactions and task outcomes.
Implementing explainable AI features that provide transparency into the LLM's decision-making process, particularly for organizational tasks that require auditability.
Establishing connections with specialized agents or modules within the system, such as data processing agents, analytics agents, and task automation tools, to enhance the LLM's capabilities in performing complex role-specific activities.

Throughout the deployment process, the digital co-worker system 102 may perform iterative testing and validation to ensure the customized LLM instance meets the specific requirements of the role and integrates seamlessly with existing workflows and systems.

In some examples, the method 1300 may include implementing a feedback loop to continuously improve the customized LLM instance based on user interactions and task performance. This feedback loop may involve:
Storing feedback in a memory module, which may utilize techniques such as vector databases or knowledge graphs to efficiently store and retrieve relevant information.
Processing both positive and negative feedback using machine learning algorithms to analyze feedback patterns and adjust the LLM instance's behavior accordingly.
Implementing a continuous learning mechanism that allows the LLM instance to refine its processes based on new data and feedback, ensuring that its analyses remain accurate as business conditions change.
Utilizing reinforcement learning or other adaptive techniques to optimize the LLM instance's performance over time.

The method may also implement security measures to protect sensitive organizational data accessed by the customized LLM instance. These measures may include:
Implementing robust security protocols such as encryption, secure data access protocols, and multi-factor authentication to protect sensitive organizational information.
Applying data governance rules to ensure compliance with access controls, data privacy regulations, and company policies regarding sensitive organizational information.
Maintaining audit logs of data access and retrieval operations to track and monitor system usage.
Implementing role-based access controls to ensure that the LLM instance only accesses data relevant to its assigned role and permissions.
Conducting regular compliance checks to ensure adherence to regulatory requirements and industry standards for organizational data handling.

These security measures are designed to safeguard the integrity and confidentiality of organizational data while allowing the LLM instance to perform its designated tasks effectively.

The method may further involve generating a knowledge base of organizational regulations and industry best practices relevant to the role and incorporating this knowledge base into the customized LLM instance. This ensures that the AI coworker operates within appropriate regulatory frameworks.

The method 1300 may include generating multiple specialized agents within the customized LLM instance, each responsible for specific tasks related to the role. This multi-agent approach may involve:
Creating task-specific agents such as data monitoring agents, accounting agents, and analytics agents within the customized LLM instance.
Implementing specialized agents for functions like OCR, data cleaning, entity extraction, document classification, and data aggregation to handle various aspects of organizational data processing.
Developing role-specific agents such as Accounts Payable, Accounts Receivable, Accountant, FP&A, Controller, and CFO agents to handle tasks associated with each organizational role.

An orchestration mechanism may be implemented to coordinate interactions between these specialized agents, enabling them to:
Break down complex organizational tasks into subtasks and delegate them to appropriate specialized agents.
Facilitate communication and data sharing between agents to complete role-specific activities efficiently.
Manage task prioritization and scheduling across multiple agents to optimize workflow and resource allocation.

The customized LLM instance may be adapted to recognize and interpret company-specific organizational patterns and anomalies by:
Analyzing historical financial data and current trends to identify patterns and deviations.
Utilizing machine learning algorithms to develop predictive models for financial outcomes based on company-specific data.
Implementing anomaly detection techniques to identify unusual patterns that may indicate errors or fraud in financial transactions.
Adapting to company-specific financial practices and terminology through continuous learning and feedback mechanisms.

These capabilities enable the LLM instance to provide insights and recommendations based on a comprehensive understanding of the company's financial landscape and historical performance.

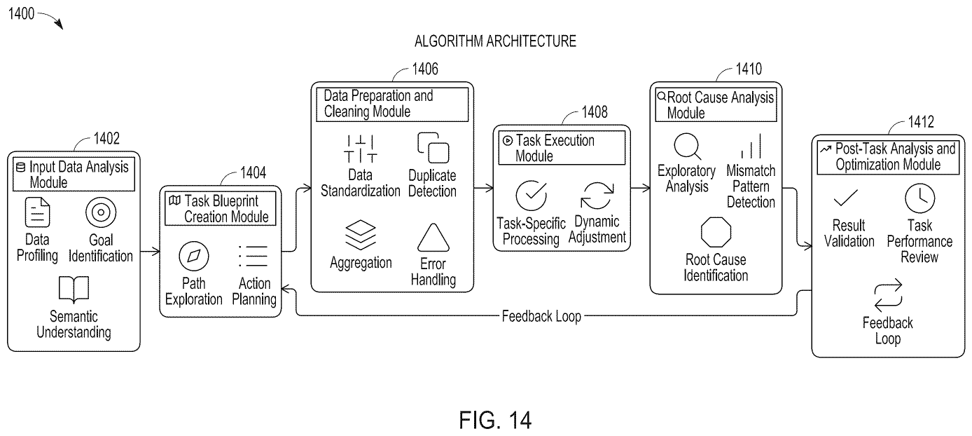

FIG. 14 is a block diagram illustrating an algorithm architecture 1400 for executing tasks in an AI coworker system, according to some examples.

An algorithm architecture 1400 comprises six interconnected modules that work together to process and execute tasks efficiently. The input data analysis module 1402 analyzes input data to understand its structure, type, and the goal to be achieved. This input data analysis module 1402 performs data profiling to identify data types, structures, and formats. It also conducts goal identification to determine the target goal of the task, such as reconciliation, analytics, or audit. Additionally, the input data analysis module 1402 employs semantic understanding to comprehend field meanings and relationships within the input data.

The task blueprint creation module 1404 formulates a step-by-step execution plan for the task. This module is designed to develop a comprehensive strategy for task completion, considering various approaches and methods.

In some examples, at a high level, the task blueprint creation module 1404 may function as a planning component within the system. It may receive input from preceding modules and generate output that guides subsequent processes. The module may utilize general problem-solving techniques to break down complex tasks into manageable components.

In more specific examples, the task blueprint creation module 1404 may employ algorithmic approaches to explore multiple paths for achieving the task. It may consider different methods such as various matching algorithms for data reconciliation or different aggregation techniques for analysis. The module may also perform action planning, which involves decomposing the task into smaller, more manageable steps. These steps may include operations like data cleaning and data matching. The module may then prioritize these steps based on the task's objective and other relevant factors.

In even more specific examples, the task blueprint creation module 1404 may use advanced decision-making algorithms to evaluate and compare different execution paths. Some examples may include:
The task blueprint creation module 1404 may employ graph-based algorithms to represent possible task execution paths, with nodes representing individual steps and edges representing dependencies or transitions between steps.
The task blueprint creation module 1404 may use heuristic search algorithms, such as A* or beam search, to efficiently explore the solution space and identify promising execution plans.
The task blueprint creation module 1404 may incorporate machine learning techniques, such as reinforcement learning, to improve its path exploration and action planning capabilities over time based on the outcomes of previous task executions.
For prioritizing steps, the task blueprint creation module 1404 may use multi-criteria decision-making algorithms that consider factors such as estimated execution time, resource requirements, and impact on overall task completion.
The blueprint creation process may involve the generation of multiple candidate plans, followed by a simulation or scoring phase to evaluate and rank these plans based on predefined metrics or historical performance data.
In some examples, the task blueprint creation module 1404 may implement adaptive planning techniques that allow for real-time adjustments to the execution plan based on feedback from other modules or changes in the task environment.

The data preparation and cleaning module 1406 operatively ensures that data is properly processed and ready for subsequent analysis and task execution.

In some examples, at a high level, the data preparation and cleaning module 1406 may function as a data preprocessing component within the algorithm architecture 1400. It may receive input data from various sources and transform it into a standardized format suitable for further processing. The module may employ general data-cleaning techniques to improve data quality and consistency.

In more specific examples, the data preparation and cleaning module 1406 may perform several operations to prepare the data. It may conduct data standardization to normalize various formats, such as date formats and currency representations. This standardization process helps ensure consistency across different data sources and facilitates accurate comparisons and analyses. The data preparation and cleaning module 1406 may also implement duplicate detection algorithms to identify and remove redundant records, thereby improving data integrity. Additionally, it may handle errors by systematically checking for missing values, inconsistencies, or outliers in the data set. These error-handling procedures help maintain data quality and prevent potential issues in subsequent processing stages.

In even more specific examples, the data preparation and cleaning module 1406 may use advanced techniques and algorithms to process complex data sets. For instance, the data preparation and cleaning module 1406 may employ machine learning-based anomaly detection methods to identify outliers or unusual patterns in the data. It may use natural language processing techniques to standardize and clean text-based data, such as comments or descriptions. The data preparation and cleaning module 1406 may implement data-matching algorithms to identify and merge duplicate records, even when there are slight variations in the data entries. For handling missing values, the data preparation and cleaning module 1406 may use imputation techniques based on statistical models or machine learning algorithms to estimate and fill in the missing data points. The data preparation and cleaning module 1406 may also incorporate domain-specific rules and constraints to ensure that the cleaned data adheres to business logic and regulatory requirements. Furthermore, the data preparation and cleaning module 1406 may determine if data aggregation is necessary for specific tasks, such as reconciliation or analysis, and perform appropriate summarization or grouping operations on the data.

A task execution module 1408 is responsible for carrying out the specific task using appropriate algorithms and processing logic.

In some examples, at a high level, the task execution module 1408 may function as a processing component within the algorithm architecture 1400. It may receive input from preceding modules and generate output based on the execution of specific tasks. The task execution module 1408 may use general task processing techniques to handle various types of operations.

In more specific examples, the task execution module 1408 may employ task-specific processing logic tailored to the nature of the operation at hand. For instance, it may use matching algorithms for reconciliation tasks or apply analytical algorithms for data analysis tasks. The task execution module 1408 may also incorporate dynamic adjustment capabilities, allowing it to modify its approach based on intermediate results obtained during task execution.

In even more specific examples, the task execution module 1408 may implement algorithms and techniques to optimize task performance. It may utilize machine learning models that can adapt and improve their performance over time based on historical task execution data. The task execution module 1408 may employ parallel processing techniques to handle multiple subtasks simultaneously, improving overall execution speed. For reconciliation tasks, it may use matching algorithms that can handle data structures and account for variations in data formats. In cases where initial results are unsatisfactory, the task execution module 1408 may implement a feedback mechanism that triggers the selection and application of alternative algorithms or processing methods. This adaptive approach ensures that the system can handle a wide range of task complexities and data scenarios effectively.

The root cause analysis module 1410 operates to investigate and identify the underlying reasons for mismatches or errors that occur during task execution.

In some examples, at a high level, the root cause analysis module 1410 may function as an analytical component within the algorithm architecture 1400. It may receive input data related to task execution outcomes and generate insights into the causes of discrepancies or errors. The root cause analysis module 1410 may employ general analytical techniques to identify patterns and trends in the data.

In more specific examples, the root cause analysis module 1410 may use pattern recognition algorithms to detect recurring issues in task execution results. It may conduct exploratory analysis to investigate various potential explanations for mismatches or errors. The root cause analysis module 1410 may further examine transaction patterns, analyze specific types of discrepancies (e.g., such as duplicates or chargebacks), and automatically flag the most probable causes for further investigation.

In even more specific examples, the root cause analysis module 1410 may implement advanced machine learning and data mining techniques to perform in-depth analysis of task execution outcomes. It may use clustering algorithms to group similar types of mismatches or errors, facilitating the identification of common underlying causes. The root cause analysis module 1410 may employ decision tree algorithms to create a hierarchical representation of potential causes, allowing for systematic exploration of different factors contributing to discrepancies. For transaction pattern analysis, the root cause analysis module 1410 may use time series analysis techniques to identify temporal trends or anomalies that could explain certain types of errors. The root cause analysis module 1410 may also incorporate natural language processing capabilities to analyze textual data associated with transactions or errors, potentially uncovering insights from unstructured data sources. Additionally, the root cause analysis module 1410 may implement a scoring system to prioritize identified causes based on their likelihood and impact, ensuring that the most critical issues are addressed first.

A post-task analysis and optimization module 1412 reviews the task execution process and suggests improvements for future tasks. The post-task analysis and optimization module 1412 validates the results of the task execution to ensure correctness and analyzes performance metrics like time taken, accuracy, and resource usage to suggest optimizations. The module also integrates learnings from past tasks to refine future blueprint creation and task execution.

The architecture includes a feedback loop that connects the post-task analysis and optimization module 1412 back to the input data analysis module 1402. This loop allows the algorithm architecture 1400 to continuously improve its performance by incorporating insights gained from each task execution into future tasks.

Each module in the architecture operates in sequence but can also backtrack based on real-time analysis and task outcomes. This dynamic and adaptive approach ensures efficient handling of complex tasks in organizational workflows. The modular design allows for flexibility in task execution, enabling the system to pivot between different strategies as needed to achieve optimal results.

The algorithm architecture 1400 integrates with other components of the AI coworker system, such as the role-based customization and adaptive learning features described in the system architecture. It may be implemented as part of the task agents layer 212, working in conjunction with specialized AI agents 702 to execute various organizational tasks.

In some examples, the algorithm architecture 1400 may be customized for specific organizational roles or departments, with specialized modules tailored to handle domain-specific tasks and data types. The system may also incorporate additional modules or sub-modules to address unique organizational requirements or to integrate with existing enterprise systems.

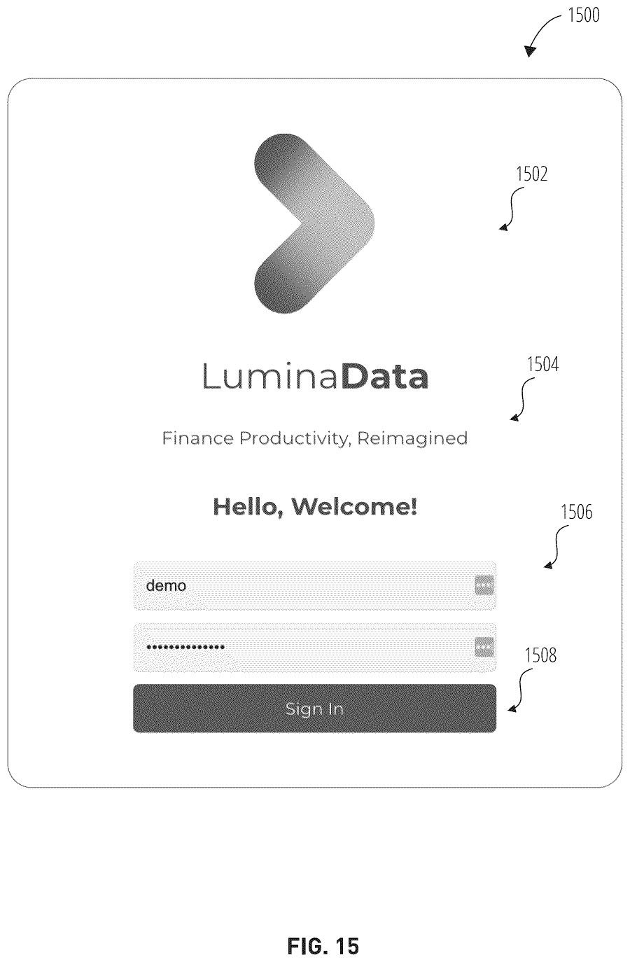

FIG. 15 is a user interface diagram illustrating the layout and functionality of a login screen 1500 for an organizational productivity application, according to some examples.

The login screen 1500 comprises a layout designed to facilitate user authentication and access to the digital co-worker system 102.

At the top of the login screen 1500, a logo and application name 1502 are displayed.

This element serves to identify the application and confirm to users that they are accessing the intended system.

Below the branding, a greeting message 1504 is presented. This text element provides an introductory message to the user.

The central area of the login screen 1500 contains the sign-in components. An input field 1506 is provided for users to enter their login credentials. The input field may be configured to accept various types of user identifiers, such as usernames or email addresses, depending on the system's authentication requirements.

Adjacent to the input field, a sign-in button 1508 is positioned. This interactive element, when activated, initiates the authentication process using the credentials provided in the input field.

In some examples, the login screen 1500 may incorporate additional elements to enhance functionality and user experience. These may include:
A password input field, which may be initially concealed and revealed upon user interaction with the username field.
A persistence option, such as a “Remember me” checkbox, allowing users to store their login information for subsequent sessions.
An account recovery mechanism, such as a “Forgot password” link, providing users with a method to regain access to their account if needed.
Alternative authentication options, such as social media login integrations, enabling users to authenticate using existing accounts on external platforms.

The login screen 1500 may also implement visual feedback mechanisms, such as input field highlighting or error message displays, to guide users through the login process and provide information on their actions.

In more specific examples, the login screen may implement advanced security features. These could include:
Multi-factor authentication mechanisms, requiring users to provide additional verification after entering their initial credentials.
Biometric authentication options, such as fingerprint or facial recognition, for compatible devices.
Challenge-response tests, such as CAPTCHA, to mitigate automated login attempts.

The login screen 1500 facilitates the functionality of the underlying system by serving as the entry point for user authentication. Upon successful authentication, the system may transition the user to a subsequent interface, such as a dashboard or home screen, granting access to the organizational productivity tools and features of the digital co-worker system 102.

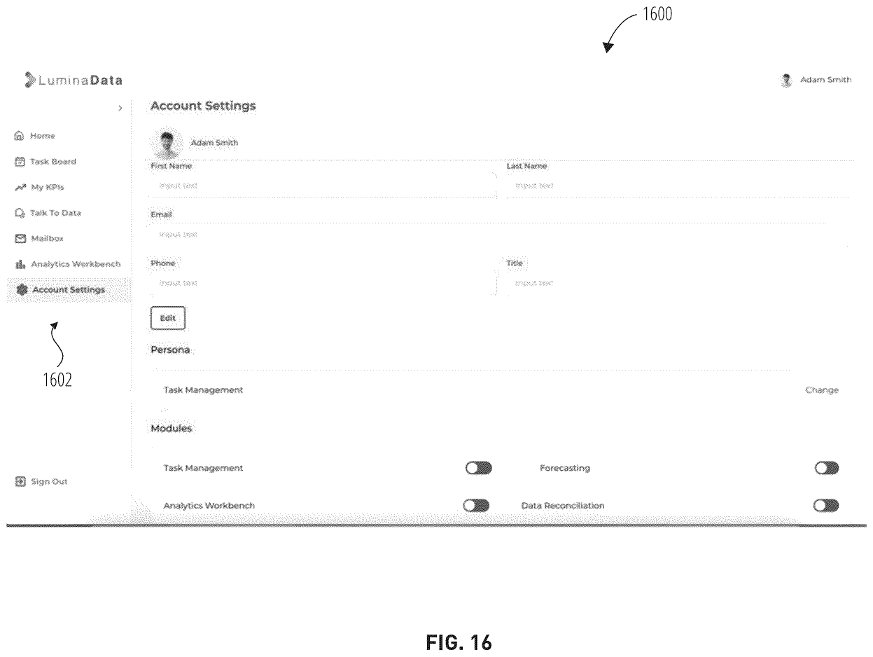

FIG. 16 is a user interface diagram illustrating the layout and functionality of an account setting user interface 1600 for an organizational productivity application, according to some examples.

The account setting user interface 1600 displays an account settings screen for the digital co-worker system 102. The account setting user interface 1600 comprises a layout designed to allow users to view and modify their account information and preferences.

On the left of the account setting user interface 1600, a navigation menu 1602 is presented. This menu includes options such as “Home”, “Task Board”, “My KPIs”, “Talk To Data”, “Mailbox”, “Analytics Workbench”, “Account Settings”, and “Sign Out”. The “Account Settings” option is highlighted, indicating the current active screen.

Adjacent to the navigation menu, the account setting user interface 1600 displays the user's name, which in this example is “Adam Smith”. This element serves to identify the account being managed.

The main content area of the account setting user interface 1600 contains various input fields for user information:
1. First Name input field
2. Last Name input field
3. Email input field
4. Phone input field
5. Title input field

Below these input fields, an “Edit” button is positioned. This interactive element, when activated, may allow users to modify the information in the input fields.

Below the personal information section, a “Persona” section is displayed. This element may allow users to select or modify their role or persona within the system.

The interface also includes a “Modules” section, which displays various modules or features of the application that can be enabled or disabled. In this example, the modules shown are “Task Management,” “Analytics Workbench,” “Forecasting,” and “Data Reconciliation.”

In some examples, the interface may incorporate additional elements to enhance functionality and user experience. These may include:
Profile picture upload functionality allowing users to personalize their account with a visual identifier.
Password change option, enabling users to update their account security credentials.
Notification preferences, where users can customize how they receive alerts and updates from the system.
Language and localization settings, permitting users to adjust the application's language and regional preferences.

In more specific examples, the account setting user interface 1600 may implement advanced features such as:
Two-factor authentication setup, enhancing account security by requiring an additional verification step during login.
API key management, for users who need to integrate the application with other systems or services.
Data privacy controls, allowing users to manage how their data is used and shared within the application.
Account activity log, providing users with a detailed history of their interactions with the system.

The account setting user interface 1600 facilitates the functionality of the underlying system by providing a centralized location for users to manage their account settings and preferences. These settings may influence how the digital co-worker system 102 operates and interacts with the user across its various features and modules.

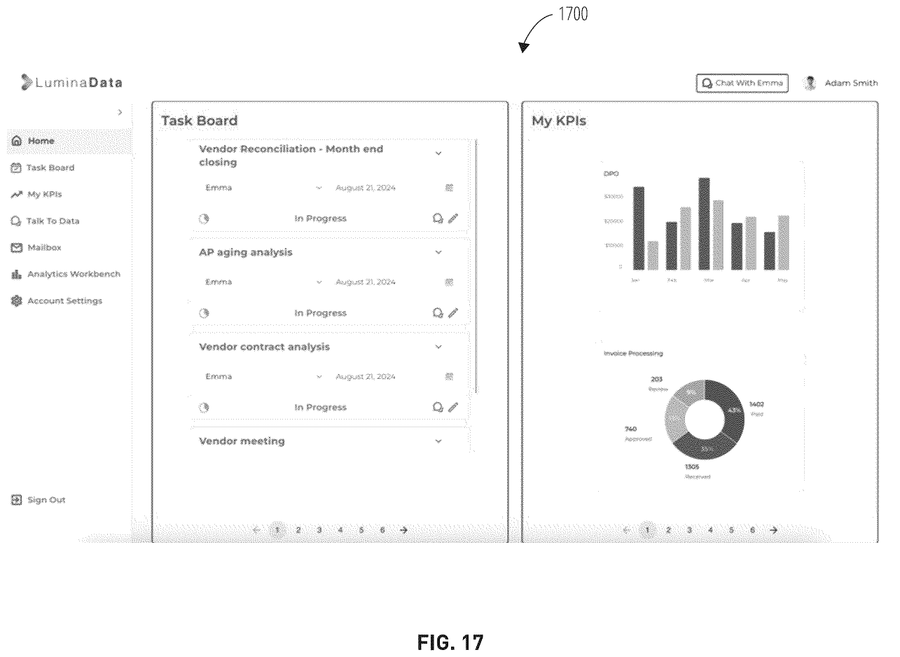

FIG. 17 is a user interface diagram illustrating a home user interface 1700 and specifically the layout and functionality of a task board and key performance indicator (KPI) dashboard for an organizational productivity application, according to some examples.

The home user interface 1700 displays a combined task board and KPI dashboard for the digital co-worker system 102. The home user interface 1700 comprises a layout designed to provide users with an overview of their tasks and performance metrics.

On the left of the interface, a navigation menu is presented. This menu includes options such as “Home”, “Task Board”, “My KPIs”, “Talk To Data”, “Mailbox”, “Analytics Workbench”, “Account Settings”, and “Sign Out”. The “Task Board” option is highlighted, indicating the current active screen.

The main content area of the home user interface 1700 is divided into two sections: a task list on the left and a KPI dashboard on the right.

The task list section displays a series of task cards. Each task card contains information such as:
1. Task name
2. Assigned AI coworker (in this case, “Emma”)
3. Due date
4. Task status (e.g., “In Progress”)

The task cards are presented in a vertical list format, allowing users to scroll through their assigned tasks.

The KPI dashboard section on the right side of the home user interface 1700 presents various performance metrics:
1. A graph displaying a financial metric (possibly “DPO” or Days Payable Outstanding) over time.
2. A circular chart 17 showing invoice processing statistics, including the number of invoices reviewed, approved, received, and paid.
3. Additional KPI metrics may be displayed below these visualizations.

In some examples, the home user interface 1700 may incorporate additional elements to enhance functionality and user experience. These may include:
1. Task filtering options, allowing users to sort or filter tasks based on criteria such as priority, due date, or assigned AI coworker.
2. Task creation functionality, enabling users to add new tasks directly from this interface.
3. Interactive KPI visualizations, permitting users to drill down into specific data points or time periods for more detailed analysis.
4. Customizable dashboard layouts, allowing users to arrange KPI widgets according to their preferences.

In more specific examples, the home user interface 1700 may implement advanced features such as:
1. Real-time task updates, where task statuses and KPI metrics are automatically refreshed without requiring manual page reloads.
2. AI-driven task prioritization, where the digital co-worker system 102 suggests task order based on urgency, importance, and user work patterns.
3. Predictive KPI analytics, providing forecasts of future performance based on historical data and current trends.
4. Integration with external data sources, allowing the KPI dashboard to display metrics from various organizational systems in a unified view.

The home user interface 1700 facilitates the functionality of the underlying AI coworker system by providing a centralized location for users to manage their tasks and monitor performance metrics. The task board allows users to interact with the AI coworker (e.g., Emma) for task execution, while the KPI dashboard provides real-time insights into organizational performance, enabling data-driven decision-making.

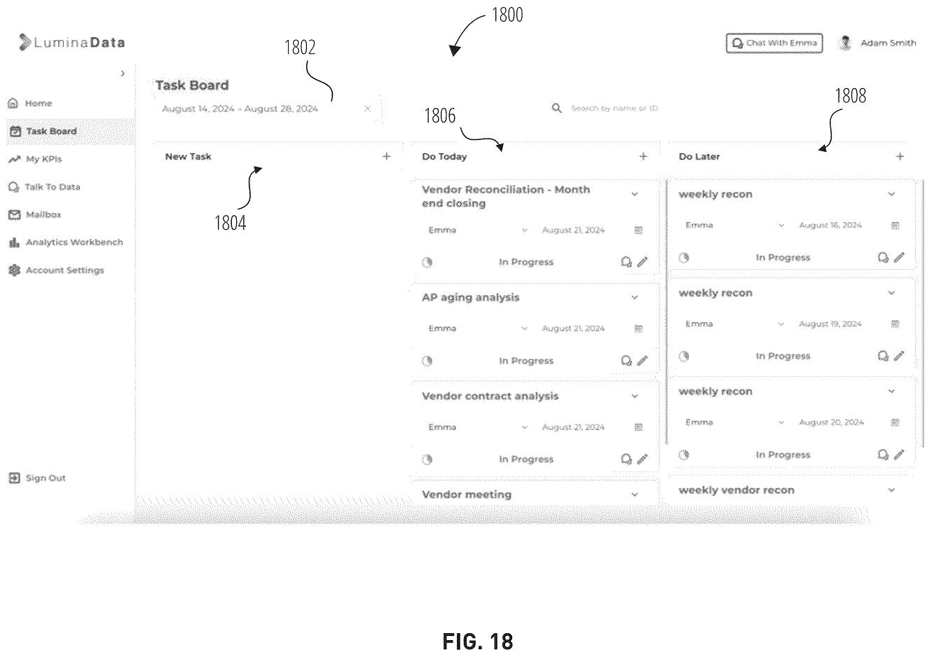

FIG. 18 is a user interface diagram illustrating the layout and functionality of a task board user interface 1800 for an organizational productivity application, according to some examples.

The task board user interface 1800 displays a detailed task board for the digital co-worker system 102. The interface comprises a layout designed to provide users with a comprehensive view of their tasks and enable task management.

A date range selector 1802 is displayed, allowing users to view tasks within a specific time frame. In this example, the date range is set to “Aug. 14, 2024-Aug. 28, 2024”.

The main content area of the interface is divided into primary sections: a new task section 1804, a do today section 1806 and a do later section 1808. Each section contains task cards that provide detailed information about individual tasks.

The task cards in both sections display the following information:

1. Task name
2. Assigned AI coworker (in this case, “Emma”)
3. Due date
4. Task status (e.g., “In Progress”)
5. A visual indicator of task progress or priority

A “+” button may allow users to add new tasks to the respective category.

A search bar is provided, allowing users to search for tasks by name or ID.

In some examples, the task board user interface 1800 may incorporate additional elements to enhance functionality and user experience. These may include:
1. Drag-and-drop functionality, enabling users to move tasks between the “Do Today” and “Do Later” sections or to reorder tasks within each section.
2. Task filtering options, allowing users to sort or filter tasks based on criteria such as priority, assigned AI coworker, or task type.
3. Task detail expansion, where clicking on a task card reveals more detailed information or subtasks.
4. Color-coding or tagging system for tasks, helping users visually categorize or prioritize their work.

In more specific examples, the task board user interface 1800 may implement advanced features such as:
1. AI-driven task prioritization, where the digital co-worker system 102 suggests task order based on urgency, importance, and user work patterns.
2. Real-time collaboration features, allowing multiple team members to view and update tasks simultaneously.
3. Integration with calendar systems, automatically scheduling tasks based on due dates and user availability.
4. Task dependency visualization, showing relationships between tasks and how they impact overall project timelines.
5. Automated task creation based on recurring events or triggers from integrated systems.

The task board user interface 1800 facilitates the functionality of the underlying digital co-worker system 102 by providing a centralized location for users to manage their tasks. The task board user interface 1800 allows users to interact with the AI coworker (e.g., Emma) for task execution, assignment, and prioritization. This task board user interface 1800 serves as a component in the overall organizational productivity system, enabling efficient task management and collaboration between human users and AI coworkers.

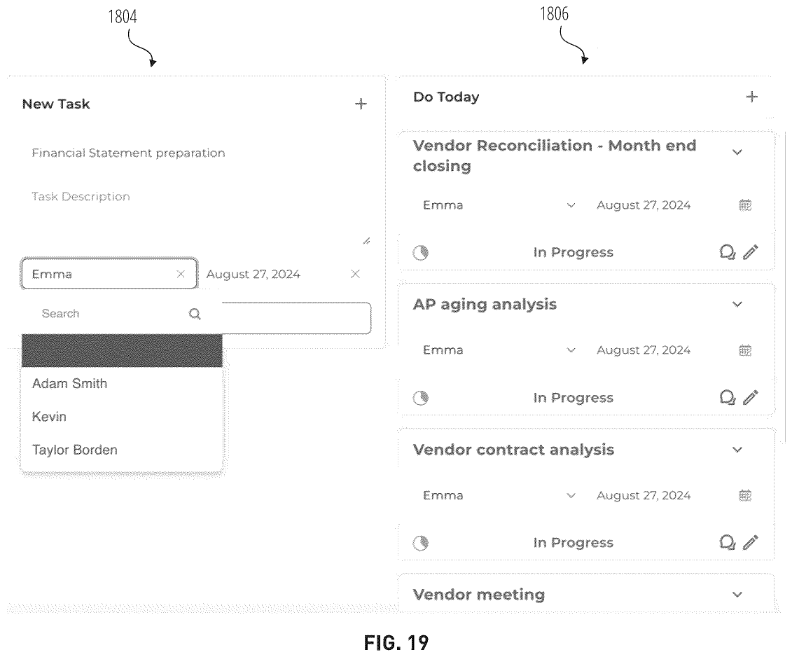

FIG. 19 is a user interface diagram illustrating further details of the new task section and the do today section 1806, according to some examples.

The new task section 1804 facilitates the process of creating a new task. An input field is provided for entering the task description. In this example, the task description is “Financial Statement preparation”.

Below the task description field, a date selector is displayed. This element allows users to set the due date for the task. In the current example, the date is set to “Aug. 27, 2024”.

A search bar is positioned below the task details. This search functionality may allow users to find and select team members or AI coworkers to which the users can assign tasks.

From the search bar, a drop-down menu of potential task assignees 1910 may be activated. These names listed in the menu include both human team members (e.g., “Adam Smith,” “Kevin,” “Taylor Borden”) and the AI coworker (e.g., “Emma.”) Each assignee is represented by a selectable element, allowing the user to choose who will be responsible for the task.

The left portion of the interface displays existing tasks under the do today section 1806 This section shows task cards similar to those seen in the main task board, providing continuity and context for the user as they create a new task.

In some examples, the interface may incorporate additional elements to enhance functionality and user experience. These may include:
1. Priority selection options, allowing users to set the importance or urgency of the task.
2. Task category or tag assignment, enabling better organization and filtering of tasks.
3. Attachment functionality, permitting users to include relevant documents or files with the task.
4. Subtask creation, allowing for the breakdown of complex tasks into smaller, manageable components.

In more specific examples, the task assignment interface may implement advanced features such as:
1. AI-assisted task description generation, where the digital co-worker system 102 suggests task details based on similar past tasks or organizational patterns.
2. Intelligent assignee recommendations, where the digital co-worker system 102 suggests the most suitable team member or AI coworker based on skills, workload, and task requirements.
3. Automated task scheduling, where the digital co-worker system 102 proposes optimal start and due dates based on the assignee's current workload and task priority.
4. Integration with project management tools, allowing tasks to be automatically linked to relevant projects or workflows.

The user interface facilitates the functionality of the underlying digital co-worker system 102 by providing a streamlined process for task creation and assignment. It allows for the integration of human team members and AI coworkers in task management, supporting the collaborative nature of the digital co-worker system 102.

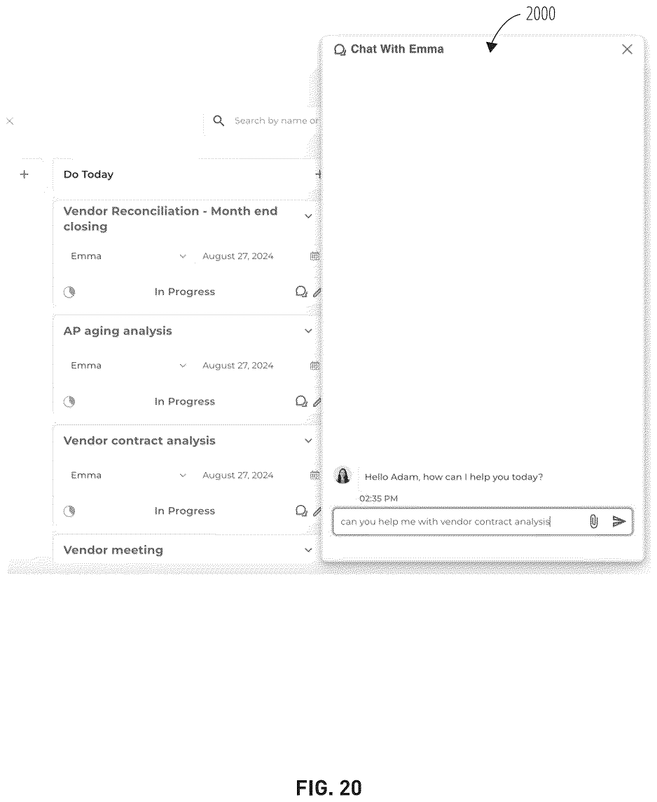

FIG. 20 is a user interface diagram illustrating the layout and functionality of a chat interface 2000 within an organizational productivity application, according to some examples.

The chat interface 2000 displays a conversation between a user and an example AI coworker named Emma within the digital co-worker system 102. The chat interface 2000 comprises a layout designed to facilitate natural language interaction between users and the AI system.

At the top of the chat interface, a header displays “Chat With Emma”, indicating the current interaction context. This header helps users understand they are communicating with the AI coworker

The main content area of the interface includes a conversation display. This area shows the exchange of messages between the user and Emma. Each message is presented in a distinct bubble or block, with user messages typically aligned to one side and Emma's responses to the other. This visual separation helps users distinguish between their inputs and the AI's outputs.

At the bottom of the interface, an input field is provided for users to type their messages or queries. This field may include placeholder text such as “Type your message here . . . ” to guide user input.

In some examples, the chat interface 2000 may incorporate additional elements to enhance functionality and user experience. These may include:
1. A send button adjacent to the input field, allowing users to submit their messages.
2. Timestamps for each message, providing context for when each interaction occurred.
3. Message status indicators (e.g., sent, delivered, read) to confirm successful communication.
4. Attachment options, enabling users to share files or images within the chat.

In more specific examples, the chat interface 2000 may implement features such as:
1. Real-time typing indicators, showing when Emma is “composing” a response.
2. Message formatting options, allowing users to structure their queries with bold, italic, or list formats for clarity.
3. Context-aware suggestions, where the system offers potential queries or actions based on the current conversation topic.
4. Integration with other application features, such as the ability to create tasks or view KPIs directly from the chat interface.

The chat interface 2000 facilitates the functionality of the underlying AI coworker system by providing a natural language interaction point between users and the AI. It allows users to ask questions, request assistance with tasks, and receive information or guidance from Emma in a conversational manner. This interface serves as a key component in the overall organizational productivity system, enabling efficient communication and collaboration between human users and AI coworkers.

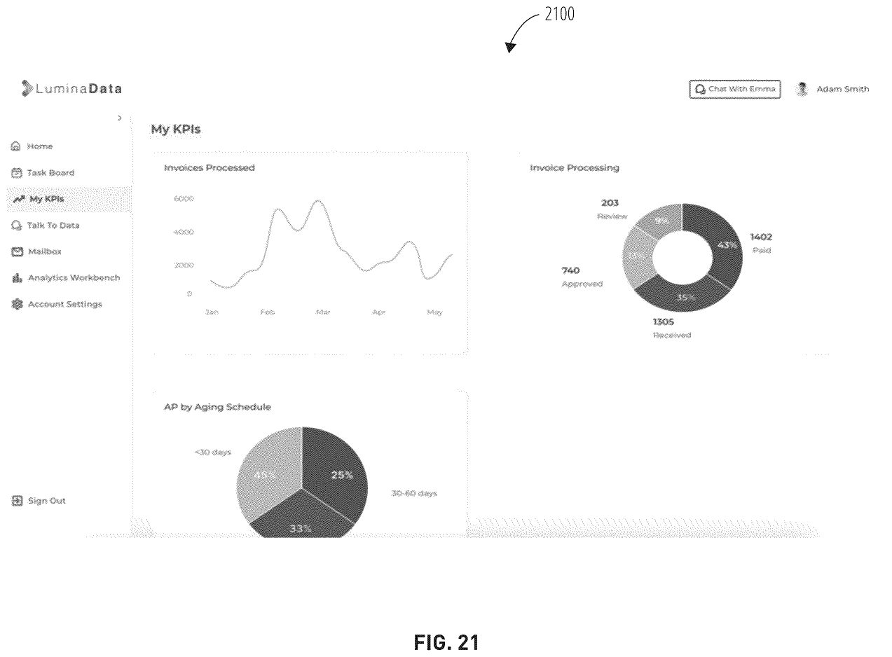

FIG. 21 is a user interface diagram illustrating the layout and functionality of a Key Performance Indicator (KPI) dashboard in the form of a KPIs interface 2100 within an organizational productivity application, according to some examples.

The KPIs interface 2100 displays a comprehensive overview of various performance metrics for the digital co-worker system 102. The KPIs interface 2100 comprises a layout designed to provide users with quick insights into key financial and operational data.

The main content area of the interface is divided into several sections, each presenting different KPI visualizations:
A line graph titled “Invoices Processed” is displayed at the top of the KPIs interface 2100. This graph shows the number of invoices processed over time, with data points for different months (January, February, March, April, May). The y-axis represents the number of invoices, while the x-axis represents the time periods.
A circular chart titled “AP by Aging Schedule” is presented. This chart breaks down accounts payable by different aging categories, such as “<30 days”, “30-60 days”, and potentially other time ranges. Each category is represented by a different colored segment of the circle, with percentages indicating the proportion of payables in each aging bracket.
An “Invoice Processing” section is displayed. This section provides a breakdown of invoice statuses using both numerical values and percentages. The statuses shown include:
   Review: 203 (9%)
   Approved: 740 (35%)
   Received: 1305
   Paid: 1402 (43%)

In some examples, the KPIs interface 2100 may incorporate additional elements to enhance functionality and user experience. These may include:
1. Interactive tooltips that provide more detailed information when hovering over data points or chart segments.
2. Date range selectors, allowing users to adjust the time period for which KPIs are displayed.
3. Customizable dashboard layouts, enabling users to arrange KPI widgets according to their preferences or role-specific needs.

In more specific examples, the KPIs interface 2100 may implement features such as:
1. Real-time data updates, where KPI metrics are automatically refreshed at regular intervals or when new data becomes available.
2. Drill-down capabilities, allowing users to click on specific metrics or data points to view more granular information or underlying data.
3. Predictive analytics, where the system provides forecasts or trend analysis based on historical KPI data.
4. Comparative analysis tools, enabling users to benchmark current KPIs against previous periods or predefined targets.

The KPIs interface 2100 facilitates the functionality of the underlying digital co-worker system 102 by providing a visual representation of key financial and operational metrics. This allows users to quickly assess performance, identify trends, and make data-driven decisions. The interface serves as a component in the overall organizational productivity system, enabling efficient monitoring and analysis of business performance

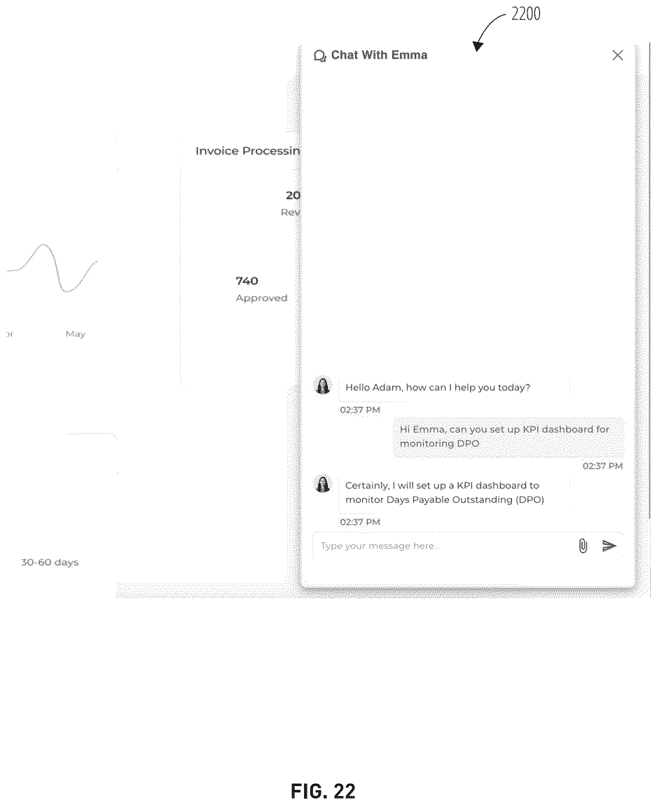

FIG. 22 is a user interface diagram illustrating the layout and functionality of an AI chat interface 2200 within an organizational productivity application, according to some examples.

The AI chat interface 2200 displays a conversation between a user and an AI coworker named Emma within the digital co-worker system 102. This chat interface 2200 is accessed when the user selects the AI chat activation button shown in FIG. 21.

The main content area of the interface includes a conversation display. This area shows the exchange of messages between the user and Emma. Each message is presented in a distinct bubble or block, with user messages typically aligned to one side and Emma's responses to the other.

At the bottom of the interface, an input field is provided for users to type their messages or queries. This field may include placeholder text such as “Type your message here . . . ” to guide user input.

The chat interface allows users to interact with an AI agent 702 (e.g., Emma) to set up and customize the KPIs interface 2100. For example, a user might type a message like “Hi Emma, can you set up KPI dashboard for monitoring DPO” as shown in the interface.

In response, Ethe AI agent 702 might confirm the request and proceed to set up the KPI dashboard for monitoring Days Payable Outstanding (DPO). This interaction demonstrates how users can leverage natural language commands to configure and customize their KPI displays.

In some examples, the AI chat interface 2200 may provide additional functionality for KPI setup:
1. Guided KPI selection, where the AI agent 702 asks follow-up questions to determine which KPIs are most relevant to the user's role or current objectives.
2. Data source specification, allowing users to indicate which financial systems or databases should be used to populate the KPIs.
3. Visualization preferences, enabling users to specify how they want the KPIs displayed (e.g., as graphs, charts, or numerical indicators).

In more specific examples, the AI chat interface 2200 may implement features for KPI configuration:
1. Natural language processing capabilities that can interpret complex requests and break them down into actionable steps for KPI setup.
2. Machine learning algorithms that suggest relevant KPIs based on the user's role, past interactions, and organizational patterns.
3. Real-time KPI preview, where Emma can generate and display sample KPI visualizations within the chat interface for user approval before finalizing the dashboard.

The AI chat interface 2200 facilitates the functionality of the underlying digital co-worker system 102 by providing a conversational means for users to configure and customize their KPI dashboards. This allows for a more intuitive and user-friendly approach to data visualization and performance monitoring, enabling users to quickly set up and modify their KPI displays without needing extensive technical knowledge of the underlying systems.

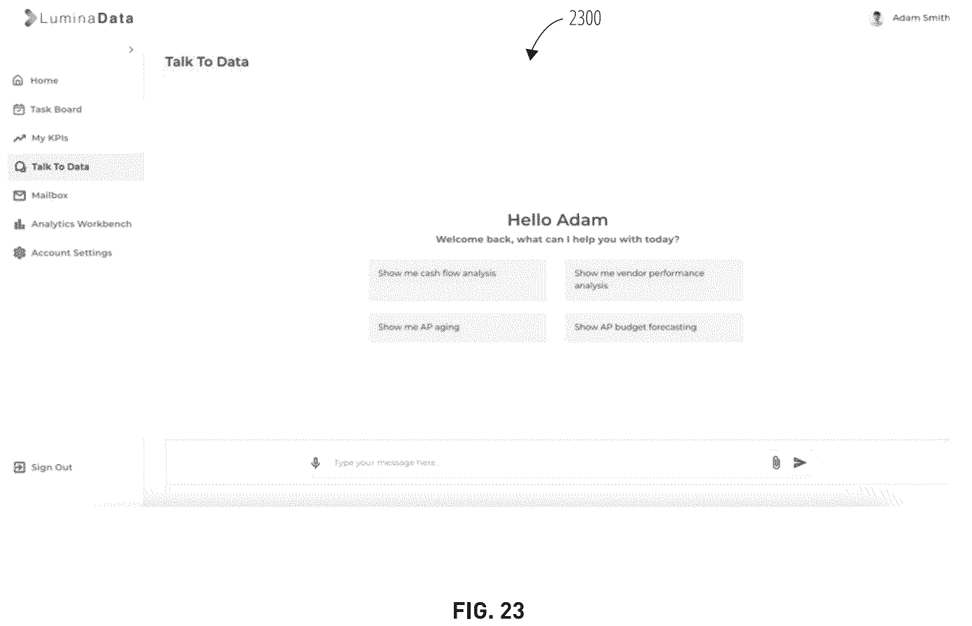

FIG. 23 illustrates a user interface diagram showcasing the layout and functionality of a talk to data interface 2300 within an organizational productivity application, according to some examples.

The talk to data interface 2300 displays a conversation-style interaction between a user and the digital co-worker system digital co-worker systems 102, designed to facilitate natural language queries about organizational data. The talk to data interface 2300 comprises a layout that enables users to ask questions and receive data-driven responses.

The main content area of the interface comprises:
A greeting message from the digital co-worker system 102, welcoming the user and prompting for input.
A series of suggested query buttons or chips, providing quick access to common data analysis requests. Examples of these suggestions include:
   “Show me cash flow analysis”
   “Show me vendor performance analysis”
   “Show me AP aging”
   “Show AP budget forecasting”
An input field at the bottom of the talk to data interface 2300, where users can type custom queries or data requests.

The talk to data interface 2300 may support various functions to enhance data analysis and decision-making:
Natural Language Query Processing: The interface allows users to ask questions about their data in plain language, without requiring knowledge of specific query languages or data structures.
Data Visualization Generation: Based on user queries, the system can generate appropriate visualizations such as charts, graphs, or tables to represent the requested data.
Trend Analysis: Users may ask questions about trends in their financial data, and the digital co-worker system 102 can provide insights on patterns or changes over time.
Comparative Analysis: The talk to data interface 2300 may support queries that compare different periods, departments, or metrics, providing a comprehensive view of organizational performance.
Predictive Analytics: Advanced implementations may allow users to ask about future projections or forecasts based on historical data and trends.
Data Drill-Down: Users might be able to ask follow-up questions to explore specific aspects of the data presented.
Custom Report Generation: The interface could support requests for generating custom reports based on specific data points or metrics of interest.
Data Source Integration: The digital co-worker system 102 may be capable of pulling data from various sources within the organization to provide comprehensive answers to user queries.

In more specific examples, the talk to data interface 2300 may implement advanced features such as:
Context-aware suggestions: As users interact with the digital co-worker system 102, it may learn to provide more relevant query suggestions based on user history and current organizational focus.
Multi-modal input: The talk to data interface 2300 may support voice input in addition to text, allowing for hands-free data querying.
Explainable AI: For complex queries, the digital co-worker system 102 might provide explanations of how it arrived at certain conclusions or data interpretations.
Data anomaly detection: The digital co-worker system 102 may proactively highlight unusual patterns or discrepancies in the data as part of its responses.

The talk to data interface 2300e facilitates the functionality of the underlying digital co-worker system 102 by providing a user-friendly, conversational approach to data analysis. This allows users across various roles in the organization to gain insights from complex financial and operational data without requiring extensive technical knowledge or data analysis skills.

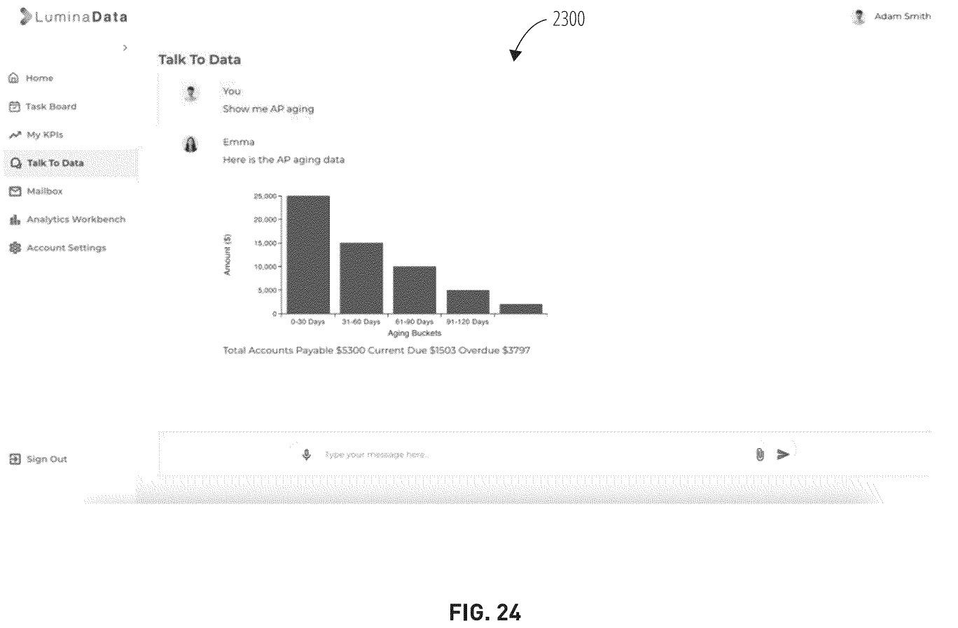

FIG. 24 illustrates a user interface diagram showcasing the layout and functionality of the talk to data interface 2300 within the digital co-worker system 102, focusing on a specific use case example of how it responds to a user query.

In this example, the user has entered a query related to AP aging analysis. The interface displays the following elements:
User Query: At the bottom of the interface, the user's input “Show me AP aging” is visible in the chat input field.
AI Response: The AI system, represented by an AI agent 702, processes the query and generates a response. The response is displayed in the conversation area and includes:
   A textual summary of the AP aging data: “Here is the AP aging data”
   A visual representation of the data in the form of a bar chart. The chart shows:
      The x-axis representing aging buckets: “0-30 Days”, “31-60 Days”, “61-90 Days”, and “91-120 Days”
      The y-axis representing the amount in dollars, with values ranging from 0 to 25,000
      Bars of varying heights corresponding to the amount in each aging bucket
   Additional summary statistics below the chart: “Total Accounts Payable $5300 Current Due $1503 Overdue $3797”

This specific use case demonstrates how the talk to data interface 2300 may process a user's natural language query about financial data and provide a comprehensive response. The digital co-worker system 102 combines textual information with visual data representation, allowing users to gain immediate insights into their accounts payable aging situation.

The talk to data interface 2300 facilitates easy data interpretation by presenting the information in multiple formats:
The bar chart offers a quick visual comparison of amounts across different aging buckets, allowing users to identify patterns or areas of concern at a glance.
The summary statistics provide precise figures for total accounts payable, current due amounts, and overdue amounts, giving users a clear overview of their AP status.

This approach to data presentation enables finance professionals to conveniently assess their accounts payable situation and make informed decisions based on the aging of their payables.

The talk to data interface 2300 demonstrates the system's ability to understand and process natural language queries related to financial data, retrieve relevant information from the organization's data sources, and present it in a user-friendly format. This functionality supports efficient decision-making processes by providing quick access to critical financial information without requiring users to navigate complex database queries or spreadsheet analyses.

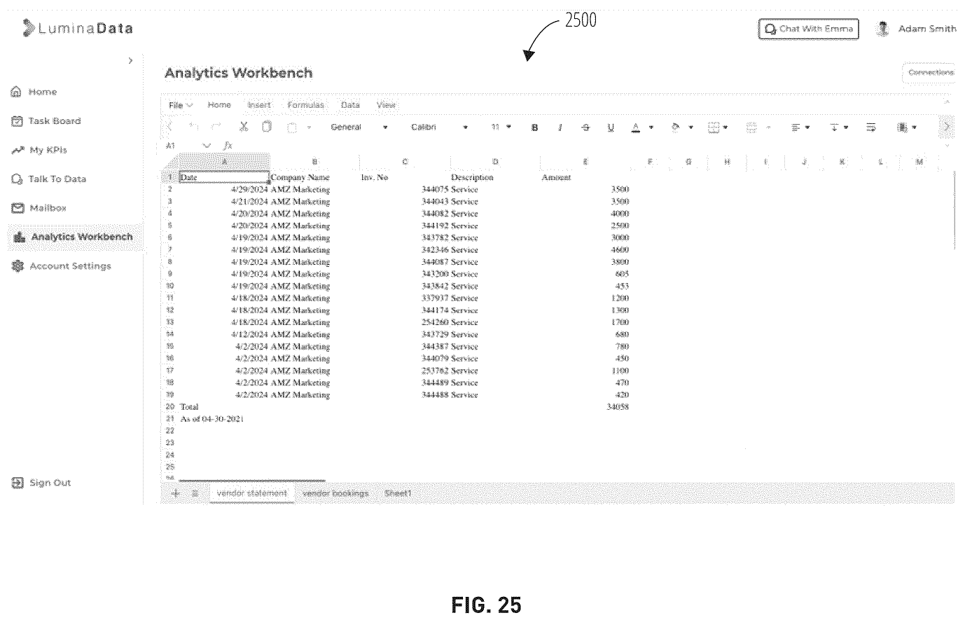

FIG. 25 illustrates an analytics workbench interface 2500, according to some examples, within the digital co-worker system 102, showcasing a spreadsheet-like environment for data analysis and manipulation.

The analytics workbench interface 2500 comprises several example components:
Toolbar: At the top of the interface, a toolbar displays various options typically found in spreadsheet applications, such as file operations, formatting tools, and data manipulation functions.
Formula Bar: Below the toolbar, a formula bar is visible, allowing users to input and edit cell contents or formulas.
Spreadsheet Grid: The main area of the interface presents a grid-like structure resembling a traditional spreadsheet. This grid contains columns labeled with letters (A, B, C, etc.) and rows numbered sequentially.
Data Display: The spreadsheet grid is populated with financial data, including dates, company names, invoice numbers, descriptions, and amounts. This suggests that the Analytics Workbench can import and display structured financial data for analysis.
Chat Interface: On the right side of the interface, a “Chat With Emma” panel is visible, indicating that users can interact with the AI assistant while working with the data.

The analytics workbench interface 2500 supports several functions that enhance data analysis capabilities:
Data Import: Users can import data from various sources into the workbench for analysis.
Data Manipulation: The spreadsheet-like environment allows users to manipulate data, potentially including sorting, filtering, and applying formulas.
AI-Assisted Analysis: The integration of the chat interface with AI agents 702 means that users can leverage AI capabilities to assist with data analysis tasks, potentially including generating insights, creating visualizations, or performing complex calculations.
Customization: The toolbar and formula bar enable users to customize their analysis environment, apply to format, create custom formulas, or adjust the display of data.
Collaboration: The analytics workbench interface 2500 facilitates collaborative work between human users and AI, potentially enhancing the depth and efficiency of financial analysis.

This interface demonstrates the integration of traditional spreadsheet functionality with advanced AI capabilities, providing users with a powerful tool for financial data analysis and decision-making within the digital co-worker system 102.

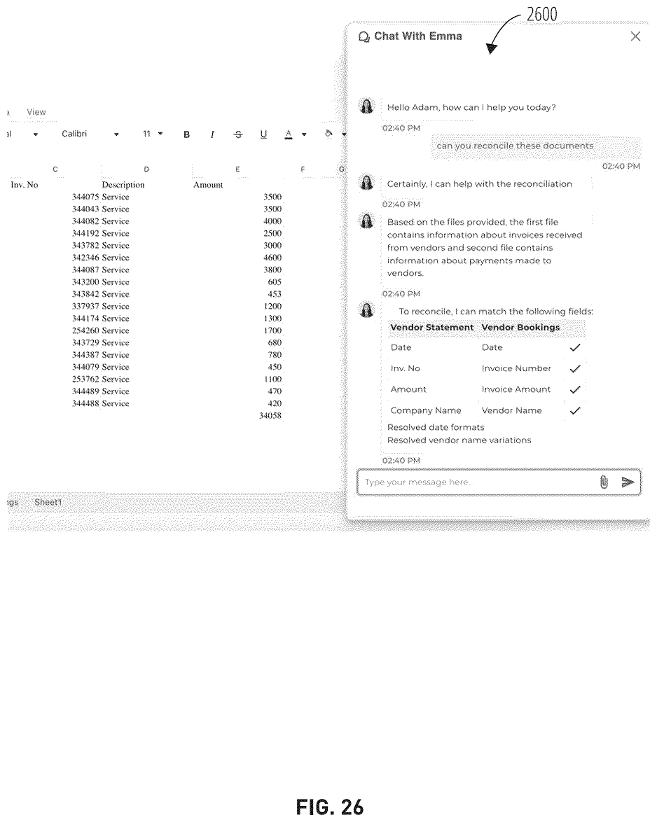

FIG. 26 is a user interface diagram illustrating the layout and functionality of an AI chat interface 2600 within an analytics workbench interface 2500, according to some examples.

The AI chat interface 2600 comprises a chat window overlaid on a spreadsheet-like environment.

The AI chat interface 2600 comprises several key components:
A close button is located in the top-right corner, enabling users to dismiss the chat window.
The conversation area displays the exchange between the user and an AI agent 702. Messages are presented in distinct bubbles, with user messages aligned to the right and Emma's responses to the left.
An input field is positioned at the bottom of the chat window, where users can type their messages. A send button and an attachment button are located adjacent to the input field.

The conversation in the interface demonstrates a specific use case:
The user asks the AI agent 702 (e.g., Emma) to reconcile documents, as shown in the message “Can you reconcile these documents?”.
Emma responds affirmatively and provides a detailed explanation of the reconciliation process. The AI agent 702 identifies the contents of the files, explains the matching fields, and notes resolved issues such as date formats and vendor name variations.
The background spreadsheet displays financial data, including invoice numbers, descriptions, and amounts. This arrangement allows users to reference relevant data while interacting with AI agent 702.

The AI chat interface 2600 facilitates integration between data analysis and AI assistance. Users can request complex operations like document reconciliation while maintaining visibility of the underlying financial data.

In some examples, the AI chat interface 2600 may implement additional features:
Natural language processing capabilities to interpret complex financial queries and commands.
Real-time data analysis, where AI agent 702 can perform calculations or generate visualizations based on the visible spreadsheet data.
Context-aware suggestions, where the AI agent 702 proposes relevant actions or analyses based on the current data and conversation history.

The AI chat interface 2600 within the analytics workbench enables users to leverage AI capabilities for data analysis tasks, potentially enhancing efficiency and accuracy in financial operations.

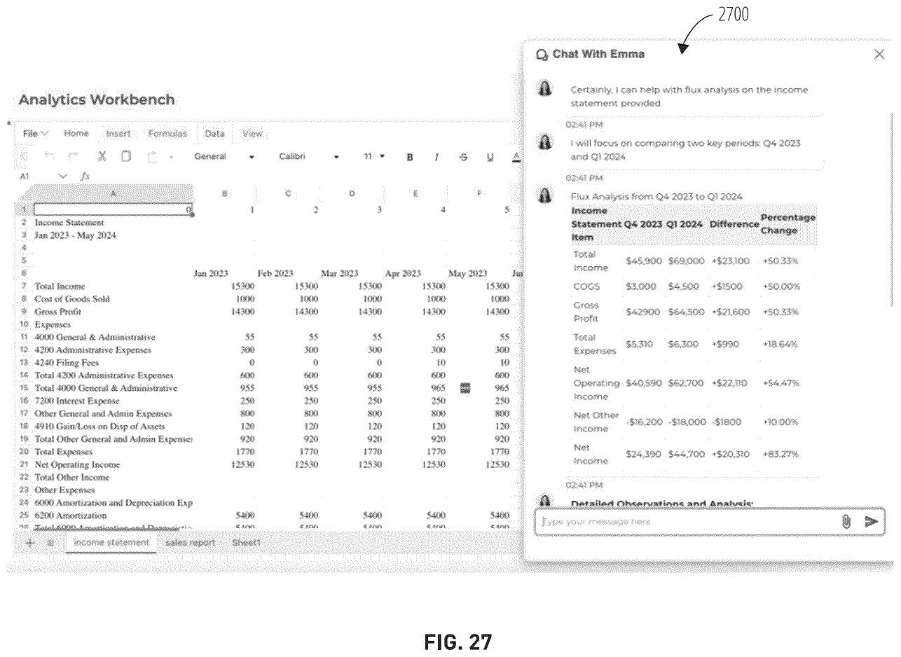

FIG. 27 is a user interface diagram illustrating the layout and functionality of an AI chat interface 2700 within an analytics workbench interface 2500, according to some examples.

The AI chat interface 2700 displays a conversation between a user and an AI agent 702 named Emma. The interface is overlaid on top of a spreadsheet-like environment, allowing users to interact with Emma while viewing financial data.

The chat interface comprises several key components:
A header labeled “Chat With Emma” at the top of the window.
A close button in the top-right corner, enabling users to dismiss the chat window.
A conversation area displaying the exchange between the user and Emma. Messages are presented in distinct bubbles, with user messages aligned to the right and Emma's responses to the left.
An input field at the bottom of the chat window for users to type their messages.

The conversation in the interface demonstrates a specific use case related to financial analysis:
Emma provides a detailed flux analysis comparing Q4 2023 and Q1 2024 financial data.
The analysis includes a breakdown of various financial metrics such as Total Income, COGS, Gross Profit, Total Expenses, Net Operating Income, Net Other Income, and Net Income.
Emma presents the data in a tabular format, showing values for Q4 2023, Q1 2024, the difference between the two periods, and the percentage change.
The AI assistant offers to provide more detailed observations and analysis based on the flux analysis results.

The AI chat interface 2700 facilitates integration between data analysis and AI agents 702. Users can request complex financial analyses while maintaining visibility of the underlying spreadsheet data.

In some examples, the AI chat interface 2700 may implement additional features:
Natural language processing capabilities to interpret complex financial queries and commands.
Real-time data analysis, where the AI agent 702 can perform calculations or generate visualizations based on the visible spreadsheet data.
Context-aware suggestions, where the AI agent 702 proposes relevant analyses or insights based on the current data and conversation history.

The AI chat interface 2700 within the analytics workbench interface 2500 enables users to leverage AI capabilities for advanced financial analysis tasks, potentially enhancing efficiency and accuracy in financial operations and decision-making processes.

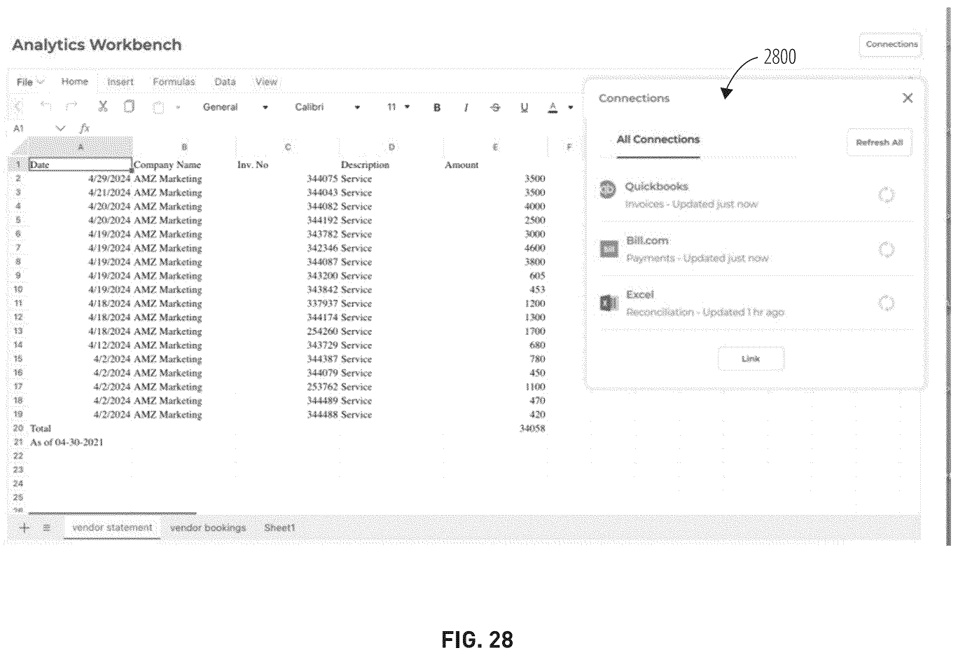

FIG. 28 is a user interface diagram illustrating the layout and functionality of a connections interface 2800 within an organizational productivity application, according to some examples.

The connections interface 2800 displays options for integrating the digital co-worker system 102 with third-party systems. The connections interface 2800 comprises a layout designed to facilitate the connection and management of external data sources and tools.

A main content area of the interface presents a list of connection options, including:
Quickbooks: An icon representing QuickBooks integration is displayed, indicating the ability to connect to this accounting software.
Bill.com: An icon for Bill.com integration is shown, supporting functionality to link with this accounts payable and receivable platform.
Excel: An Excel icon is present, supporting the capability to import or export data to and from Excel spreadsheets.

These connection options align with the data sources layer 216, which includes integrations with various business systems such as ERP systems, CRM systems, and Excel spreadsheets.

The connections interface 2800 facilitates the functionality of the underlying digital co-worker system 102 by enabling access to diverse data sources. This integration capability supports the system's ability to process and analyze financial data from multiple platforms, enhancing its effectiveness in performing financial tasks and generating insights.

In some examples, the connections interface 2800 may implement additional features such as:
Connection status indicators to show whether each integration is active or requires setup.
Configuration options for each connected system, allowing users to specify data sync preferences or access permissions.
Data flow visualizations to illustrate how information moves between the digital co-worker system 102 and connected systems.

The connections interface plays a role in the system's data integration capabilities, allowing it to access and process information from various enterprise systems. This aligns with the system's ability to handle heterogeneous data from multiple sources, addressing the technical challenge of integrating diverse data types for comprehensive financial analysis and operations.

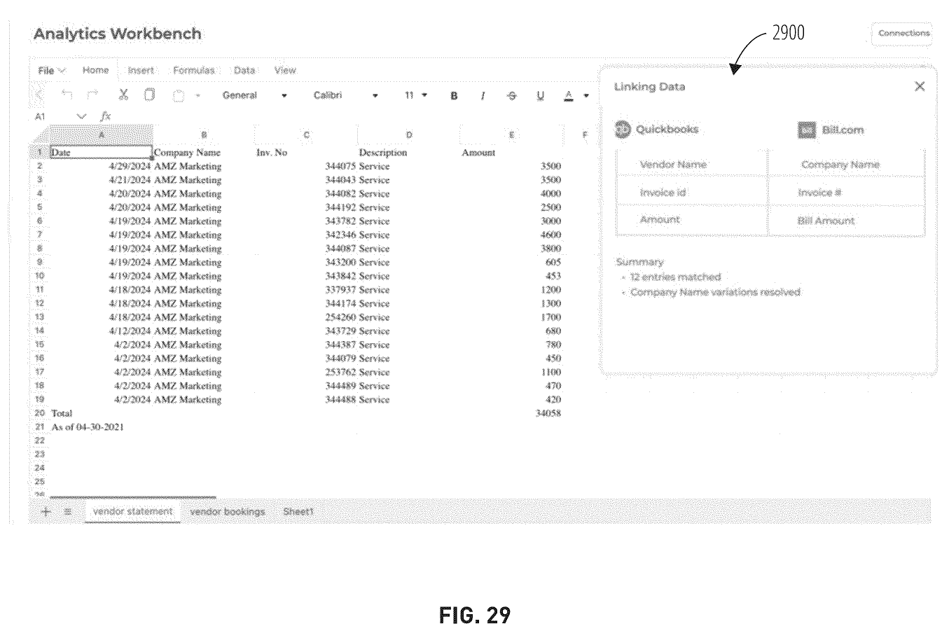

FIG. 29 is a user interface diagram illustrating the layout and functionality of a linking data dialog box 2900 within an analytics workbench interface 2500, according to some examples.

The linking data dialog box 2900 displays a dialog box overlaid on a spreadsheet-like environment, facilitating the connection between different data sources. The interface comprises several key components:
A header labeled “Linking Data” at the top of the dialog box.
Two columns representing different data sources:
   Left column labeled “Quickbooks” 2904
   Right column labeled “Bill.com” 2906
Rows displaying field mappings between the two data sources:
   Vendor Name mapped to Company Name
   Invoice id mapped to Invoice #
Amount mapped to Bill Amount

A summary section at the bottom of the linking data dialog box 2900, indicating “12 entries matched” and “Company Name variations resolved”.

The linking data dialog box 2900 allows users to establish connections between different data sources, specifically financial systems like Quickbooks and Bill. com in this example. This functionality aligns with the system's data integration capabilities, enabling it to process information from various enterprise systems.

The interface facilitates the following operations:
Field Mapping: Users can visually map corresponding fields between different data sources, ensuring accurate data integration.
Data Matching: The system automatically matches entries between the connected systems, as indicated by the “12 entries matched” summary.
Data Normalization: The linking data dialog box 2900 resolves variations in data representation, such as company name variations, to ensure consistent data integration.

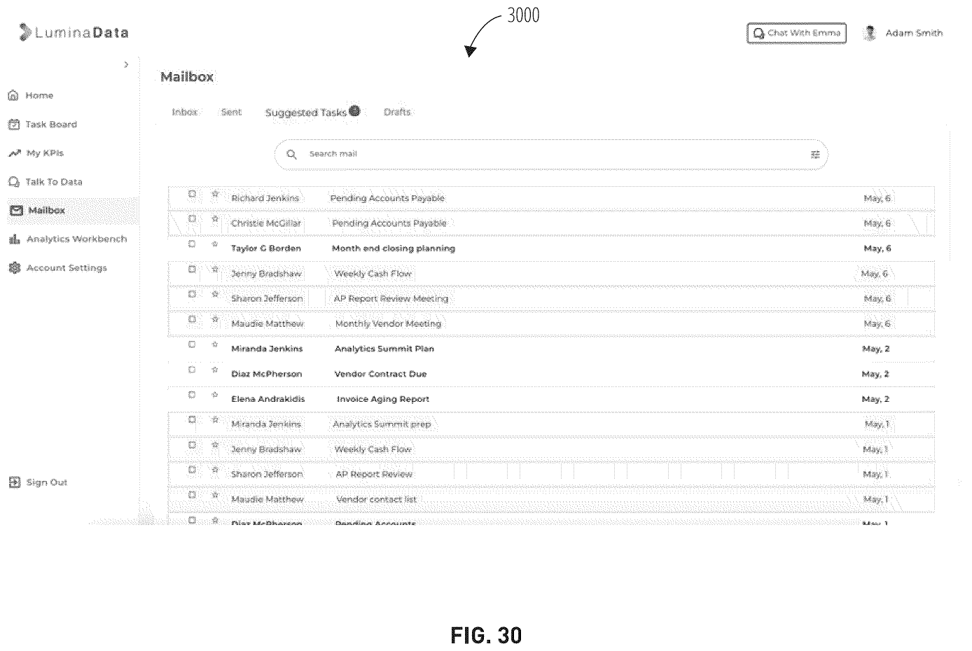

FIG. 30 is a user interface diagram illustrating the layout and functionality of a mailbox interface 3000 within an organizational productivity application, according to some examples.

The mailbox interface 3000 displays a list of the user's email communications. The interface comprises several key components:
A header labeled “Mailbox” at the top of the interface.
A “Suggested Tasks” section, which presents a list of tasks extracted from email content.
Each email item in the inbox includes:
   The sender's name
   A brief description of the task or email subject
   The date the email was received

A search field at the top of the task list, allowing users to filter or search for specific tasks.

The interface surfaces the following functionalities:
Task Extraction: The system automatically analyzes incoming emails to identify potential tasks or action items.
Task Prioritization: Tasks are likely ordered based on factors such as urgency, sender importance, or due dates.
Quick Access: Users can quickly view and access tasks without having to manually sort through their email inbox.

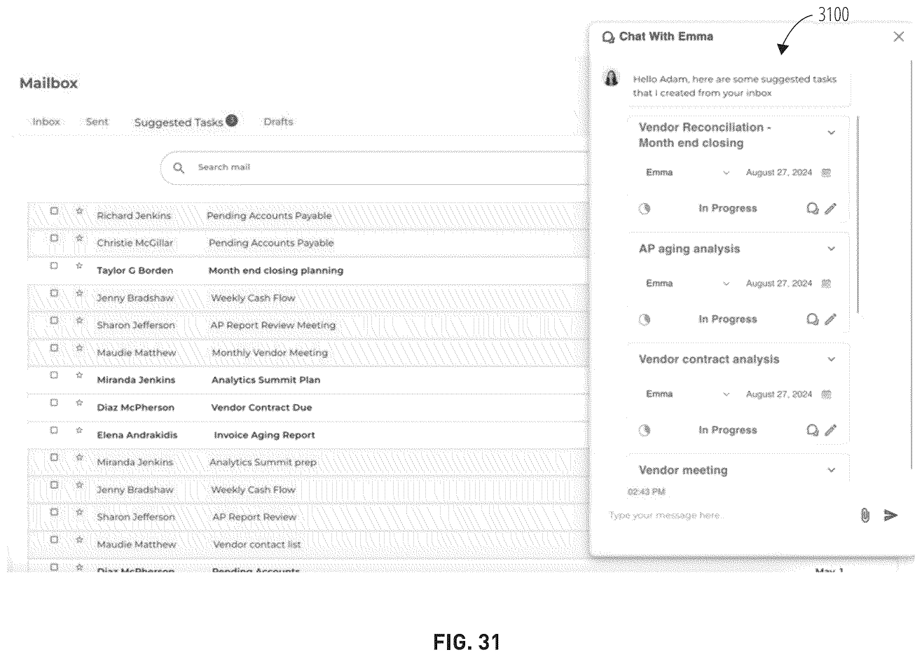

FIG. 31 is a user interface diagram illustrating the layout and functionality of an AI chat interface 3100 overlaid on a mailbox interface 3000 within an organizational productivity application, according to some examples.

The AI chat interface 3100 displays a conversation between a user and an AI assistant named Emma. The chat window comprises several key components:
A header labeled “Chat With Emma” at the top of the dialog box.
A conversation area displaying the exchange between the user and Emma. Messages are presented in distinct bubbles, with Emma's responses aligned to the left and including an avatar icon.
A message input field at the bottom of the chat window, allowing users to type their queries or responses.

The AI chat interface 3100 demonstrates how an AI agent 702 interacts with suggested tasks created from emails, in an illustrative example:
Task Generation: Emma has analyzed the user's inbox and/or sent box and generated a list of potential tasks. These tasks are displayed in the background, showing items like “Vendor Reconciliation-Month end closing,” “AP aging analysis,” “Vendor contract analysis,” and “Vendor meeting.”
Task Details: Each suggested task includes the assigned owner (e.g., Emma in this case), the task name, its due date (Aug. 27, 2024), and its current status (e.g., “In Progress”).
Task Integration: Emma can discuss and provide information about these automatically generated tasks within the chat interface. The visible message from Emma states, “Hello, Adam; here are some suggested tasks that I created from your inbox.”

The digital co-worker system 102 implements automatic allocation of tasks to both human co-workers and digital co-workers like Emma through several components:
Task Generator 314: This module creates both periodic and ad-hoc tasks based on the AI co-worker's role understanding. It dynamically generates tasks aligned with specific role requirements.
Task Prioritization Module 320: This component organizes tasks based on factors like manager input, time sensitivity, and task importance. It efficiently manages the task queue to optimize workflow.
Task Scheduler 322: The scheduler assigns specific times for task execution, considering task priority and manager preferences. It ensures even distribution of tasks to maintain productivity and prevent bottlenecks.
Task Executor 324: This module carries out scheduled tasks using predefined procedures and integrated skills. It adapts execution strategies based on real-time data and feedback.
AI Agents 702: The system utilizes multiple specialized AI agents, like Emma, to execute various tasks. These agents can be assigned to specific subtasks based on their capabilities.
Role-Based Assignment: Tasks are allocated based on the specific roles defined for both human and AI co-workers. The digital co-worker system 102 understands role requirements and assigns tasks accordingly.
Intelligent Task Distribution: The digital co-worker system 102 can automatically distribute tasks between human team members and AI agents based on factors like workload, expertise, and task complexity.
Adaptive Learning: The digital co-worker system 102 learns from past task allocations and outcomes to improve future task assignments, optimizing the distribution between human and AI workers over time.
Manager Oversight: While tasks are automatically allocated, managers can review, adjust, and override assignments as needed through the manager communication and feedback modules.

This automated allocation enables efficient task management across both human and AI team members, leveraging the strengths of each to optimize overall productivity and performance in financial operations.

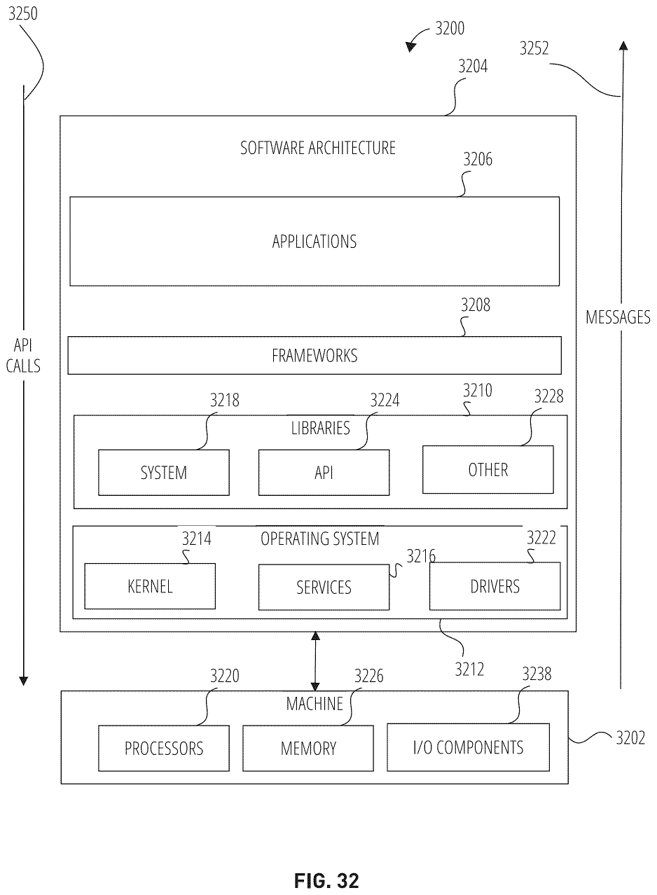

FIG. 32 is a block diagram 3200 showing a software architecture 3204, which can be installed on any devices like smartphones, tablets, or computers. The software architecture 3204 runs on hardware like a machine 302 with processors 3220, memory 3226, and I/O components 3238. In this example, the software architecture 3204 has layers that each provide specific functions. The layers are applications 3206, frameworks 3208, libraries 3210, and an operating system 3212.

In operation, the applications 3206 make API calls 3250 through the software stack and get messages 3252 back responding to the API calls 3250.

The operating system 3212 handles hardware resources and common services. It includes a kernel 3214, services 3216, and drivers 3222. The kernel 3214 abstracts the hardware for the other software. It handles memory, processing, components, networking, security, and more. The services 3216 provide common services to the layers. The drivers 3222 control and interface with the hardware. Examples are display, camera, Bluetooth, flash memory, USB, Wi-Fi, audio, and power drivers.

The libraries 3210 have low-level code the applications 3206 use. The libraries 3210 include system libraries 3218 like the C standard with functions for memory, strings, math, and more. They also have API libraries 3224 like media, graphics, database, web, and other libraries 3228. The graphics libraries render 2D and 3D graphics.

The frameworks 3208 have high-level common infrastructure the applications 3206 use. For example, they provide graphical user interfaces, resource management, location services, and other APIs.

The applications 3206 execute program functions using languages like Objective-C, Java, C++, C, or assembly. For example, a third-party application 3240 may be made with the iOS or Android SDK by another company. It uses the operating system's 3212 APIs.

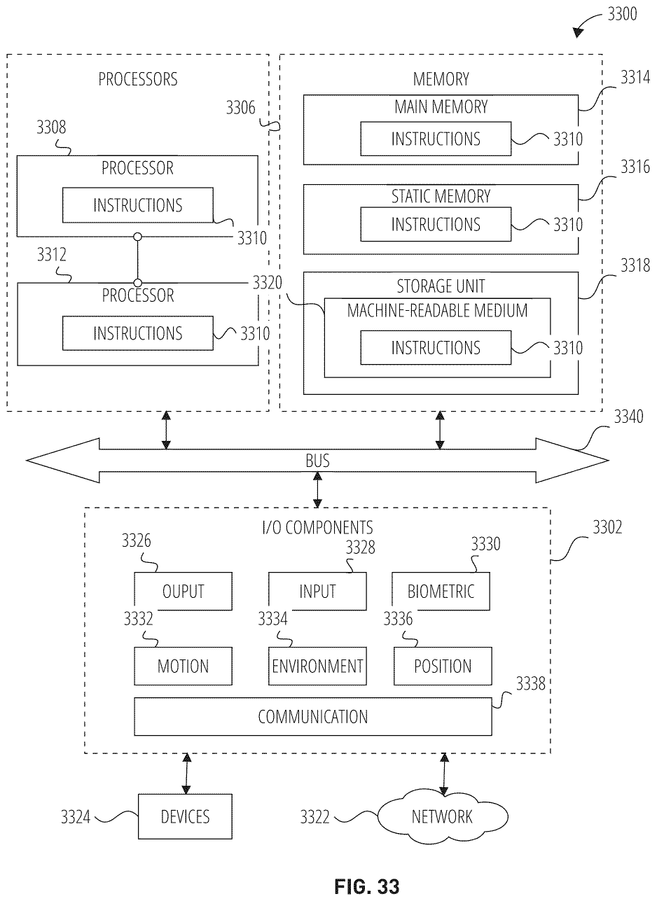

FIG. 33 is a diagrammatic representation of the machine 3300 within which instructions 3310 (e.g., software, a program, an application, an applet, an app, or other executable code) for causing the machine 3300 to perform any one or more of the methodologies discussed herein may be executed. For example, the instructions 3310 may cause the machine 3300 to execute any one or more of the methods described herein. The instructions 3310 transform the general, non-programmed machine 400 into a particular machine 3300 programmed to carry out the described and illustrated functions in the manner described. The machine 3300 may operate as a standalone device or be coupled (e.g., networked) to other machines. In a networked deployment, the machine 3300 may operate in the capacity of a server machine or a client machine in a server-client network environment, or as a peer machine in a peer-to-peer (or distributed) network environment. The machine 3300 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 3310, sequentially or otherwise, that specify actions to be taken by the machine 3300. Further, while a single machine 3300 is illustrated, the term “machine” may include a collection of machines that individually or jointly execute the instructions 3310 to perform any one or more of the methodologies discussed herein.

The machine 3300 may include processors 3304, memory 3306, and I/O components 3302, which may be configured to communicate via a bus 3340. In some examples, the processors 3304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), a Tensor Processing Unit (TPU), a Neural Processing Unit (NPU), a Vision Processing Unit (VPU), a Machine Learning Accelerator (MLA), a Cryptographic Acceleration Processor, a Field-Programmable Gate Array (FPGA), a Quantum Processor, another processor, or any suitable combination thereof) may include, for example, a processor 3308 and a processor 3312 that execute the instructions 3310.

Although FIG. 33 shows multiple processors 3304, the machine 3300 may include a single processor with a single core, a single processor with multiple cores (e.g., a multi-core processor), multiple processors with a single core, multiple processors with multiples cores, or any combination thereof. Modern processor architectures include superscalar, very long instruction word (VLIW), vector processor, multi-core, manycore, neuromorphic, and quantum architectures.

The memory 3306 includes a main memory 3314, a static memory 3316, and a storage unit 3318, both accessible to the processors 3304 via the bus 3340. The main memory 3306, the static memory 3316, and storage unit 3318 store the instructions 3310 embodying any one or more of the methodologies or functions described herein. The instructions 3310 may also reside, wholly or partially, within the main memory 3314, within the static memory 3316, within machine-readable medium 3320 within the storage unit 3318, within the processors 3304 (e.g., within the processor's cache memory), or any suitable combination thereof, during execution thereof by the machine 3300.

The I/O components 3302 may include various components to receive input, provide output, produce output, transmit information, exchange information, or capture measurements. The specific I/O components 3302 included in a particular machine depend on the type of machine. For example, portable machines such as mobile phones may include a touch input device or other such input mechanisms, while a headless server machine will likely not include such a touch input device. The I/O components 3302 may include many other components not shown in FIG. 33. In various examples, the I/O components 3302 may include output components 3326 and input components 3328. The output components 3326 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 3328 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 3302 may include biometric components 3330, motion components 3332, environmental components 3334, or position components 3336, among a wide array of other components. For example, the biometric components 3330 could include components to detect expressions (e.g., hand gestures, facial expressions, vocal expressions, body movements, or eye tracking) or measure biosignals (e.g., heart rate, blood pressure, body temperature, perspiration, or brain waves) in an aggregate, anonymous way that does not identify individuals. Technologies like facial recognition, fingerprint identification, voice identification, retinal scanning, or electroencephalogram-based identification are of course only be implemented with explicit informed consent from users, if at all. When biometric data is collected, it is minimized, encrypted, and accessed only for authorized purposes. Users are able to opt-out of biometric collection by the biometric components 3330 and have their data permanently deleted. With proper consent, security protections, data minimization, and respect for user privacy, certain biometric components may be implemented ethically.

The motion components 3332 include acceleration sensor components (e.g., accelerometer), gravitation sensor components, rotation sensor components (e.g., gyroscope). The environmental components 3334 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 3336 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 3302 further include communication components 3338 operable to couple the machine 3300 to a network 3322 or devices 3324 via respective coupling or connections. For example, the communication components 3338 may include a network interface Component or another suitable device to interface with the network 3322. In further examples, the communication components 3338 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 3324 may be another machine or any of a wide variety of peripheral devices (e.g., a peripheral device coupled via a USB).

Moreover, the communication components 3338 may detect identifiers or include components operable to detect identifiers. For example, the communication components 3338 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 3338, such as location via Internet Protocol (IP) geolocation, location via Wi-Fi® signal triangulation, or location via detecting an NFC beacon signal that may indicate a particular location.

The various memories (e.g., main memory 3314, static memory 3316, and/or memory of the processors 3304) and/or storage unit 3318 may store one or more sets of instructions and data structures (e.g., software) embodying or used by any one or more of the methodologies or functions described herein. These instructions (e.g., the instructions 3310), when executed by processors 3304, cause various operations to implement the disclosed examples.

The instructions 3310 may be transmitted or received over the network 3322, using a transmission medium, via a network interface device (e.g., a network interface component included in the communication components 3338) and using any one of several well-known transfer protocols (e.g., hypertext transfer protocol (HTTP)). Similarly, the instructions 3310 may be transmitted or received using a transmission medium via a coupling (e.g., a peer-to-peer coupling) to the devices 3324.

### Example Technical Problems and Technical Solutions

The disclosed AI co-worker system provides specific improvements to the operation of computer technology by integrating a multi-agent artificial intelligence coordination architecture into a real-time organizational data processing and task management environment. Conventional systems typically rely on generic computing operations to process enterprise data and execute tasks sequentially through single-threaded processing, requiring significant manual intervention and coordination. In contrast, the AI co-worker system performs continuous, automated coordination using a hierarchical multi-agent system that directly controls and modifies distributed computing resource allocation and task execution workflows in real time.

The system includes a main coordinating agent, multiple specialized sub-task agents, a multi-layered heterogeneous data storage architecture, and adaptive learning modules with memory systems, each configured to execute specialized functions beyond those performed by a generic computer. The architecture allows the multi-agent coordination outputs to be automatically applied to system operations, such as dynamically reallocating computational resources between agents, automatically routing different data types to optimal storage solutions (SQL, key-value, vector, flat storage), modifying task execution sequences based on real-time feedback, and adaptively fine-tuning AI models based on company-specific data, thereby achieving a tangible improvement in distributed processing efficiency, data integration accuracy, task coordination throughput, and adaptive learning performance.

This technical integration transforms the system into a specific, improved computing tool rather than a general-purpose processor executing abstract mathematical operations. By enabling autonomous coordination of multiple AI agents with dynamic resource allocation and heterogeneous data optimization in response to real-time multi-agent system outputs, the AI coworker system improves the functioning of the underlying computer system itself and enhances the performance of distributed computing and enterprise data processing in which it is applied. Accordingly, the AI coworker system improves the operation of computer technology in the specific technical context of multi-agent distributed computing systems with adaptive data processing capabilities.

Described technology examples of adaptive AI coworkers for organizational operations seek to provide technical solutions to a number of example technical problems, including the following:
1. Problem: Integrating and Processing Heterogeneous Data from Multiple Enterprise Systems

Description: Organizations often struggle with integrating and processing diverse data types from various sources, including structured data from ERP and CRM systems, as well as unstructured data from emails and documents.

Solution: The described technology implements a multi-layered data architecture to address this challenge.

The system architecture 200 includes a data sources layer that collects data from various enterprise systems such as ERP, CRM, email systems, and Excel spreadsheets. This is followed by a data processing agents layer that employs specialized agents for tasks such as OCR, data cleaning, entity extraction, document classification, and data aggregation. The system utilizes natural language processing techniques to extract and interpret information from various document types. Additionally, the data storage layer implements multiple storage solutions optimized for different types of queries and access patterns, including SQL databases, key-value stores, vector databases, and flat storage thereby improving database functionality. This comprehensive approach enables the AI coworker system to efficiently process and analyze diverse data types, providing a unified view of the organization's information landscape.
2. Problem: Customizing AI Agents for Specific Roles and Company Contexts

Description: Creating AI agents that can adapt to specific roles and company contexts presents significant technical challenges in terms of personalization and adaptability.

Solution: The described technology addresses this problem through a sophisticated role-based AI co-worker generator and an onboarding module.

The role-based AI co-worker generator analyzes job descriptions and role requirements using natural language processing techniques to extract key information such as required skills, responsibilities, and qualifications. It then maps this information to predefined role templates and customizes these templates based on specific requirements. The system also incorporates a knowledge base of relevant regulations, standards, and best practices for each role.

The onboarding module further enhances customization by facilitating the AI co-worker's integration into the company's specific systems and processes.

It accesses company documents, data sources, and team information to provide company-specific training. The module employs Retrieval Augmented Generation (RAG) techniques to assimilate company-specific information, enabling the AI co-worker to make informed decisions within the company's context.
3. Problem: Coordinating Multiple AI Agents for Complex Task Execution

Description: Designing systems where multiple AI agents can effectively communicate and coordinate to break down complex tasks into subtasks presents architectural and algorithmic challenges.

Solution: The described technology implements a sophisticated task agent architecture to address this challenge.

The system includes a main agent (e.g., Emma) that acts as the central processing unit of the operation. This main agent coordinates with multiple sub-task agents that can further decompose tasks as needed. The architecture incorporates agent selectors that choose appropriate subtask agents for execution, ensuring that the most suitable resources are used for each task component.

The system also includes a pool of specialized agents designed to handle various aspects of operations, including data access agents, data processing agents, application agents, and analytics agents.

This multi-agent approach allows for efficient task management, processing, and execution within the digital co-worker system, enabling it to handle a wide range of complex operations and queries. Thus, the multi-agent approach improves the system performance in distributed processing.
4. Problem: Automating Task Generation, Prioritization, and Allocation

Description: Developing AI systems capable of automatically generating, prioritizing, and allocating tasks based on role requirements and organizational context involves complex algorithms for natural language understanding and machine learning.

Solution: The described technology addresses this challenge through a combination of task generation, prioritization, and scheduling modules.

The task generator creates both periodic tasks and ad-hoc tasks based on the AI co-worker's role understanding. It utilizes natural language processing and machine learning techniques to interpret role requirements and company context, generating tasks that align with the specific needs of the team.

The task prioritization module organizes tasks based on various factors, including manager input, time sensitivity, and task importance.

It employs algorithms that consider multiple criteria to assign priority levels to each task, ensuring that the most critical tasks are addressed first. The task scheduler then assigns specific times for task execution, considering task priority and manager preferences. It utilizes scheduling algorithms that optimize task allocation based on various constraints and efficiency metrics.

This comprehensive approach to task management enables the AI coworker to efficiently handle complex workflows and adapt to changing organizational needs.
5. Problem: Ensuring Explainability and Transparency in AI Decision-Making

Description: Ensuring that AI decision-making processes are transparent and explainable, particularly in operational contexts where accountability is crucial, presents significant technical challenges in AI model design and implementation.

Solution: The described technology addresses this challenge by incorporating explainable AI features that provide transparency into the AI coworker's decision-making process, particularly for tasks that require auditability.

The system implements feedback loops and performance metrics to continuously evaluate and optimize the selection of AI agents for each role, ensuring that the generated AI co-worker remains aligned with the evolving needs of the team.

Additionally, the manager communication module alerts the manager upon task completion and provides detailed reports on task outcomes.

This allows for result review, ensuring transparency and accountability in the AI coworker's operations. The system also includes mechanisms for manual override, allowing human managers to intervene and adjust priorities when necessary, further enhancing transparency and control.

By implementing these technical solutions, the described technology aims to create a highly personalized, adaptive, and intelligent AI coworker system for organizational operations, with a focus on accuracy, customization, and explainability.

### Example Use Cases

Exampled use cases for the described adaptive AI coworker technology may include:
1. Automated Financial Reporting and Analysis

Technique: The AI coworker can be configured to automatically generate periodic financial reports and conduct in-depth analysis. Using the task generator (314) shown in FIG. 3, the system creates periodic tasks for report generation.

The AI accesses relevant data through the data sources layer (402) and processes it using specialized analytics agents (520) from the task agent architecture in FIG. 5. The system then utilizes large language models (236) to generate human-readable reports and insights, which are communicated to managers through the manager communication module (326).
2. Intelligent Customer Service Support

Technique: The AI coworker can be customized to handle customer inquiries and support tickets. Using the role-based AI co-worker generator (304) shown in FIG. 3, the system is configured with customer service skills and knowledge.

It integrates with CRM systems (220) through the data sources layer (216) to access customer information. The AI uses natural language processing capabilities of large language models (236) to understand customer queries and generate appropriate responses. The feedback mechanism (706) in the single AI agent architecture allows the system to learn from interactions and improve its responses over time.
3. Supply Chain Optimization

Technique: The AI coworker can be utilized to optimize supply chain operations. The system integrates with ERP systems (218) and other relevant data sources through the data sources layer (216) shown in FIG. 2.

Using the analytics agents (520) from the task agent architecture (FIG. 5), the AI performs demand forecasting, inventory optimization, and supplier performance analysis. The problem-solving module (708) in the single AI agent architecture (FIG. 7) enables the system to identify potential supply chain issues and suggest optimizations.
4. Human Resources Management

Technique: The AI coworker can assist in various HR processes. Using the role creation layer (210) shown in FIG. 2, the system is configured with HR-specific knowledge and capabilities.

It can automate tasks such as resume screening, interview scheduling, and employee onboarding. The system integrates with HR databases through the data sources layer (216) and uses document classification capabilities from the data processing agents layer (214) to categorize and analyze HR documents. The task prioritization module (320) in FIG. 3 helps manage and prioritize various HR tasks.
5. Project Management and Resource Allocation

Technique: The AI coworker can be utilized for project management and resource allocation across teams. Using the task agent architecture shown in FIG. 5, the system breaks down complex projects into subtasks and assigns them to appropriate team members.

The task scheduler (322) in FIG. 3 optimizes task allocation based on team members'skills and availability. The system integrates with project management tools through the data sources layer (216) and uses analytics agents (520) to track project progress, identify potential bottlenecks, and suggest resource reallocations.
6. Regulatory Compliance Monitoring

Technique: The AI coworker can be configured to monitor and ensure regulatory compliance across various business operations. Using the role creation layer (210) shown in FIG. 2, the system is equipped with knowledge of relevant regulations and compliance requirements.

It integrates with various data sources through the data sources layer (216) to monitor business activities. The system uses document classification and entity extraction capabilities from the data processing agents layer (214) to identify potential compliance issues. The manager communication module (326) in FIG. 3 alerts relevant stakeholders about compliance risks and necessary actions.
7. Sales Pipeline Management and Forecasting

Technique: The AI coworker can assist in managing and optimizing the sales pipeline. It integrates with CRM systems (220) through the data sources layer (216) shown in FIG. 2 to access sales data.

Using analytics agents (520) from the task agent architecture (FIG. 5), the system analyzes historical sales data, customer interactions, and market trends to forecast sales and identify opportunities. The task generator (314) in FIG. 3 creates tasks for sales representatives based on pipeline analysis, while the manager communication module (326) provides insights and recommendations to sales managers.

8. IT Service Management and Support

Technique: The AI coworker can be customized to handle IT service requests and support. Using the role-based AI co-worker generator (304) shown in FIG. 3, the system is configured with IT knowledge and troubleshooting capabilities.

It integrates with IT service management tools through the data sources layer (216) and uses natural language processing capabilities of large language models (236) to understand and categorize IT issues. The task prioritization module (320) in FIG. 3 helps manage and prioritize IT tickets, while the problem-solving module (708) in the single AI agent architecture (FIG. 7) assists in diagnosing and resolving IT problems.

These use cases demonstrate the versatility and adaptability of the described AI coworker technology across various organizational functions, leveraging its sophisticated architecture and capabilities to address diverse operational needs.

### TERM EXAMPLES

“Network” may include one or more portions of a network that are coupled together to form an end-to-end communication path between two points. The network may be comprised of multiple network portions using different permutations and combinations of network types.

Example network portions may include:
An ad hoc network
An intranet
An extranet
A virtual private network (VPN)
A local area network (LAN)
A wireless LAN (WLAN)
A wide area network (WAN)
A wireless WAN (WWAN)
A metropolitan area network (MAN)
The Internet
A portion of the Internet
A portion of the Public Switched Telephone Network (PSTN)
A plain old telephone service (POTS) network
A cellular telephone network
A wireless network
A Wi-Fi® network
Another type of network
A combination of two or more such networks

Specific examples may include:
5G networks
Low power wide area networks (LPWANs) like LoRaWAN or Sigfox
Narrowband internet of things (NB-IoT)
6G networks
Bluetooth
Zigbee
Thread
Z-Wave
Near Field Communication (NFC)
Radio Frequency Identification (RFID)
Message Queuing Telemetry Transport (MQTT)
Constrained Application Protocol (CoAP)
Controller Area Network (CAN) bus
FlexRay
Bluetooth
Zigbee
Thread
Body area networks (BANs)
Wireless USB

Example networks may utilize a variety of data transfer technologies, such as:
Single Carrier Radio Transmission Technology (1xRTT)
Evolution-Data Optimized (EVDO) technology
General Packet Radio Service (GPRS) technology
Enhanced Data rates for GSM Evolution (EDGE) technology
Third Generation Partnership Project (3GPP) including 3G
Fourth-generation wireless (4G) networks
Universal Mobile Telecommunications System (UMTS)
High-Speed Packet Access (HSPA)
Worldwide Interoperability for Microwave Access (WiMAX)
Long Term Evolution (LTE) standard
Others defined by various standard-setting organizations
Other long-range protocols
Other data transfer technology.

“Component” may include a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In some examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In some examples, the processors or processor-implemented components may be distributed across a number of geographic locations.

“Non-transitory computer-readable medium” may include, in some examples, one or more storage devices and media (e.g., a centralized or distributed database, and associated caches and servers) that store executable instructions, routines, and data. The term specifically excludes intangible carrier waves, modulated data signals, and other such media, at least some of which are covered under the term “signal medium.” The term shall accordingly be taken to include, but not be limited to, solid-state memories, and optical and magnetic media, including memory internal or external to processors. Specific examples of non-transitory machine-readable media, non-transitory computer-readable media, and device-readable media may include non-volatile memory, including by way of example semiconductor memory devices, e.g., erasable programmable read-only memory (EPROM), electrically erasable programmable read-only memory (EEPROM), Field Programmable Gate Array (FPGA), and flash memory devices; magnetic disks such as internal hard disks and removable disks; magneto-optical disks; CD-ROM and DVD-ROM disks; solid state drives (SSD); USB flash drives; memory cards such as SD cards, microSD cards, CompactFlash cards; optical discs such as Blu-ray discs; as well as cloud storage and network attached storage (NAS). Additional examples include read-only memory (ROM), programmable read-only memory (PROM), ferroelectric RAM (FRAM), phase-change memory (PCM), resistive RAM (RRAM), memristors, racetrack memory, and magnetic tape. The terms “non-transitory machine-readable medium,” “non-transitory device-readable medium,” and “non-transitory computer-readable medium” mean the same thing and may be used interchangeably in this disclosure.

“Module” may include, in some examples, logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” may include, in some examples, one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a neuromorphic processor, a quantum processor, or any combination thereof.

A processor may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently.

A processor may be emulated in software, running on a physical processor, as a virtual processor or virtual circuit. The virtual processor may behave like an independent processor but is implemented in software rather than hardware.

“Signal Medium” may include, in some examples, an intangible medium that is capable of storing, encoding, or carrying the instructions for execution by a machine and includes digital or analog communications signals or other intangible media to facilitate communication of software or data. The term “signal medium” may include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another or may be combined in various ways. All possible combinations and sub-combinations are intended to fall within the scope of this disclosure. In addition, certain method or process blocks, or operations may be omitted in some implementations.

The term “operation” is used to refer to elements in the drawings of this disclosure for ease of reference and it will be appreciated that each “operation” may identify one or more operations, processes, actions, or steps, and may be performed by one or multiple components.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a computer-implemented method for automated task management in a digital co-worker system, the computer-implemented method comprising receiving, by at least one processor, a role description for an artificial intelligence (AI) co-worker of an organization, the role description including role requirements of a particular role that is associated with the AI co-worker, identifying, by the at least one processor, required skills and responsibilities corresponding to the AI co-worker from the role description by analyzing the role description using natural language processing techniques, selecting, by the at least one processor, a combination of AI agents from a pool of specialized agents based on the identified skills and responsibilities, creating, by the at least one processor, a customized AI co-worker by integrating the selected AI agents, automatically generating, by the at least one processor, a plurality of tasks to be performed by the customized AI co-worker based on the role requirements included in the role description and a company context that describes characteristics of the organization, prioritizing, by the at least one processor, the plurality of tasks, each of the plurality of tasks prioritized based on a time sensitivity and a task importance of the task, allocating, by the at least one processor, the prioritized plurality of tasks to the AI co-worker, and executing, by the at least one processor, the allocated plurality of tasks using the AI agents of the AI co-worker.

In Example 2, the subject matter of Example 1, wherein the pool of specialized agents comprises one or more data access agents, each data access agent to retrieve data from a plurality of different sources, one or more data processing agents, each data processing agent to standardize the retrieved data into a standardized format, one or more analytics agents, each analytics agent to analyze the standardized data and generate insights based on the analysis, and one or more application agents, each application agent to perform a domain-specific task.

In Example 3, the subject matter of any one or more of Examples 1-2, further comprising onboarding the customized AI co-worker by providing the customized AI co-worker access to company-specific data sources and documents.

In Example 4, the subject matter of any one or more of Examples 1-3, wherein onboarding the customized AI co-worker further comprises fine-tuning a machine-learning model of the AI co-worker using company-specific organizational data and practices.

In Example 5, the subject matter of any one or more of Examples 1-4, wherein automatically generating the plurality of tasks comprises identifying recurring tasks based on an analysis of role-specific responsibilities associated with the particular role for the customized AI co-worker and historical task data, and creating periodic tasks based on the identified recurring tasks.

In Example 6, the subject matter of any one or more of Examples 1-5, wherein automatically generating the plurality of tasks further comprises monitoring user inputs and system events, identifying immediate needs within the organization based on the monitored user inputs and system events, and generating one or more ad-hoc tasks based on the identified immediate needs.

In Example 7, the subject matter of any one or more of Examples 1-6, wherein prioritizing the plurality of tasks comprises generating a priority score for each of the plurality of tasks based on predefined criteria including at least one of a deadline, impact on operations, and manager input, wherein the plurality of tasks are prioritized based on the priority score for each of the plurality of tasks.

In Example 8, the subject matter of any one or more of Examples 1-7, wherein allocating the prioritized plurality of tasks comprises determining an execution sequence for the prioritized plurality of tasks and scheduling the prioritized plurality of tasks according to the determined execution sequence.

In Example 9, the subject matter of any one or more of Examples 1-8, further comprising monitoring task execution progress of the plurality of tasks, determining workload balance between the AI agents of the personalized AI coworker, and dynamically adjusting task priorities and allocation of the adjusted prioritized plurality of tasks to the AI agents based on the monitored progress and workload balance.

In Example 10, the subject matter of any one or more of Examples 1-9, wherein executing the allocated plurality of tasks comprises retrieving data relevant to the allocated plurality of tasks from a plurality of integrated data sources, processing the retrieved data using the AI agents, and generating output based on the processed data, the output including a visualization of the processed data.

In Example 11, the subject matter of any one or more of Examples 1-10, further comprising receiving feedback on task execution of the plurality of tasks and updating task execution parameters of the AI co-worker based on the received feedback.

In Example 12, the subject matter of any one or more of Examples 1-11, wherein automatically generating the plurality of tasks comprises tuning one or more large language models (LLMs) by inputting the role requirements and company-specific data of the organization into the one or more LLMs, the tuned one or more LLMs understanding the role requirements and the company-specific data of the organization, inputting multiple data sources including emails, calendar events, and organizational system alerts into the one or more tuned LLMs, the one or more tuned LLMs outputting identified potential tasks, and generating relevant tasks based on the potential tasks identified by the one or more tuned LLMs.

In Example 13, the subject matter of any one or more of Examples 1-12, wherein each of the executed plurality of tasks is associated with at least one task execution decision and the method further comprises generating an explanation of the at least one task execution decisions for each of the executed plurality of tasks, receiving feedback on the explanation, and retraining the AI coworker based on the feedback.

In Example 14, the subject matter of any one or more of Examples 1-13, wherein allocating the prioritized plurality of tasks to the AI co-worker comprises identifying required capabilities for each of the prioritized plurality of tasks, matching the required capabilities for each of the prioritized plurality of tasks to agent profiles of the AI agents selected for the AI co-worker, and assigning an agent from the AI agents selected for the AI co-worker to at least one of the prioritized plurality of tasks based on the assigned agent having a profile that matches the required capability for the task.

In Example 15, the subject matter of any one or more of Examples 1-14, further comprising managing resource allocation to assigned AI agents across distributed computing resources to optimize performance and efficiency of the execution of the allocated plurality of tasks.

Example 16 is a computing system comprising at least one processor and at least one memory storing instructions that, when executed in cooperation with controlling the at least one processor, operate the computing system to perform operations comprising receiving a role description for an artificial intelligence (AI) co-worker of an organization, the role description including role requirements of a particular role that is associated with the AI co-worker, identifying required skills and responsibilities corresponding to the AI co-worker from the role description by analyzing the role description using natural language processing techniques, selecting a combination of AI agents from a pool of specialized agents based on the identified skills and responsibilities, creating a customized AI co-worker by integrating the selected AI agents, automatically generating a plurality of tasks to be performed by the customized AI co-worker based on the role requirements included in the role description and a company context that describes characteristics of the organization, prioritizing the plurality of tasks, each of the plurality of tasks prioritized based on a time sensitivity and a task importance of the task, allocating the prioritized plurality of tasks to the AI co-worker, and executing the allocated plurality of tasks using the AI agents of the AI co-worker.

In Example 17, the subject matter of Example 16, wherein the operations further comprise fine-tuning a machine-learning model of the AI co-worker using company-specific organizational data and practices to onboard the customized AI co-worker.

In Example 18, the subject matter of any one or more of Examples 16-17, wherein the operations further comprise monitoring task execution progress of the plurality of tasks, determining workload balance between the AI agents of the AI coworker, and dynamically adjusting task priorities and allocation of the adjusted prioritized plurality of tasks to the AI agents based on the monitored progress and workload balance.

Example 19 is a non-transitory computer-readable medium storing instructions that, when executed by at least one processor, cause the at least one processor to perform operations comprising receiving, by the at least one processor, a role description for an artificial intelligence (AI) co-worker of an organization, the role description including role requirements of a particular role that is associated with the AI co-worker, identifying, by the at least one processor, required skills and responsibilities corresponding to the AI co-worker from the role description by analyzing the role description using natural language processing techniques, selecting, by the at least one processor, a combination of AI agents from a pool of specialized agents based on the identified skills and responsibilities, creating, by the at least one processor, a customized AI co-worker by integrating the selected AI agents, automatically generating, by the at least one processor, a plurality of tasks to be performed by the customized AI co-worker based on the role requirements included in the role description and a company context that describes characteristics of the organization, prioritizing, by the at least one processor, the plurality of tasks, each of the plurality of tasks prioritized based on a time sensitivity and a task importance of the task, allocating, by the at least one processor, the prioritized plurality of tasks to the AI co-worker, and executing, by the at least one processor, the allocated plurality of tasks using the AI agents of the AI co-worker.

In Example 20, the subject matter of Example 19, wherein the operations further comprise fine-tuning a machine-learning model of the AI co-worker using company-specific organizational data and practices to onboard the customized AI co-worker.

What is claimed is:

1. A computer-implemented method for automated task management in a digital co-worker system, the computer-implemented method comprising:
receiving, by at least one processor, a role description for an artificial intelligence (AI) co-worker of an organization, the role description including role requirements of a particular role that is associated with the AI co-worker;
identifying, by the at least one processor, required skills and responsibilities corresponding to the AI co-worker from the role description by analyzing the role description using natural language processing techniques;
selecting, by the at least one processor, a combination of AI agents from a pool of specialized agents based on the identified skills and responsibilities;
creating, by the at least one processor, a customized AI co-worker by integrating the selected AI agents;
automatically generating, by the at least one processor, a plurality of tasks to be performed by the customized AI co-worker based on the role requirements included in the role description and a company context that describes characteristics of the organization;
prioritizing, by the at least one processor, the plurality of tasks, each of the plurality of tasks prioritized based on a time sensitivity and a task importance of the task;
allocating, by the at least one processor, the prioritized plurality of tasks to the AI co-worker; and
executing, by the at least one processor, the allocated plurality of tasks using the AI agents of the AI co-worker.

2. The computer-implemented method of claim 1, wherein the pool of specialized agents comprises:
one or more data access agents, each data access agent to retrieve data from a plurality of different sources;
one or more data processing agents, each data processing agent to standardize the retrieved data into a standardized format;
one or more analytics agents, each analytics agent to analyze the standardized data and generate insights based on the analysis; and
one or more application agents, each application agent to perform a domain-specific task.

3. The computer-implemented method of claim 1, further comprising:
onboarding the customized AI co-worker by providing the customized AI co-worker access to company-specific data sources and documents.

4. The computer-implemented method of claim 3, wherein onboarding the customized AI co-worker further comprises:
fine-tuning a machine-learning model of the AI co-worker using company-specific organizational data and practices.

5. The computer-implemented method of claim 1, wherein automatically generating the plurality of tasks comprises:
identifying recurring tasks based on an analysis of role-specific responsibilities associated with the particular role for the customized AI co-worker and historical task data; and
creating periodic tasks based on the identified recurring tasks.

6. The computer-implemented method of claim 1, wherein automatically generating the plurality of tasks further comprises:
monitoring user inputs and system events;
identifying immediate needs within the organization based on the monitored user inputs and system events; and
generating one or more ad-hoc tasks based on the identified immediate needs.

7. The computer-implemented method of claim 1, wherein prioritizing the plurality of tasks comprises:
generating a priority score for each of the plurality of tasks based on predefined criteria including at least one of a deadline, impact on operations, and manager input,
wherein the plurality of tasks are prioritized based on the priority score for each of the plurality of tasks.

8. The computer-implemented method of claim 1, wherein allocating the prioritized plurality of tasks comprises:
determining an execution sequence for the prioritized plurality of tasks; and
scheduling the prioritized plurality of tasks according to the determined execution sequence.

9. The computer-implemented method of claim 1, further comprising:
monitoring task execution progress of the plurality of tasks;
determining workload balance between the AI agents of the personalized AI coworker; and
dynamically adjusting task priorities and allocation of the adjusted prioritized plurality of tasks to the AI agents based on the monitored progress and workload balance.

10. The computer-implemented method of claim 1, wherein executing the allocated plurality of tasks comprises:
retrieving data relevant to the allocated plurality of tasks from a plurality of integrated data sources;
processing the retrieved data using the AI agents; and
generating output based on the processed data, the output including a visualization of the processed data.

11. The computer-implemented method of claim 1, further comprising:
receiving feedback on task execution of the plurality of tasks; and
updating task execution parameters of the AI co-worker based on the received feedback.

12. The computer-implemented method of claim 1, wherein automatically generating the plurality of tasks comprises:
tuning one or more large language models (LLMs) by inputting the role requirements and company-specific data of the organization into the one or more LLMs, the tuned one or more LLMs understanding the role requirements and the company-specific data of the organization;
inputting multiple data sources including emails, calendar events, and organizational system alerts into the one or more tuned LLMs, the one or more tuned LLMs outputting identified potential tasks; and
generating relevant tasks based on the potential tasks identified by the one or more tuned LLMs.

13. The computer-implemented method of claim 1, wherein each of the executed plurality of tasks is associated with at least one task execution decision and the method further comprises:
generating an explanation of the at least one task execution decisions for each of the executed plurality of tasks; and
receiving feedback on the explanation; and
retraining the AI coworker based on the feedback.

14. The computer-implemented method of claim 1, wherein allocating the prioritized plurality of tasks to the AI co-worker comprises:
identifying required capabilities for each of the prioritized plurality of tasks;
matching the required capabilities for each of the prioritized plurality of tasks to agent profiles of the AI agents selected for the AI co-worker; and
assigning an agent from the AI agents selected for the AI co-worker to at least one of the prioritized plurality of tasks based on the assigned agent having a profile that matches the required capability for the task.

15. The computer-implemented method of claim 14, further comprising:
managing resource allocation to assigned AI agents across distributed computing resources to optimize performance and efficiency of the execution of the allocated plurality of tasks.

16. A computing system comprising:
at least one processor; and
at least one memory storing instructions that, when executed in cooperation with controlling the at least one processor, operate the computing system to perform operations comprising:
receiving a role description for an artificial intelligence (AI) co-worker of an organization, the role description including role requirements of a particular role that is associated with the AI co-worker;
identifying required skills and responsibilities corresponding to the AI co-worker from the role description by analyzing the role description using natural language processing techniques;
selecting a combination of AI agents from a pool of specialized agents based on the identified skills and responsibilities;
creating a customized AI co-worker by integrating the selected AI agents;
automatically generating a plurality of tasks to be performed by the customized AI co-worker based on the role requirements included in the role description and a company context that describes characteristics of the organization;
prioritizing the plurality of tasks, each of the plurality of tasks prioritized based on a time sensitivity and a task importance of the task;
allocating the prioritized plurality of tasks to the AI co-worker; and
executing the allocated plurality of tasks using the AI agents of the AI co-worker.

17. The computer system of claim 16, wherein the operations further comprise:
fine-tuning a machine-learning model of the AI co-worker using company-specific organizational data and practices to onboard the customized AI co-worker.

18. The computer system of claim 16, wherein the operations further comprise:
monitoring task execution progress of the plurality of tasks;
determining workload balance between the AI agents of the AI coworker; and
dynamically adjusting task priorities and allocation of the adjusted prioritized plurality of tasks to the AI agents based on the monitored progress and workload balance.

19. A non-transitory computer-readable medium storing instructions that, when executed by at least one processor, cause the at least one processor to perform operations comprising:
receiving, by the at least one processor, a role description for an artificial intelligence (AI) co-worker of an organization, the role description including role requirements of a particular role that is associated with the AI co-worker;
identifying, by the at least one processor, required skills and responsibilities corresponding to the AI co-worker from the role description by analyzing the role description using natural language processing techniques;
selecting, by the at least one processor, a combination of AI agents from a pool of specialized agents based on the identified skills and responsibilities;
creating, by the at least one processor, a customized AI co-worker by integrating the selected AI agents;
automatically generating, by the at least one processor, a plurality of tasks to be performed by the customized AI co-worker based on the role requirements included in the role description and a company context that describes characteristics of the organization;
prioritizing, by the at least one processor, the plurality of tasks, each of the plurality of tasks prioritized based on a time sensitivity and a task importance of the task;
allocating, by the at least one processor, the prioritized plurality of tasks to the AI co-worker; and
executing, by the at least one processor, the allocated plurality of tasks using the AI agents of the AI co-worker.

20. The non-transitory computer-readable medium of claim 19, wherein the operations further comprise:
fine-tuning a machine-learning model of the AI co-worker using company-specific organizational data and practices to onboard the customized AI co-worker.
